(19) United States
(12) Patent Application Publication
(10) Pub. No.: US 2026/0365875 A1
(43) Pub. Date: Nov. 19, 2026

(54) FLUORINE-CONTAINING AROMATIC POLYMER AND METHOD FOR PRODUCING FLUORINE-CONTAINING AROMATIC POLYMER

(71) Applicant: OCHANOMIZU UNIVERSITY, Tokyo (JP)

(72) Inventors: Tadashi Kanbara, Bunkyo-ku, Tokyo (JP); Tomoko Yajima, Bunkyo-ku, Tokyo (JP)

(73) Assignee: OCHANOMIZU UNIVERSITY, Tokyo (JP)

(21) Appl. No.: 19/103,858

(22) PCT Filed: Aug. 10, 2023
(86) PCT No.: PCT/JP2023/029312

§ 371 Date: Feb. 14, 2025

(30) Foreign Application Priority Data
Aug. 16, 2022 (JP) 2022-129720

(51) Int. Cl. C09D 179/08; C08G 59/14; C08G 64/42; C08G 73/10; C08G 73/14; C08G 75/23; C08J 7/04; C09D 163/00; C09D 169/00; C09D 181/06

(52) U.S. Cl. CPC C09D 179/08; C08G 59/1433; C08G 64/42; C08G 73/1007; C08G 73/1039; C08G 73/1071; C08G 73/14; C08G 75/23; C08J 7/0427; C09D 163/00; C09D 169/00; C09D 181/06; C08J 2363/00; C08J 2369/00; C08J 2379/08; C08J 2381/06

(57) ABSTRACT

Fluorine-containing aromatic polymers are used in a wide range of applications, and therefore desired to have various structures. The fluorine-containing aromatic polymer of the present disclosure is represented by the Formula (I).

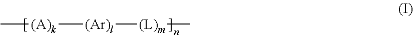

### TECHNICAL FIELD

The present disclosure relates to a fluorine-containing aromatic polymer and a method for producing a fluorine-containing aromatic polymer.

### BACKGROUND ART

Super engineering plastics such as polyimides and aromatic polymers typified by engineering plastics exhibit excellent properties such as heat resistance, mechanical properties, and insulation properties. Patent Document 1 describes a reaction product of an acid anhydride and an amine containing a dimer diamine, as a polyimide.

### PRIOR ART DOCUMENT

### Patent Document

Patent Document 1: JP-A-2020-203981

### SUMMARY OF THE INVENTION

### Problems to be Solved by the Invention

Fluorine-containing aromatic polymers are used in a wide range of applications, and therefore desired to have various structures.

### Solutions to the Problems

<1>

A fluorine-containing aromatic polymer represented by Formula (I):

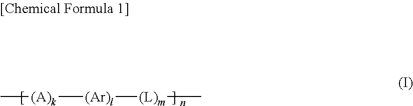

wherein
A each independently represents an aliphatic or aromatic imide-diyl group,
Ar each independently represents a divalent group comprising a C₆₋₂₀ aromatic hydrocarbon moiety optionally having one or more substituents,
L each independently represents one selected from the group consisting of —R¹—, —O—, —S—, —NR²—, —CO—, —CO—O—, —O—CO—, —O—CO—O—, —SO₂—, —NR²—CO—, and CO—NR²—,
R¹ each independently represents one selected from a C₁₋₁₆ alkylene group optionally having one or more substituents; and a divalent group comprising a C₃₋₁₆ alicyclic hydrocarbon moiety optionally having one or more substituents,
R² each independently represents a C₁₋₁₆ alkyl group optionally having one or more substituents; a C₆₋₂₀ aromatic hydrocarbon group optionally having one or more substituents; or hydrogen atom,
k each independently represents an integer of 0 to 4,
l each independently represents an integer of 1 to 4,
m each independently represents an integer of 0 to 4,
n represents an integer of 1 or more, and
in a unit enclosed in parentheses with n, units enclosed in parentheses with k, 1, and m may appear in any order, and
the Formula (I) satisfies (i) or (ii):
(i) k is 0, and Formula (I) comprises one or more C₂₋₂₀ fluorine-containing organic groups, and
(ii) k is 1 to 4, and Formula (I) comprises one or more C₁₋₂₀ fluorine-containing organic groups.
   <2>

The fluorine-containing aromatic polymer according to <1>, wherein
the C₂₋₂₀ fluorine-containing organic groups are represented by one or more selected from Formula (1A) and Formula (1B):

R³¹—X¹—(R^{F1})ᵣ—CF₂—* (1A)

*—X³—CF₂—* (1B)
wherein
R^{F1} represents —(Rf)ₚ—R^{F}—O)_{q},
Rf each independently represents a C₁₋₁₆ alkylene group optionally substituted with one or more fluorine atoms,
R^{F} represents a divalent fluoro(poly)ether group,
X¹ represents a C₁₋₁₆ alkylene group optionally substituted with one or more halogen atoms; or single bond,
X³ represents a C₁₋₁₆ alkylene group optionally substituted with one or more halogen atoms,
R³¹ represents a C₁₋₁₆ alkyl group optionally substituted with one or more halogen atoms; a C₆₋₂₀ aromatic hydrocarbon group optionally having one or more substituents; a silsesquioxane residue optionally having one or more substituents; —COOR^{f2}; —OR^{f2}; —SO₂R^{f3}; —CR^{f4}═CR^{f4}₂; fluorine atom; bromine atom; or iodine atom,
R^{f2} each independently represents a C₁₋₁₆ alkyl group optionally substituted with one or more fluorine atoms; or hydrogen atom,
R^{f3} represents a C₁₋₁₆ alkyl group optionally substituted with one or more halogen atoms; fluorine atom; or hydrogen atom,
R^{f4} each independently represents hydrogen atom or fluorine atom,
p is 0 or 1, q is 0 or 1, r is 0 or 1,
* represents a bond, and
Formula (1A) and Formula (1B) each comprise 2 to 20 20 carbon atoms, and
the C₁₋₂₀ fluorine-containing organic groups are represented by Formula (2A) and Formula (2B):

R³²—X¹—(R^{F1})ᵣ—CF₂—* (2A)

*—X¹—CF₂—* (2B)
wherein
R^{F1} represents —(Rf)ₚ—R^{F}—(O)_{q},
Rf each independently represents a C₁₋₁₆ alkylene group optionally substituted with one or more fluorine atoms,
R^{F} represents a divalent fluoro(poly)ether group,
X¹ represents a C₁₋₁₆ alkylene group optionally substituted with one or more halogen atoms; or single bond,
R³² represents a C₁₋₁₆ alkyl group optionally substituted with one or more halogen atoms; a C₆₋₂₀ aromatic hydrocarbon group optionally having one or more substituents; a silsesquioxane residue optionally having one or more substituents; —COOR^{f2}; —OR^{f2}; —SO₂R^{f3}; —CR^{f4}═C^{Rf4}₂; fluorine atom; bromine atom; or iodine atom,
R^{f2} each independently represents a C₁₋₁₆ alkyl group optionally substituted with one or more fluorine atoms or hydrogen atom,
R^{f3} represents a C₁₋₁₆ alkyl group optionally substituted with one or more halogen atoms; fluorine atom; or hydrogen atom,
R^{f4} each independently represents hydrogen atom or fluorine atom,
p is 0 or 1, q is 0 or 1, r is 0 or 1,
* represents a bond, and
Formula (2A) and Formula (2B) each comprise 1 to 20 carbon atoms.
   <3>

The fluorine-containing aromatic polymer according to <1> or <2>, wherein
the C₂₋₂₀ fluorine-containing organic groups are selected from Formula (1-a), Formula (1-b), Formula (1-c), and Formula (1B):

F—X³—CF₂—* (1-a)

R³¹—X¹—CF₂—* (1-b)

R³¹—X¹—R^{F1}—CF₂—* (1-c)

*—X³—CF₂—* (1B)
wherein
R^{F1} represents —(Rf)ₚ-R^{F}(O)_{q},
Rf each independently represents a C₁₋₁₆ alkylene group optionally substituted with one or more fluorine atoms,
R^{F} represents a divalent fluoro(poly)ether group,
X¹ represents a C₁₋₁₆ alkylene group optionally substituted with one or more halogen atoms; or single bond,
X³ represents a C₃₋₁₆ alkylene group optionally substituted with one or more halogen atoms,
R³¹ represents a C₁₋₁₆ alkyl group optionally substituted with one or more halogen atoms; a C₆₋₂₀ aromatic hydrocarbon group optionally having one or more substituents; a silsesquioxane residue optionally having one or more substituents; —COOR^{f2}; —OR^{f2}; —SO₂R^{f3}; —CR^{f4}═CR^{f4}₂; fluorine atom; or bromine atom,
R^{f2} each independently represents a C₁₋₁₆ alkyl group optionally substituted with one or more fluorine atoms; or hydrogen atom,
R^{f3} represents a C₁₋₁₆ alkyl group optionally substituted with one or more halogen atoms; fluorine atom; or hydrogen atom,
R^{f4} each independently represents hydrogen atom or fluorine atom,
p is 0 or 1, q is 0 or 1, r is 0 or 1,
* represents a bond,
Formula (1-a) comprises 2 to 20 carbon atoms,
Formula (1-b) comprises 2 to 20 carbon atoms,
Formula (1-c) comprises 2 to 20 carbon atoms, and
Formula (1B) comprises 2 to 20 carbon atoms, and
the C₁₋₂₀ fluorine-containing organic groups are selected from Formula (2-a), Formula (2-b), Formula (2-c), and Formula (2B):

F—X¹—CF₂—* (2-a)

R³²—X¹—CF₂—* (2-b)

R³²—X¹—R^{F1}—CF₂—* (2-c)

*—X¹—CF₂—* (2B)
wherein
R^{F1} represents —(Rf)ₚ-R^{F}—(O)_{q}—,
Rf each independently represents a C₁₋₁₆ alkylene group optionally substituted with one or more fluorine atoms,
R^{F} represents a divalent fluoro(poly)ether group,
X¹ represents a C₁₋₁₆ alkylene group optionally substituted with one or more halogen atoms; or single bond,
R³² represents a C₁₋₁₆ alkyl group optionally substituted with one or more halogen atoms; a C₆₋₂₀ aromatic hydrocarbon group optionally having one or more substituents; a silsesquioxane residue optionally having one or more substituents; —COOR^{f2}; —OR^{f2}; —SO₂R^{f3}; —CR^{f4}═CR^{f4}₂; fluorine atom; or bromine atom,
R^{f2} each independently represents a C₁₋₁₆ alkyl group optionally substituted with one or more fluorine atoms; or hydrogen atom,
R^{f3} represents a C₁₋₁₆ alkyl group optionally substituted with one or more halogen atoms; fluorine atom; or hydrogen atom,
R^{f4} each independently represents hydrogen atom or fluorine atom,
p is 0 or 1, q is 0 or 1, r is 0 or 1,
* represents a bond,
Formula (2-a) comprises 1 to 20 carbon atoms,
Formula (2-b) comprises 1 to 20 carbon atoms,
Formula (2-c) comprises 1 to 20 carbon atoms, and
Formula (2B) comprises 1 to 20 carbon atoms.
   <4>

The fluorine-containing aromatic polymer according to any one of <1> to <3>, wherein
Formula (I) is represented by Formula (I-a):

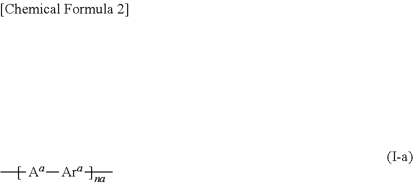

wherein
A^{a} each independently represents an aliphatic or aromatic imide-diyl group,
Ar^{a} each independently represents a divalent group comprising a C₆₋₂₀ aromatic hydrocarbon moiety optionally having one or more substituents,
na represents an integer of 1 or more, and
Formula (I-a) comprises one or more C₁₋₂₀ fluorine-containing organic groups.
   <5>

The fluorine-containing aromatic polymer according to any one of <1> to <4>,

wherein
Formula (I) is represented by Formula (I-b):

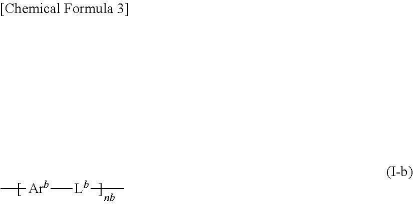

wherein
Ar^{b} each independently represents a divalent group comprising a C₆₋₂₀ aromatic hydrocarbon moiety optionally having one or more substituents,
L^{b} each independently represents one selected from the group consisting of —R¹—, —O—, —S—, —NR²—, —CO—, —CO—O—, —O—CO—, —O—CO—O—, —SO₂—, —NR²—CO—, and CO—NR²—,
R¹ each independently represents one selected from a C₁₋₁₆ alkylene group optionally having a substituent; and a divalent group comprising a C₃₋₁₆ alicyclic hydrocarbon moiety optionally having one or more substituents,
R² each independently represents a C₁₋₁₆ alkyl group optionally having one or more substituents; a C₆₋₂₀ aromatic hydrocarbon group optionally having one or more substituents; or hydrogen atom,
nb represents an integer of 1 or more, and
Formula (I-b) comprises one or more C₂₋₂₀ fluorine-containing organic groups.
   <6>

The fluorine-containing aromatic polymer according to <5>, wherein
Formula (I-b) is represented by Formula (I-b1), (I-b2), (I-b3), (I-b4), (I-b5), (I-b6), or (I-b7):

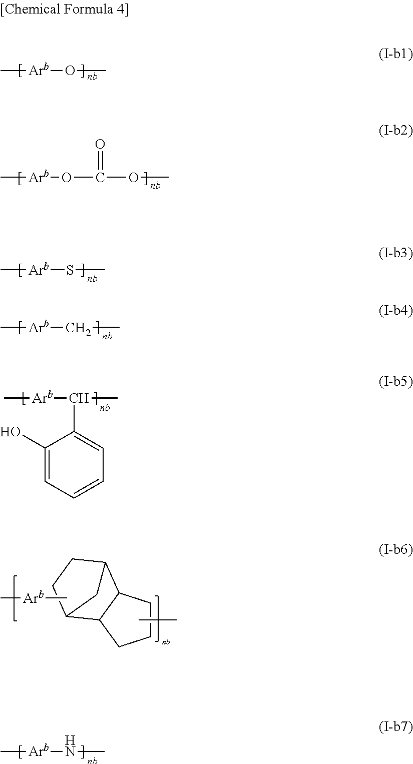

wherein
Ar^{b} each independently represents a divalent group comprising a C₆₋₂₀ aromatic hydrocarbon moiety optionally having one or more substituents,
nb represents an integer of 1 or more, and
Formulas (I-b1), (I-b2), (I-b3), (I-b4), (I-b5), (I-b6), and (I-b7) each comprise one or more C₂₋₂₀ fluorine-containing organic groups.
   <7>

The fluorine-containing aromatic polymer according to any one of <1> to <3>, wherein
Formula (I) is represented by Formula (I-c):

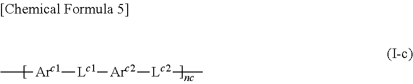

wherein
Ar^{c1} each independently represents a divalent group comprising a C₆₋₂₀ aromatic hydrocarbon moiety optionally having one or more substituents,
Ar^{c2} each independently represents a divalent group comprising a C₆₋₂₀ aromatic hydrocarbon moiety optionally having one or more substituents,
L^{c1} each independently represents one selected from the group consisting of —R¹—, —O—, —S—, —NR²—, —CO—, —CO—O—, —O—CO—, —O—CO—O—, —SO₂—, —NR²—CO—, and CO—NR²—,
L^{c2} each independently represents one selected from the group consisting of —R¹—, —O—, —S—, —NR²—, —CO—, —CO—O—, —O—CO—, —O—CO—O—, —SO₂—, —NR²—CO—, and CO—NR²—, in at least one combination of Ar^{c1} and Ar^{c2}; or L^{c1} and L^{c2}, one group is different from the other,
R¹ each independently represents one selected from a C₁₋₁₆ alkylene group optionally having a substituent; and a divalent group comprising a C₃₋₁₆ alicyclic hydrocarbon moiety optionally having one or more substituents,
R² each independently represents a C₁₋₁₆ alkyl group optionally having one or more substituents; a C₆₋₂₀ aromatic hydrocarbon group optionally having one or more substituents; or hydrogen atom,
nc represents an integer of 1 or more, and
Formula (I-c) comprises one or more C₂₋₂₀ fluorine-containing organic groups.
   <8>

The fluorine-containing aromatic polymer according to <7>, wherein
Formula (I-c) is represented by Formula (I-c1), (I-c2), or (I-c3):

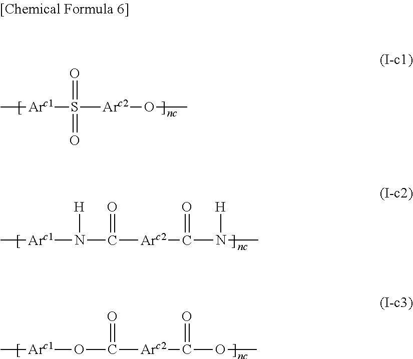

wherein
Ar^{c1} each independently represents a divalent group comprising a C₆₋₂₀ aromatic hydrocarbon moiety optionally having one or more substituents,
Ar^{c2} each independently represents a divalent group comprising a C₆₋₂₀ aromatic hydrocarbon moiety optionally having one or more substituents,
nc each independently represents an integer of 1 or more, and
Formulas (I-c1), (I-c2), and (I-c3) each comprise one or more C₂₋₂₀ fluorine-containing organic groups.
   <9>

The fluorine-containing aromatic polymer according to any one of <1> to <3>, wherein
Formula (I) is represented by Formula (I-d):

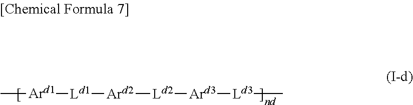

wherein
Ar^{d1} each independently represents a divalent group comprising a C₆₋₂₀ aromatic hydrocarbon moiety optionally having one or more substituents,
Ar^{d2} each independently represents a divalent group comprising a C₆₋₂₀ aromatic hydrocarbon moiety optionally having one or more substituents,
Ar^{d3} each independently represents a divalent group comprising a C₆₋₂₀ aromatic hydrocarbon moiety optionally having one or more substituents,
L^{d1} each independently represents one selected from the group consisting of —R¹—, —O—, —S—, —NR²—, —CO—, —CO—O—, —O—CO—, —O—CO—O—, —SO₂—, —NR²—CO—, and CO—NR²—,
L^{d2} each independently represents one selected from the group consisting of —R¹—, —O—, —S—, —NR²—, —CO—, —CO—O—, —O—CO—, —O—CO—O—, —SO₂—, —NR²—CO—, and CO—NR²—,
L^{d3} each independently represents one selected from the group consisting of —R¹—, —O—, —S—, —NR²—, —CO—, —CO—O—, —O—CO—, —O—CO—O—, —SO₂—, —NR²—CO—, and CO—NR²—,
in at least one combination of Ar^{d1}, Ar^{d2}, and Ar^{d3}; or L^{d1}, L^{d2}, and L^{d3}; one group is different from at least one of the other two groups,
R¹ each independently represents one selected from a C₁₋₁₆ alkylene group optionally having one or more substituents; and a divalent group comprising a C₃₋₁₆ alicyclic hydrocarbon moiety optionally having one or more substituents,
R² each independently represents a C₁₋₁₆ alkyl group optionally having one or more substituents; a C₆₋₂₀ aromatic hydrocarbon group optionally having one or more substituents; or hydrogen atom,
nd represents an integer of 1 or more, and
Formula (I-d) comprises one or more C₂₋₂₀ fluorine-containing organic groups.
   <10>

The fluorine-containing aromatic polymer according to <9>, wherein
Formula (I-d) is represented by Formula (I-d1) or (I-d2):

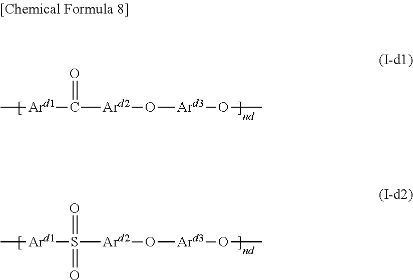

wherein
Ar^{d1} each independently represents a divalent group comprising a C₆₋₂₀ aromatic hydrocarbon moiety optionally having one or more substituents,
Ar^{d2} each independently represents a divalent group comprising a C₆₋₂₀ aromatic hydrocarbon moiety optionally having one or more substituents,
Ar^{d3} each independently represents a divalent group comprising a C₆₋₂₀ aromatic hydrocarbon moiety optionally having one or more substituents,
nd each independently represents an integer of 1 or more, and
Formulas (I-d1) and (I-d2) each comprise one or more C₂₋₂₀ fluorine-containing organic groups.
   <11>

The fluorine-containing aromatic polymer according to any one of <1> to <3>, wherein
Formula (I) is represented by Formula (I-e):

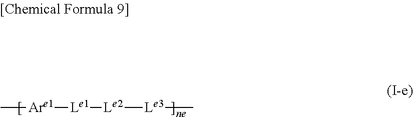

wherein
Ar^{c1} each independently represents a divalent group comprising a C₆₋₂₀ aromatic hydrocarbon moiety optionally having one or more substituents,
L^{c1} each independently represents one selected from the group consisting of —R¹—, —O—, —S—, —NR²—, —CO—, —CO—O—, —O—CO—, —O—CO—O—, —SO₂—, —NR²—CO—, and CO—NR²—,
L^{c2} each independently represents one selected from the group consisting of —R¹—, —O—, —S—, —NR²—, —CO—, —CO—O—, —O—CO—, —O—CO—O—, —SO₂—, —NR²—CO—, and CO—NR²—,
L^{c3} each independently represents one selected from the group consisting of —R¹—, —O—, —S—, —NR²—, —CO—, —CO—O—, —O—CO—, —O—CO—O—, —SO₂—, —NR²—CO—, and CO—NR²—,
R¹ each independently represents one selected from a C₁₋₁₆ alkylene group optionally having one or more substituents; and a divalent group comprising a C₃₋₁₆ alicyclic hydrocarbon moiety optionally having one or more substituents,
R² each independently represents a C₁₋₁₆ alkyl group optionally having one or more substituents; a C₆₋₂₀ aromatic hydrocarbon group optionally having one or more substituents; or hydrogen atom,
ne represents an integer of 1 or more, and
Formula (I-e) comprises one or more C₂₋₂₀ fluorine-containing organic groups.
   <12>

The fluorine-containing aromatic polymer according to <11>, wherein
Formula (I-e) is represented by Formula (I-e1), (I-e2), or (I-e3):

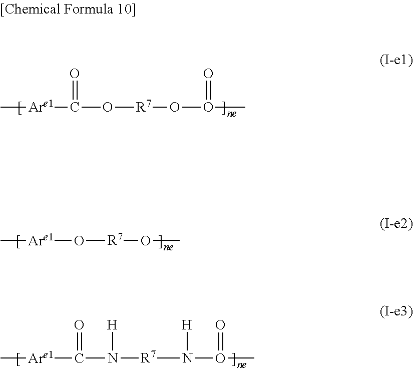

wherein
Ar^{c1} each independently represents a divalent group comprising a C₆₋₂₀ aromatic hydrocarbon moiety optionally having one or more substituents,
R⁷ represents one selected from a C₁₋₁₆ alkylene group optionally having one or more substituents; and a divalent group comprising a C₃₋₁₆ alicyclic hydrocarbon moiety optionally having one or more substituents,
ne each independently represents an integer of 1 or more, and
Formulas (I-e1), (I-e2), and (I-e3) each comprise one or more C₂₋₂₀ fluorine-containing organic groups.
   <13>

The fluorine-containing aromatic polymer according to any one of <1> to <3>, wherein
Formula (I) is represented by Formula (I-g):

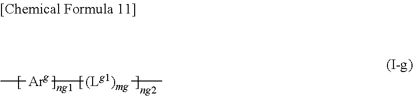

wherein
Ar^{g} each independently represents a divalent group comprising a C₆₋₂₀ aromatic hydrocarbon moiety optionally having one or more substituents,
L^{g1} represents a divalent group comprising a C₃₋₁₆ alicyclic hydrocarbon moiety optionally having one or more substituents,
mg each independently represents an integer of 0 to 4,
ng1 represents an integer of 1 or more,
ng2 represents an integer of 1 or more, and
Formula (I-g) comprises one or more C₂₋₂₀ fluorine-containing organic groups.
   <14>

The fluorine-containing aromatic polymer according to any one of <1> to <3>, wherein
Formula (I) is represented by Formula (I-h):

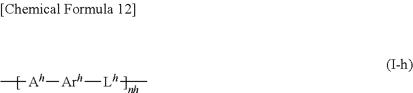

wherein
A^{h} each independently represents an aliphatic or aromatic imide-diyl group,
Ar^{h} each independently represents a divalent group comprising a C₆₋₂₀ aromatic hydrocarbon moiety optionally having one or more substituents,
L^{h} each independently represents one selected from the group consisting of —R¹—, —O—, —S—, —NR²—, —CO—, —CO—O—, —O—CO—, —O—CO—O—, —SO₂—, —NR²—CO—, and CO—NR²—,
R¹ each independently represents one selected from a C₁₋₁₆ alkylene group optionally having a substituent; and a divalent group comprising a C₃₋₁₆ alicyclic hydrocarbon moiety optionally having one or more substituents,
R² each independently represents a C₁₋₁₆ alkyl group optionally having one or more substituents; a C₆₋₂₀ aromatic hydrocarbon group optionally having one or more substituents; or hydrogen atom,
nh represents an integer of 1 or more, and
Formula (1-h) comprises one or more C₁₋₂₀ fluorine-containing organic groups.
   <15>

The fluorine-containing aromatic polymer according to <14>, wherein
Formula (I-h) is represented by Formula (I-h1):

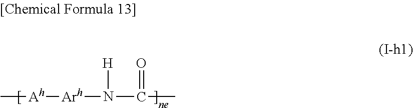

wherein
A^{h} each independently represents an aliphatic or aromatic imide-diyl group,
Ar^{h} each independently represents a divalent group comprising a C₆₋₂₀ aromatic hydrocarbon moiety optionally having one or more substituents,
nh each independently represents an integer of 1 or more, and
Formula (I-h1) comprises one or more C₁₋₂₀ fluorine-containing organic groups.
   <16>

The fluorine-containing aromatic polymer according to any one of <1> to <15>, wherein
A is represented by Formula (A2-I):

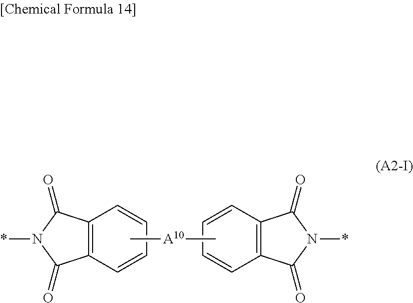

wherein
A¹⁰ represents single bond or a divalent organic group, and
* represents a bond, or
A is represented by Formula (A2-II):

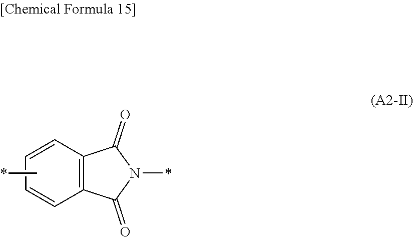

wherein * represents a bond.
   <17>

The fluorine-containing aromatic polymer according to <16>, wherein
A¹⁰ is one selected from single bond and groups represented by Formulas (a-1) to (a-7):

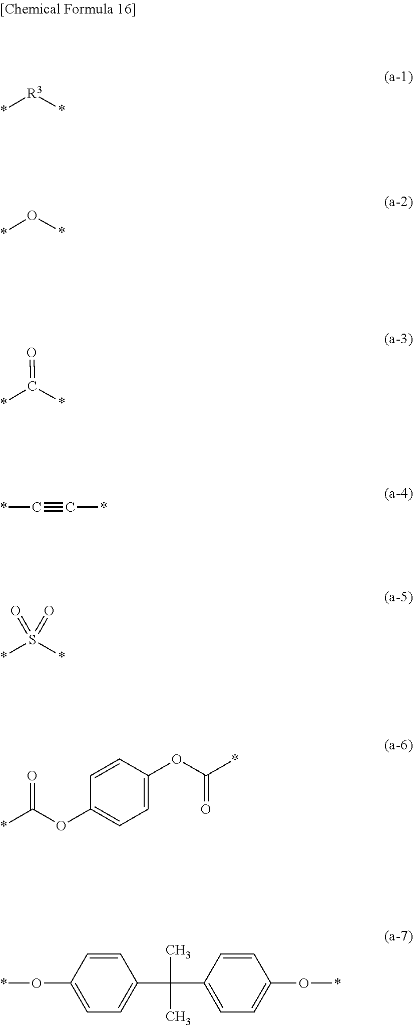

wherein
R³ represents a C₁₋₁₆ alkylene group optionally substituted with fluorine atom, and
*represents a bond.
   <18>

The fluorine-containing aromatic polymer according to <14>, wherein
A is one selected from groups represented by Formulas (A1-1) to (A1-19):

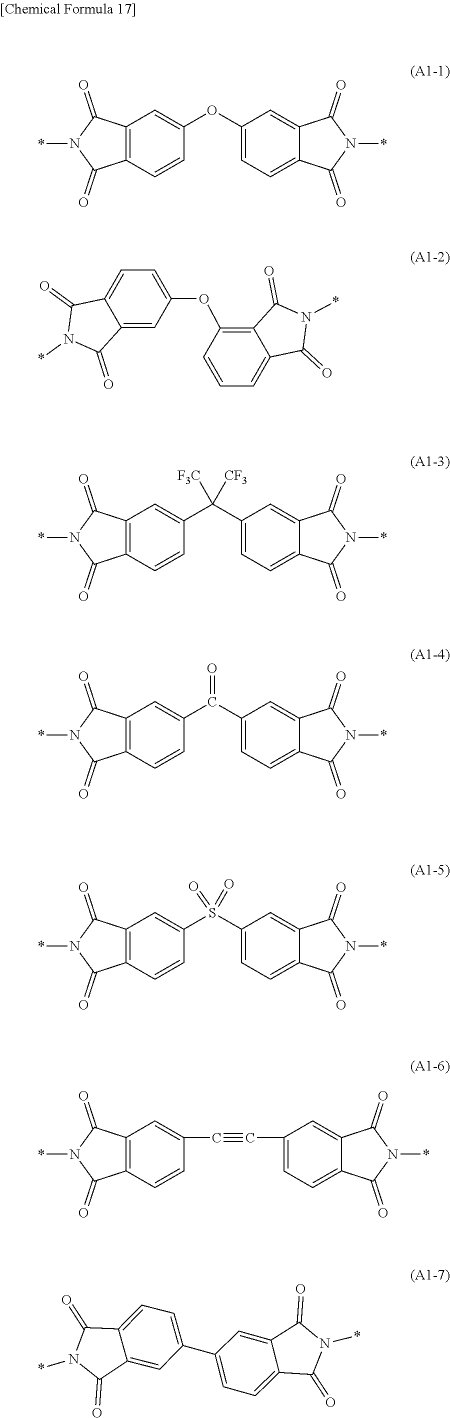

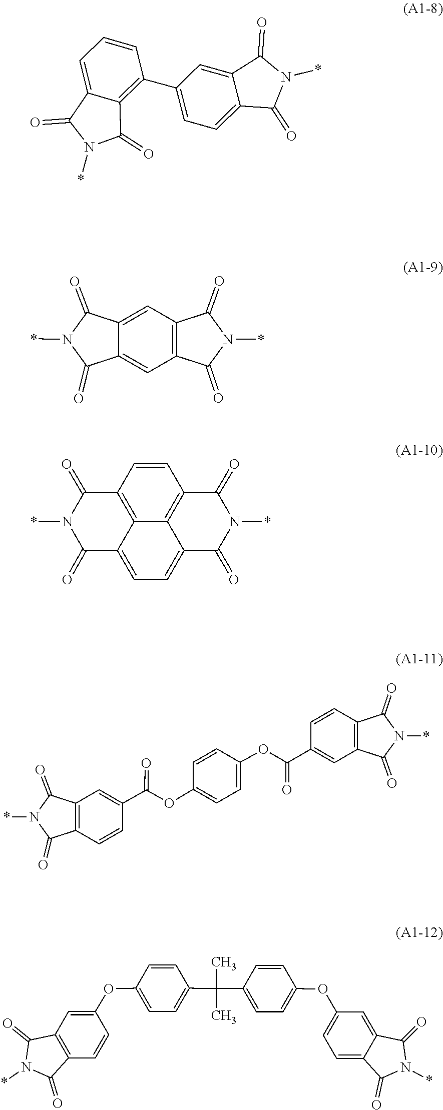 [SMILES: *N1C(=O)c2ccc(-c3cccc4c3C(=O)N(*)C4=O)cc2C1=O ; *n1c(=O)c2cc3c(=O)n(*)c(=O)c3cc2c1=O ; *N1C(=O)c2ccc3c4c(ccc(c24)C1=O)C(=O)N(*)C3=O ; *N1C(=O)c2ccc(C(=O)Oc3ccc(OC(=O)c4ccc5c(c4)C(=O)N(*)C5=O)cc3)cc2C1=O ; *N1C(=O)c2ccc(Oc3ccc(C(C)(C)c4ccc(Oc5ccc6c(c5)C(=O)N(*)C6=O)cc4)cc3)cc2C1=O]

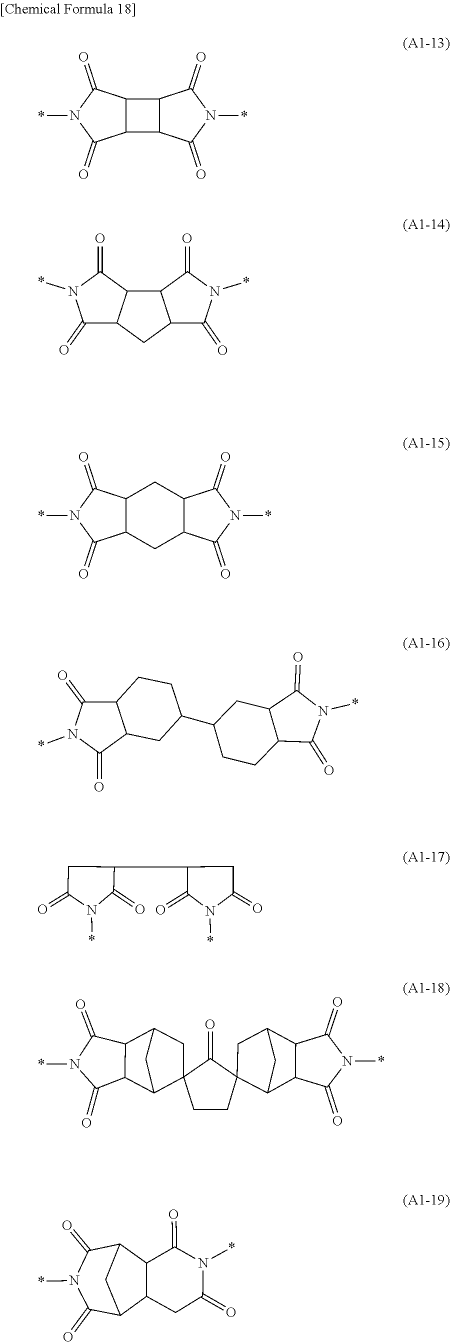

wherein * represents a bond.
   <10>

A method for producing a fluorine-containing aromatic polymer represented by Formula (I-1):

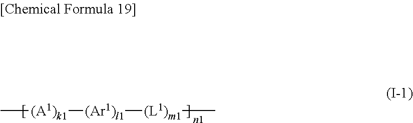

wherein
A¹ each independently represents an aliphatic or aromatic imide-diyl group,
Ar¹ each independently represents a divalent group comprising a C₆₋₂₀ aromatic hydrocarbon moiety optionally having one or more substituents,
L¹ each independently represents one selected from the group consisting of —R¹¹—, —O—, —S—, —NR¹²—, —CO—, —CO—O—, —O—CO—, —O—CO—O—, —SO₂—, —NR¹²—CO—, and CO—NR¹²—,
R¹¹ each independently represents one selected from a C₁₋₁₆ alkylene group optionally having a substituent; and a divalent group comprising a C₃₋₁₆ alicyclic hydrocarbon moiety optionally having one or more substituents,
R¹² each independently represents a C₁₋₁₆ alkyl group optionally having a substituent; a C₆₋₂₀ aromatic hydrocarbon group optionally having one or more substituents; or hydrogen atom,
k1 each independently represents an integer of 0 to 4,
l1 each independently represents an integer of 1 to 4,
m1 each independently represents an integer of 0 to 4,
n1 represents an integer of 1 or more,
in a unit enclosed in parentheses with n1, units enclosed in parentheses with k1, l1, and m1 appear in any order, and
Formula (I-1) comprises 1 or more C₁₋₂₀ fluorine-containing organic groups,
the method comprising reacting an aromatic polymer represented by Formula (I-2):

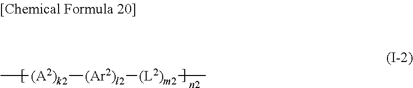

wherein
A² each independently represents an aliphatic or aromatic imide-diyl group,
Ar² each independently represents a divalent group comprising a C₆₋₂₀ aromatic hydrocarbon moiety optionally having one or more substituents,
L each independently represents one selected from the group consisting of —R²¹—, —O—, —S—, —NR²²—, —CO—, —CO—O—, —O—CO—, —O—CO—O—, —SO₂—, —NR²²—CO—, and CO—NR²²—
R²¹ each independently represents one selected from a C₁₋₁₆ alkylene group optionally having one or more substituents; and a divalent group comprising a C₃₋₁₆ alicyclic hydrocarbon moiety optionally having one or more substituents,
R²² each independently represents a C₁₋₁₆ alkyl group optionally having one or more substituents; a C₆₋₂₀ aromatic hydrocarbon group optionally having one or more substituents; or hydrogen atom,
k2 each independently represents an integer of 0 to 4,
l2 each independently represents an integer of 1 to 4,
m2 each independently represents an integer of 0 to 4,
n2 represents an integer of 1 or more, and
in a unit enclosed in parentheses with n2, units enclosed in parentheses with k2, l2, and m2 appear in any order,
with a compound represented by Formula (II):

I—R^{f1} (II)
wherein R^{f1} represents a C₁₋₂₀ fluorine-containing organic group.
   <20>

A method for producing a fluorine-containing aromatic polymer represented by Formula (I-1):

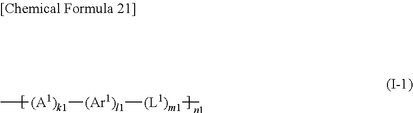

wherein
A¹ each independently represents an aliphatic or aromatic imide-diyl group,
Ar¹ each independently represents a divalent group comprising a C₆₋₂₀ aromatic hydrocarbon moiety optionally having one or more substituents,
L¹ each independently represents one selected from the group consisting of —R¹¹—, —O—, —S—, —NR¹²—, —CO—, —CO—O—, —O—CO—, —O—CO—O—, —SO₂—, —NR¹²—CO—, and CO—NR¹²—,
R¹¹ each independently represents one selected from a C₁₋₁₆ alkylene group optionally having a substituent; and a divalent group comprising a C₃₋₁₆ alicyclic hydrocarbon moiety optionally having one or more substituents,
R¹² each independently represents a C₁₋₁₆ alkyl group optionally having a substituent; a C₆₋₂₀ aromatic hydrocarbon group optionally having one or more substituents; or hydrogen atom,
k1 each independently represents an integer of 0 to 4,
l1 each independently represents an integer of 1 to 4,
m1 each independently represents an integer of 0 to 4,
n1 represents an integer of 1 or more, and
in a unit enclosed in parentheses with n1, units enclosed in parentheses with k1, l1, and m1 appear in any order, and
Formula (I-1) comprises one or more C₁₋₂₀ fluorine-containing organic groups,
the method comprising:
reacting an aromatic monomer with a compound to obtain a fluorine-containing aromatic monomer, the compound represented by Formula (II):

I—R^{f1} (II)
wherein R^{f1} represents a C₁₋₂₀ fluorine-containing organic group; and
using the fluorine-containing aromatic monomer as a monomer to obtain a fluorine-containing aromatic polymer.
   <21>

The method according to <20>, wherein
the aromatic monomer is represented by Formula (III):

R⁴—Ar³—R⁴ (III)
wherein
Ar³ each independently represents a divalent group comprising a C₆₋₂₀ aromatic hydrocarbon moiety optionally having one or more substituents, and
R⁴ each independently represents —OH, —NH₂, a fluorine atom, or a chlorine atom.
   <22>

The method according to <20> or <21>, comprising reacting the fluorine-containing aromatic monomer with a second monomer to obtain a fluorine-containing aromatic polymer.

<23>

The method according to <22>, wherein the second monomer is a monomer having two or more groups capable of reacting with an amino group or a hydroxyl group in one molecule.

<24>

The method according to <22> or <23>, wherein
the second monomer is a compound represented by Formula (IV):

R⁵-L¹⁰-R⁵ (IV)
wherein
R⁵ each independently represents one selected from Formulas (r-1) to (r-18):

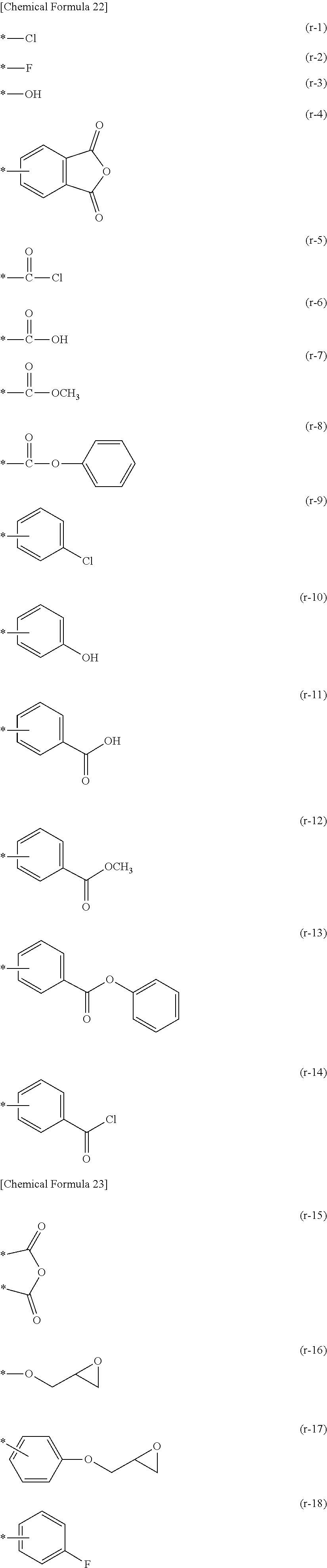

wherein * represents a bond, and
L¹⁰ represents one selected from Formulas (l-1) to (l-11):

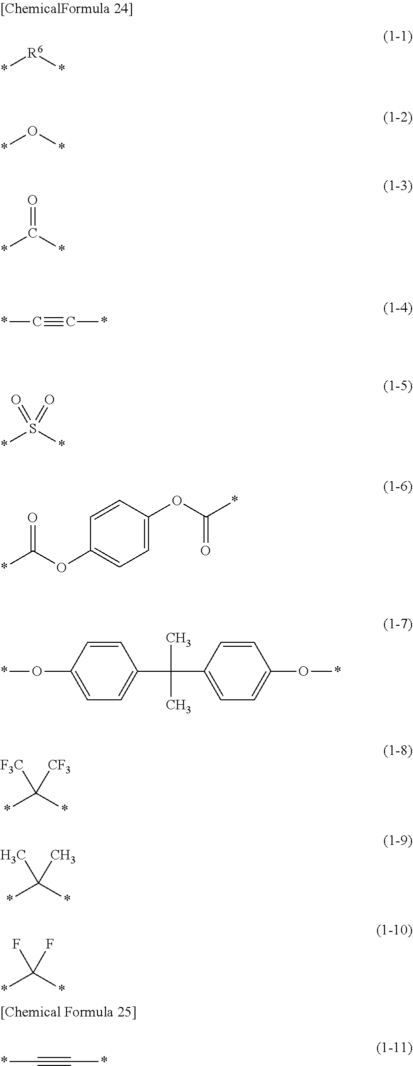

wherein
R⁶ represents single bond; a C₁₋₁₆ alkylene group optionally substituted with one or more fluorine atoms; or a divalent C₆₋₂₀ aromatic hydrocarbon group optionally having one or more substituents, and
* represents a bond.
   <25>

A fluorine-containing aromatic monomer represented by Formula (III-1):

[Chemical Formula 26]

R⁴¹—Ar³¹—R⁴¹ (III-1)
wherein
Ar³¹ each independently represents a divalent group comprising a C₆₋₂₀ aromatic hydrocarbon moiety optionally having one or more substituents,
R⁴¹ each independently represents —OH, —NH₂, glycidyloxy group, fluorine atom, or chlorine atom, and
Formula (III-1) comprises one or more C₁₋₂₀ fluorine-containing organic groups,
the C₁₋₂₀ fluorine-containing organic groups are represented by one or more selected from Formula (2-1A) and Formula (2B):

R³³—X¹—(R^{F1})ᵣ—CF₂—* (2-1A)

*—X¹—CF₂—* (2B)
wherein
R^{F1} represents —(Rf)ₚ—R^{F}—O)_{q},
Rf each independently represents a C₁₋₁₆ alkylene group optionally substituted with one or more fluorine atoms,
R^{F} represents a divalent fluoro(poly)ether group,
X¹ represents a C₁₋₁₆ alkylene group optionally substituted with one or more halogen atoms; or single bond,
R³³ represents a C₆₋₂₀ aromatic hydrocarbon group optionally having one or more substituents; a silsesquioxane residue optionally having one or more substituents; —COOR^{f2}; —OR^{f2}; —SO₂R^{f3}; —CR^{f4}═CR^{f5}₂; fluorine atom; bromine atom; or iodine atom,
R^{f2} each independently represents a C₁₋₁₆ alkyl group optionally substituted with one or more fluorine atoms; or hydrogen atom,
R^{f3} represents a C₁₋₁₆ alkyl group optionally substituted with one or more halogen atoms; a fluorine atom; or hydrogen atom,
R^{f4} each independently represents hydrogen atom or fluorine atom,
p is 0 or 1, q is 0 or 1, r is 0 or 1,
* represents a bond,
Formula (2-1A) comprises 1 to 20 carbon atoms, and
Formula (2B) comprises 1 to 20 carbon atoms.
   <26>

A product comprising:
a substrate; and
a layer formed on a surface of the substrate using a surface treatment agent,
wherein the substrate comprising an aromatic polymer,
wherein the surface treatment agent comprising a compound represented by one or more selected from Formula (II-1A) and Formula (II-1B):

R³²—X¹—(R^{F1})ᵣ—CF₂—I (II-1A)

I-X¹—CF₂—I (II-1B)
wherein
R^{F1} represents —(Rf)ₚ—R^{F}—O)_{q},
Rf each independently represents a C₁₋₁₆ alkylene group optionally substituted with one or more fluorine atoms,
R^{F} represents a divalent fluoro(poly)ether group,
X¹ represents a C₁₋₁₆ alkylene group optionally substituted with one or more halogen atoms; or single bond,
R³² represents a C₁₋₁₆ alkyl group optionally substituted with one or more halogen atoms; a C₆₋₂₀ aromatic hydrocarbon group optionally having one or more substituents; a silsesquioxane residue optionally having one or more substituents; —COOR^{f2}; —OR^{f2}; —SO₂R^{f3}; —CR^{f4}═CR^{f4}₂; fluorine atom; bromine atom; or iodine atom,
R² each independently represents a C₁₋₁₆ alkyl group optionally substituted with one or more fluorine atoms; or hydrogen atom,
R^{f3} represents a C₁₋₁₆ alkyl group optionally substituted with one or more halogen atoms; fluorine atom; or hydrogen atom,
R^{f4} each independently represents hydrogen atom or fluorine atom,
p is 0 or 1, q is 0 or 1, r is 0 or 1,
* represents a bond,
Formula (II-1A) comprises 1 to 20 carbon atoms, and
Formula (II-1B) comprises 1 to 20 carbon atoms.
   <27>

A method for producing a product, the method comprising reacting a substrate with a surface treatment agent to form a layer on a surface of the substrate,
the substrate containing an aromatic polymer,
the surface treatment agent containing a compound represented by one or more selected from Formula (II-1A) and Formula (II-1B):

R³²—X¹—(R^{F1})ᵣ—CF₂—I (II-1A)

I-X¹—CF₂—I (II-1B)
wherein
R^{F1} represents —(Rf)ₚ—R^{F}—O)_{q},
Rf each independently represents a C₁₋₁₆ alkylene group optionally substituted with one or more fluorine atoms,
R^{F} represents a divalent fluoro(poly)ether group,
X¹ represents a C₁₋₁₆ alkylene group optionally substituted with one or more halogen atoms; or single bond,
R³² represents a C₁₋₁₆ alkyl group optionally substituted with one or more halogen atoms; a C₆₋₂₀ aromatic hydrocarbon group optionally having one or more substituents; a silsesquioxane residue optionally having one or more substituents; —COOR^{f2}; —OR^{f2}; —SO₂R^{f3}; —CR^{f4}═CR^{f4}₂; fluorine atom; bromine atom; or iodine atom,
R^{f2} each independently represents a C₁₋₁₆ alkyl group optionally substituted with one or more fluorine atoms; or a hydrogen atom,
R^{f3} represents a C₁₋₁₆ alkyl group optionally substituted with one or more halogen atoms; fluorine atom; or hydrogen atom,
R^{f4} each independently represents hydrogen atom or fluorine atom,
p is 0 or 1, q is 0 or 1, r is 0 or 1,
* represents a bond,
Formula (II-1A) comprises 1 to 20 carbon atoms, and
Formula (II-1B) comprises 1 to 20 carbon atoms.

### Effects of the Invention

According to the present disclosure, novel fluorine-containing aromatic polymers having various structures may be provided.

### DETAILED DESCRIPTION

(Fluorine-containing aromatic polymer)

The fluorine-containing aromatic polymer of the present disclosure is represented by Formula (I):

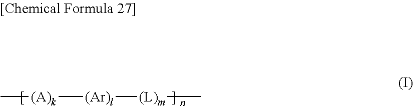

wherein
A each independently represents an aliphatic or aromatic imide-diyl group,
Ar each independently represents a divalent group comprising a C₆₋₂₀ aromatic hydrocarbon moiety optionally having one or more substituents,
L each independently represents one selected from the group consisting of —R¹—, —O—, —S—, —NR²—, —CO—, —CO—O—, —O—CO—, —O—CO—O—, —SO₂—, —NR²—CO—, and CO—NR²—,
R¹ each independently represents one selected from a C₁₋₁₆ alkylene group optionally having one or more substituents; and a divalent group comprising a C₃₋₁₆ alicyclic hydrocarbon moiety optionally having one or more substituents,
R² each independently represents a C₁₋₁₆ alkyl group optionally having one or more substituents; a C₆₋₂₀ aromatic hydrocarbon group optionally having one or more substituents; or a hydrogen atom,
k each independently represents an integer of 0 to 4,
l each independently represents an integer of 1 to 4,
m each independently represents an integer of 0 to 4,
n represents an integer of 1 or more, and
in a unit enclosed in parentheses with n, units enclosed in parentheses with k, 1, and m may appear in any order, and
the Formula (I) satisfies (i) or (ii):
(i) k is 0, and Formula (I) comprises one or more C₂₋₂₀ fluorine-containing organic groups, and
(ii) k is 1 to 4, and Formula (I) comprises one or more C₁₋₂₀ fluorine-containing organic groups.

According to the present disclosure, novel fluorine-containing aromatic polymers may be provided in which a fluorine-containing organic group is introduced into various aromatic polymers. It is particularly expected that a fluorine-containing aromatic polymer having various structures widens the range of structure selection to enable provision of a new aromatic polymer (particularly, a super engineering plastic or an engineering plastic) having improved various properties such as flexibility, adhesion (reactivity) and affinity with another material, a low dielectric property, transparency, water/oil repellency, low tackiness, an antifouling property, solvent solubility, and high surface hardness.

A each independently represents an aliphatic or aromatic imide-diyl group. That is, A comprises one or two groups represented by the following formula:

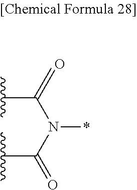

(hereinafter, also referred to as “imide-N-yl group”) wherein * represents a bond.

A preferably represents an aliphatic or aromatic imide-diyl group comprising one or more imide rings, and the aliphatic or aromatic imide-diyl group may have one or more substituents. The imide ring is a ring comprising an imide-N-yl moiety, and may be monocyclic or polycyclimayd the number of imide bonds comprised in one imide ring may be one or two or more. The number of ring members of the imide ring may be preferably 5 to 20, more preferably 5 to 15, and still more preferably 5 to 10.

Examples of the imide ring include 2,5-dioxopyrrolidine ring, 1,3-dioxohexahydroisoindoline ring, 1,2,3,4-cyclobutyltetracarboxylic acid diimide ring, 1,2,4,5-cyclopentyltetracarboxylic acid diimide ring, hexahydropyromellitic acid diimide ring, 1,3-dioxoisoindoline ring, pyromellitic acid diimide ring, and 1,4,5,8-naphthalenetetracarboxylic acid diimide ring, and 2,5-dioxopyrrolidine ring and 1,3-dioxoisoindoline ring are preferable.

The number of imide rings comprised in the aliphatic or aromatic imide-diyl group is preferably 1 or 2, and more preferably 2.

The substituent that may be comprised in the aliphatic or aromatic imide-diyl group represented by A will be described below.

A is preferably represented by Formula (A1-I):

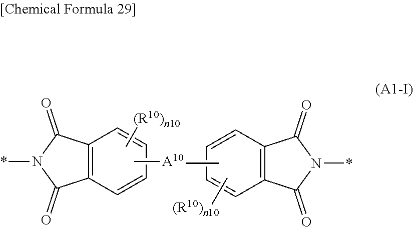

wherein
A¹⁰ represents single bond or a divalent organic group,
R¹⁰ represents a substituent,
n10 represents an integer of 0 to 3, and
* represents a bond
or
A is preferably represented by Formula (A1-II):

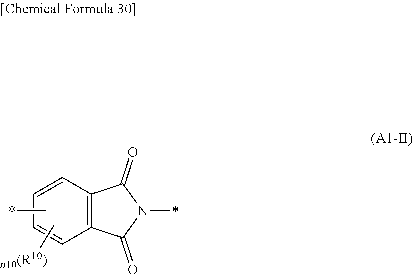

wherein
R¹⁰ represents a substituent,
n10 represents an integer of 0 to 3, and
* represents a bond.

When A is a group represented by Formula (A1-I) or (A1-II), the heat resistance of the fluorine-containing aromatic polymer may be improved.

A¹⁰ represents single bond or a divalent organic group. Examples of the organic group include a C₁₋₁₆ alkylene group optionally substituted with a fluorine atom; a divalent group comprising a C₆₋₂₀ aromatic hydrocarbon moiety optionally having one or more substituents; —O—, —CO—; —C≡C—; —SO₂—; and groups obtained by combining these groups.

The “C₁₋₁₆ alkylene moiety” in the C₁₋₁₆ alkylene group optionally substituted with a fluorine atom may be linear or branched, and is preferably a linear or branched C₁₋₁₀ alkylene moiety, and more preferably a linear or branched C₁₋₅ alkylene moiety. In one aspect, the “C₁₋₁₆ alkylene moiety” is preferably a branched C₂₋₄ alkylene moiety, and in another aspect, preferably a methylene moiety.

The C₁₋₁₆ alkylene group optionally substituted with one or more fluorine atoms is preferably —CH₂—, —C(CH₃)₂—, —CF₂—, or C(CF₃)₂—.

The “C₆₋₂₀ aromatic hydrocarbon moiety” in the divalent group comprising a C₆₋₂₀ aromatic hydrocarbon moiety optionally having one or more substituents may be monocyclic or polycyclimayd in the polycyclic ring, two or more rings may or may not form a fused ring. The number of aromatic hydrocarbon moieties in the divalent group comprising a C₆₋₂₀ aromatic hydrocarbon moiety optionally having one or more substituents is 1 or more, and may be preferably 1 to 4, more preferably 1 to 3, and still more preferably 1 or 2. The aromatic hydrocarbon moiety is preferably a C₆₋₁₀ aromatic hydrocarbon moiety, and more preferably a phenylene moiety, a tolylene moiety, a xylylene moiety, or a naphthylene moiety. In one aspect, the aromatic hydrocarbon moiety is more preferably a phenylene moiety, a tolylene moiety, or a xylylene moiety, and in another aspect, may be still more preferably a naphthylene moiety.

In the divalent group comprising a C₆₋₂₀ aromatic hydrocarbon moiety optionally having one or more substituents, two or more aromatic hydrocarbon moieties may be bonded via a single bond or an organic moiety. Examples of the organic moiety include a linear or branched C₁₋₄ alkyl moiety.

The substituents in the divalent group represented by A¹⁰ that comprises a C₆₋₂₀ aromatic hydrocarbon moiety optionally having one or more substituents will be described below.

The substituent represented by R¹⁰ will be described below.

In one aspect, A¹⁰ preferably comprise no substituent. Specifically, A is preferably a group represented by Formula (A2-I) or (A2-II). A¹⁰ has the same meaning as described above

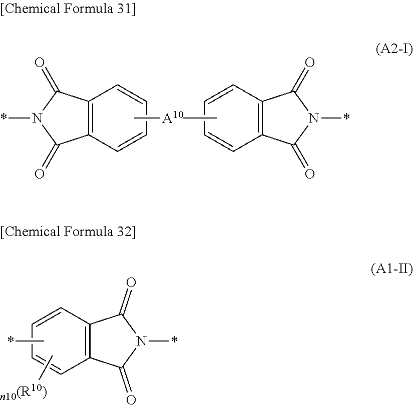

wherein A¹⁰ is preferably selected from single bond and groups represented by Formulas (a-1) to (a-7):

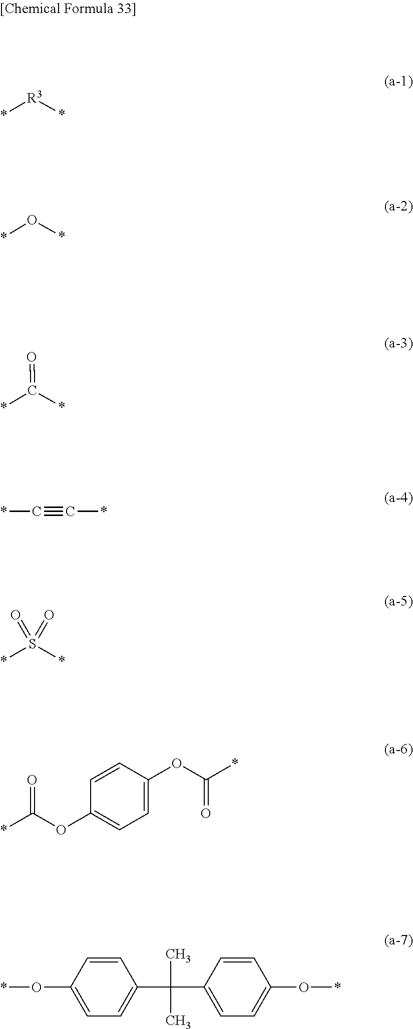

wherein
R³ represents a C₁₋₁₆ alkylene group optionally substituted with a fluorine atom, and
*represents a bond.

R³ represents a C₁₋₁₆ alkylene group optionally substituted with a fluorine atom. The “C₁₋₁₆ alkylene moiety” in the C₁₋₁₆ alkylene group optionally substituted with a fluorine atom may be linear or branched, and is preferably a linear or branched C₁₋₁₀ alkylene moiety, and more preferably a linear or branched C₁₋₅ alkylene moiety.

Among them, groups represented by Formula (a-3) and Formula (a-7) are preferable as A.

A is preferably a group represented by a formula selected from Formula (A1-1) to (A1-19):

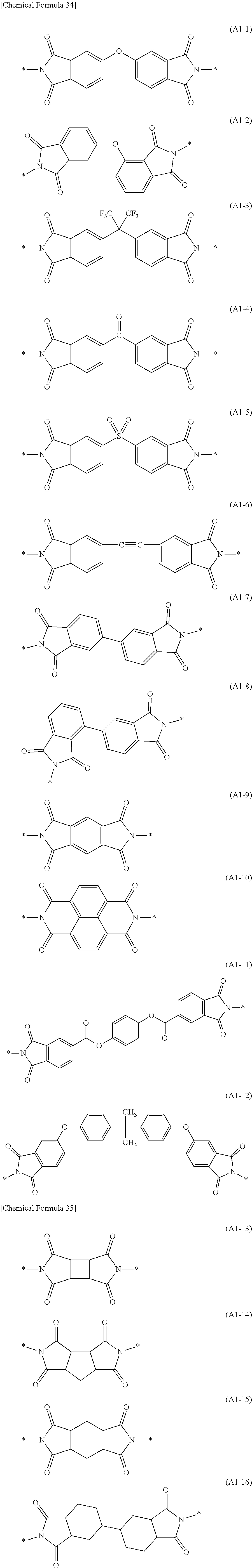

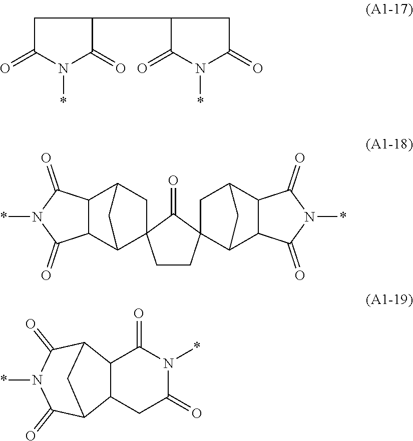 [SMILES: *N1C(=O)CC(C2CC(=O)N(*)C2=O)C1=O ; *N1C(=O)C2C3CC(C2C1=O)C1(CCC2(CC4CC2C2C(=O)N(*)C(=O)C42)C1=O)C3 ; *N1C(=O)C2CC(C1=O)C1C(=O)N(*)C(=O)CC21]

wherein * represents a bond.

Ar each independently represents a divalent group comprising a C₆₋₂₀ aromatic hydrocarbon moiety optionally having one or more substituents. The “C₆₋₂₀ aromatic hydrocarbon moiety” in the divalent group comprising a C₆₋₂₀ aromatic hydrocarbon moiety optionally having one or more substituents may be monocyclic or polycyclimayd in the polycyclic ring, two or more rings may or may not form a fused ring. In the divalent group comprising a C₆₋₂₀ aromatic hydrocarbon moiety optionally having one or more substituents, the number of aromatic hydrocarbon moieties is 1 or more, and may be preferably 1 to 4, more preferably 1 to 3, and still more preferably 1 or 2. The aromatic hydrocarbon moiety is preferably a C₆₋₁₀ aromatic hydrocarbon moiety, and more preferably a phenylene moiety, a tolylene moiety, a xylylene moiety, or a naphthylene moiety, and may be still more preferably a phenylene moiety, a tolylene moiety, or a xylylene moiety.

In the divalent group comprising a C₆₋₂₀ aromatic hydrocarbon moiety optionally having one or more substituents, two or more aromatic hydrocarbon moieties may be bonded via a single bond or a divalent organic moiety. Examples of the organic moiety include a linear or branched C₁₋₄ alkyl moiety.

Ar is preferably represented by Formula (Ar1):

[Chemical Formula 36]

* —Ar¹¹—(X¹⁰—Ar¹²)ₙ₁₁-* (Ar1)
wherein
Ar¹¹ represents a divalent C₆₋₁₀ aromatic hydrocarbon group optionally having one or more substituents,
Ar¹² each independently represents a divalent C₆₋₁₀ aromatic hydrocarbon group optionally having one or more substituents,
X¹⁰ represents single bond, —O—, —CO—, —SO₂—, or a C₁₋₄ alkylene group,
n11 represents an integer of 0 to 3,
* represents a bond, and
Formula (Ar1) comprises 6 to 20 carbon atoms in total.

Ar¹¹ represents a divalent C₆₋₁₀ aromatic hydrocarbon group optionally having one or more substituents. The “divalent C₆₋₂₀ aromatic hydrocarbon moiety” in the divalent C₆₋₂₀ aromatic hydrocarbon group optionally having one or more substituents may be monocyclic or polycyclimayd in the polycyclic ring, two or more rings may or may not form a fused ring. The “divalent C₆₋₂₀ aromatic hydrocarbon moiety” in the divalent C₆₋₂₀ aromatic hydrocarbon group optionally having one or more substituents is preferably a divalent C₆₋₁₅ aromatic hydrocarbon moiety, more preferably a divalent C₆₋₁₀ aromatic hydrocarbon moiety, still more preferably a phenylene moiety, a tolylene moiety, a xylylene moiety, or a naphthylene moiety, and still even more preferably a phenylene moiety, a tolylene moiety, or a xylylene moiety.

The substituent that may be comprised in the divalent C₆₋₁₀ aromatic hydrocarbon group represented by Ar¹¹ will be described below.

Ar¹² each independently represents a divalent C₆₋₁₀ aromatic hydrocarbon group optionally having one or more substituents. The “divalent C₆₋₂₀ aromatic hydrocarbon moiety” in the divalent C₆₋₂₀ aromatic hydrocarbon group optionally having one or more substituents may be monocyclic or polycyclimayd in polycyclic ring, two or more rings may or may not form a fused ring. The “divalent C₆₋₂₀ aromatic hydrocarbon moiety” in the divalent C₆₋₂₀ aromatic hydrocarbon group optionally having one or more substituents is preferably a divalent C₆₋₁₅ aromatic hydrocarbon moiety, more preferably a divalent C₆₋₁₀ aromatic hydrocarbon moiety, still more preferably a phenylene moiety, a tolylene moiety, a xylylene moiety, or a naphthylene moiety, and still even more preferably a phenylene moiety, a tolylene moiety, or a xylylene moiety.

The substituent that may be comprised in the divalent C₆₋₁₀ aromatic hydrocarbon group represented by Ar¹² will be described below.

X¹⁰ represents single bond, —O—, —CO—, —SO₂—, or a C₁₋₄ alkylene group. The C₁₋₄ alkylene group may be linear or branched, and is preferably a linear or branched C₁₋₃ alkylene group. Specifically, the C₁₋₄ alkylene group may be —CH₂— or —C(CH₃)₂—.

The substituent that may be comprised in the divalent group represented by Ar that comprises a C₆₋₂₀ aromatic hydrocarbon moiety will be described below.

Ar is preferably phenylene group, tolylene group, xylylene group, hydroxyphenylene group, hydroxyxylylene group, naphthylene group, biphenylene group, 3,3′-dimethylbiphenylene group, 2,2′-dimethylbiphenylene group, 2,2′-dimethoxybiphenylene group, 3,3′,5,5′-tetramethylbiphenylene group, 3,3′,5,5′-tetraethylbiphenylene group, 2,2-diphenylpropane-4,4′-diyl group, 1,1-diphenylmethane-4,4′-diyl group, benzophenone-4,4′-diyl group, diphenylsulfone-4,4′-diyl group, or oxybisphenyl-4,4′-diyl group, and more preferably phenylene group, xylylene group, hydroxyphenylene group, hydroxyxylylene group, naphthylene group, 2,2-diphenylpropane-4,4′-diyl group, 1,1-diphenylmethane-4,4′-diyl group, benzophenone-4,4′-diyl group, diphenylsulfone-4,4′-diyl group, or oxybisphenyl-4,4′-diyl group.

L each independently represents one selected from the group consisting of —R¹—, —O—, —S—, —NR²—, —CO—, —CO—O—, —O—CO—, —O—CO—O—, —SO₂—, —NR²—CO—, and CO—NR²—.

R¹ each independently represents one selected from a C₁₋₁₆ alkylene group optionally having one or more substituents; and a divalent group comprising a C₃₋₁₆ alicyclic hydrocarbon moiety optionally having one or more substituents.

The “C₁₋₁₆ alkylene moiety” in the C₁₋₁₆ alkylene group optionally having one or more substituents may be linear or branched, and is preferably a linear or branched C₁₋₁₀ alkylene moiety, and more preferably a linear or branched C₁₋₅ alkylene moiety. In one aspect, the “C₁₋₁₆ alkylene moiety” is a linear or branched C₁₋₃ alkylene moiety, and may be specifically —CH₂—, —CH₂CH₂—, or —CH₂CH₂CH₂—.

The C₁₋₁₆ alkylene group optionally having one or more substituents may be substituted with one or more fluorine atoms. In one aspect, R¹ is preferably a C₁₋₁₆ fluoroalkylene group substituted with one or more fluorine atoms, more preferably a C₁₋₁₆ perfluoroalkylene group, still more preferably a C₁₋₆ perfluoroalkylene group, and still even more preferably a C₁₋₃ perfluoroalkylene group.

The C₁₋₁₆ perfluoroalkylene group may be linear or branched, and is preferably a linear or branched C₁₋₆ perfluoroalkylene group, more preferably a linear or branched C₁₋₃ perfluoroalkylene group, and specifically —CF₂—, —CF₂CF₂—, —CF₂CF₂CF₂—, —CF₂CF(CF₃)—, or —C(CF₃)₂—.

Another substituent that may be comprised in the C₁₋₁₆ alkylene group represented by R¹ will be described below.

The “C₃₋₁₆ alicyclic hydrocarbon moiety” in the divalent group comprising a C₃₋₁₆ alicyclic hydrocarbon moiety optionally having one or more substituents may be monocyclic or polycyclimayd in the polycyclic ring, two or more rings may or may not form a bridged ring. In the divalent group comprising a C₃₋₁₆ alicyclic hydrocarbon moiety optionally having one or more substituents, the number of alicyclic hydrocarbon moieties is 1 or more, and may be preferably 1 to 4, more preferably 1 to 3, and still more preferably 1 or 2. The divalent group comprising the alicyclic hydrocarbon moiety is preferably a divalent C₃₋₁₆ alicyclic hydrocarbon group, and more preferably a divalent C₆₋₁₂ alicyclic hydrocarbon group, and may be still more preferably a cyclohexanediyl group, a decahydronaphthyl group, an isobornyl group, a tricyclo[5.2.1.0^{2,6}]demayediyl group, or an adamantyl group.

In the divalent group comprising a C₃₋₁₆ alicyclic hydrocarbon moiety optionally having one or more substituents, two or more alicyclic hydrocarbon moieties may be bonded via a single bond or a divalent organic moiety. Examples of the organic moiety include a linear or branched C₁₋₄ alkyl moiety.

In one aspect, the divalent group represented by R¹ that comprises a C₃₋₁₆ alicyclic hydrocarbon moiety is a divalent group comprising a C₃₋₁₆ alicyclic hydrocarbon moiety having no substituent, and in another aspect, the divalent group is a divalent group comprising a C₃₋₁₆ alicyclic hydrocarbon moiety having a substituent. The substituent that may be comprised in the divalent group represented by R¹ that comprises a C₃₋₁₆ alicyclic hydrocarbon moiety will be described below.

In one aspect, R¹ may be a C₁₋₁₆ alkylene group having no substituent. In another aspect, R¹ may be a C₁₋₁₆ alkylene group having a substituent. In still another aspect, R¹ may be a divalent C₁₋₁₆ alicyclic hydrocarbon group having no substituent.

R² each independently represents a C₁₋₁₆ alkyl group optionally having one or more substituents, a C₆₋₂₀ aromatic hydrocarbon group optionally having one or more substituents, or a hydrogen atom. The “C₁₋₁₆ alkyl moiety” in the C₁₋₁₆ alkyl group optionally having one or more substituents may be linear or branched, and is preferably a linear or branched C₁₋₁₀ alkyl moiety, and more preferably a linear or branched C₁₋₅ alkyl moiety. In one aspect, the “C₁₋₁₆ alkyl moiety” is a linear or branched C₁₋₄ alkyl moiety, and may be specifically —CH₃, —CH₂CH₃, —CH₂CH₂CH₃, —CH(CH₃)₂, —CH₂CH₂CH₂CH₃, —CH₂CH(CH₃)₂, or —CH(CH₃)₃.

In one aspect, R² may be a C₁₋₁₆ alkyl group having no substituent. In another aspect, R² may be a C₁₋₁₆ alkyl group having a substituent.

The C₁₋₁₆ alkyl group optionally having one or more substituents may be substituted with one or more fluorine atoms. In one aspect, R² is preferably a C₁₋₁₆ fluoroalkyl group substituted with one or more fluorine atoms, more preferably a C₁₋₁₆ perfluoroalkyl group, still more preferably a C₁₋₆ perfluoroalkyl group, and still even more preferably a C₁₋₄ perfluoroalkyl group, and may be specifically —CF₃, —CF₂CF₃, —CF₂CF₂CF₃, —CF(CF₃)₂, —CF₂CF₂CF₂CF₃, —CF₂CF(CF₃)₂, or —CF(CF₃)₃.

Another substituent that may be comprised in the C₁₋₁₆ alkyl group represented by R² will be described below.

The “C₆₋₂₀ aromatic hydrocarbon moiety” in the C₆₋₂₀ aromatic hydrocarbon group optionally having one or more substituents may be monocyclic or polycyclimayd in the polycyclic ring, two or more rings may or may not form a fused ring. The C₆₋₂₀ aromatic hydrocarbon group optionally having one or more substituents is preferably a C₆₋₁₀ aromatic hydrocarbon group, and more preferably phenylene group, tolylene group, a xylylene group, or naphthylene group. In one aspect, the C₆₋₂₀ aromatic hydrocarbon group is more preferably phenylene group, tolylene group, or xylylene group, and in another aspect, may be still more preferably naphthylene group.

Examples of the substituent that may be comprised in the C₆₋₂₀ aromatic hydrocarbon group comprise a hydroxyl group.

L is preferably one selected from the group consisting of —O—, —S—, —CO—, —O—CO—O—, —SO₂—, —NR²—CO—, and CO—NR²—.

A substituent may be comprised in the aliphatic or aromatic imide-diyl group represented by A, the divalent group represented by Ar that comprises a C₆₋₂₀ aromatic hydrocarbon moiety, the divalent group represented by A¹⁰ that comprises a C₆₋₂₀ aromatic hydrocarbon moiety, the C₆₋₁₀ aromatic hydrocarbon group represented by Ar¹¹, the C₆₋₁₀ aromatic hydrocarbon group represented by Ar¹², the C₁₋₁₆ alkylene group represented by R¹, and the C₁₋₁₆ alkyl group represented by R². Examples of the substituent that may be comprised in the aliphatic or aromatic imide-diyl group represented by A, the divalent group represented by Ar that comprises a C₆₋₂₀ aromatic hydrocarbon moiety, the divalent group represented by A¹⁰ that comprises a C₆₋₂₀ aromatic hydrocarbon moiety, the C₆₋₁₀ aromatic hydrocarbon group represented by Ar¹¹, and the C₆₋₁₀ aromatic hydrocarbon group represented by Ar¹² and the substituent represented by R¹⁰ include one or more selected from C₁₋₂₀ fluorine-containing organic groups or C₂₋₂₀ fluorine-containing organic groups; C₁₋₁₆ alkyl groups each optionally substituted with one or more fluorine atoms; C₆₋₂₀ aromatic hydrocarbon groups each optionally substituted with one or more fluorine atoms; C₁₋₁₆ alkoxy groups; C₁₋₁₆ hydroxyalkyl groups; a hydroxyl group; carboxy group; glycidyl group; and a fluorine atom. Examples of the substituent that may be comprised in the C₁₋₁₆ alkylene group represented by R¹, the divalent group represented by R¹ that comprises a C₃₋₁₆ alicyclic hydrocarbon moiety, and the C₁₋₁₆ alkyl group represented by R² include one or more selected from C₁₋₂₀ fluorine-containing organic groups or C₂₋₂₀ fluorine-containing organic groups; C₆₋₂₀ aromatic hydrocarbon groups; a hydroxyl group; and a fluorine atom. The divalent group represented by Ar that comprises a C₆₋₂₀ aromatic hydrocarbon moiety, the C₆₋₁₀ aromatic hydrocarbon group represented by Ar¹¹, and the C₆₋₁₀ aromatic hydrocarbon group represented by Ar¹² may be modified with an oil such as cashew oil, linseed oil, castor oil, or Chinese tung oil.

The C₁₋₂₀ fluorine-containing organic group or the C₂₋₂₀ fluorine-containing organic group is an organic group comprising a fluorine atom, and may contain a hydrogen atom or an oxygen atom in addition to a fluorine atom and a carbon atom.

the C₂₋₂₀ fluorine-containing organic groups are represented by one or more selected from Formula (1A) and Formula (1B):

R³¹—X—(R^{F1})ᵣ—CF₂—* (1A)

*—X³—CF₂—* (1B)
wherein
R^{F1} represents —(Rf)ₚ—R^{F}—(O)_{q},
Rf each independently represents a C₁₋₁₆ alkylene group optionally substituted with one or more fluorine atoms,
R^{F} represents a divalent fluoro(poly)ether group,
R³¹ represents a C₁₋₁₆ alkyl group optionally substituted with one or more halogen atoms; a C₆₋₂₀ aromatic hydrocarbon group optionally having one or more substituents; a silsesquioxane residue optionally having one or more substituents; —COOR^{f2}; —OR^{f2}; —SO₂R^{f3}; —CR^{f4}═CR^{f4}₂; fluorine atom; bromine atom; or iodine atom,
X¹ represents a C₁₋₁₆ alkylene group optionally substituted with one or more halogen atoms; or single bond,
X³ represents a C₁₋₁₆ alkylene group optionally substituted with one or more halogen atoms,
R² each independently represents a C₁₋₁₆ alkyl group optionally substituted with one or more fluorine atoms; or a hydrogen atom,
R³ represents a C₁₋₁₆ alkyl group optionally substituted with one or more halogen atoms; fluorine atom; or hydrogen atom,
R^{f4} each independently represents hydrogen atom or fluorine atom,
p is 0 or T, q is 0 or 1, r is 0 or T,
* represents a bond, and
Formula (1A) and Formula (1B) each comprise 2 to 20 20 carbon atoms, and
the C₁₋₂₀ fluorine-containing organic groups are represented by Formula (2A) and Formula (2B):

R³²—X¹—(R^{F1})ᵣ—CF₂—* (2A)

*—X¹—CF₂—* (2B)
wherein
R^{F1} represents —(Rf)ₚ—R^{F}—(O)_{q},
Rf each independently represents a C₁₋₁₆ alkylene group optionally substituted with one or more fluorine atoms,
R^{F} represents a divalent fluoro(poly)ether group,
R³² represents a C₁₋₁₆ alkyl group optionally substituted with one or more halogen atoms; a C₆₋₂₀ aromatic hydrocarbon group optionally having one or more substituents; a silsesquioxane residue optionally having one or more substituents; —COOR^{f2}; —OR^{f2}; —SO₂R^{f3}; —CR^{f4}═CR^{f4}₂; fluorine atom; bromine atom; or iodine atom,
X¹ represents a C₁₋₁₆ alkylene group optionally substituted with one or more halogen atoms; or single bond,
R^{f2} each independently represents a C₁₋₁₆ alkyl group optionally substituted with one or more fluorine atoms or a hydrogen atom,
R^{f3} represents a C₁₋₁₆ alkyl group optionally substituted with one or more halogen atoms; fluorine atom; or hydrogen atom,
R^{f4} each independently represents a hydrogen atom or fluorine atom,
p is 0 or T, q is 0 or 1, r is 0 or T,
* represents a bond, and
Formula (2A) and Formula (2B) each comprise 1 to 20 carbon atoms.

When the C₂₋₂₀ fluorine-containing organic group or the C₁₋₂₀ fluorine-containing organic group is a divalent group, that is, a group represented by Formula (1B) or Formula (2B), two of the bonding hands may typically be bonded to different carbon atoms. When the C₂₋₂₀ fluorine-containing organic group or the C₁₋₂₀ fluorine-containing organic group is bonded to an aromatic hydrocarbon group represented by Ar, A¹⁰, Ar¹¹, or Ar¹², the group represented by Formula (1B) or Formula (2B) may form a ring together with the aromatic hydrocarbon group.

When the fluorine-containing organic group has the above structure, a fluorine-containing aromatic polymer may be provided that is excellent in various properties such as flexibility, adhesion (reactivity) and affinity with another material, a low dielectric property, transparency, water/oil repellency, low tackiness, an antifouling property, solvent solubility, and high surface hardness. When the fluorine-containing organic group particularly has the structure represented by Formula (2B), a fluorine-containing aromatic polymer may be provided that is excellent in various properties such as rigidity, low thermal expansion, a low dielectric property, transparency, water/oil repellency, low tackiness, an antifouling property, solvent solubility, and high surface hardness.

R^{F1} represents —(Rf)ₚ—R^{F}—(O)_{q}—.

Rf each independently represents a C₁₋₁₆ alkylene group optionally substituted with one or more fluorine atoms.

The “C₁₋₁₆ alkylene moiety” in the C₁₋₁₆ alkylene group optionally substituted with one or more fluorine atoms may be linear or branched, and is preferably a linear or branched C₁₋₆ alkylene moiety, and more preferably a linear C₁₋₃ alkylene moiety.

Rf is preferably a C₁₋₁₆ fluoroalkylene group substituted with one or more fluorine atoms, more preferably a C₁₋₁₆ perfluoroalkylene group, still more preferably a C₁₋₆ perfluoroalkylene group, and still even more preferably a C₁₋₃ perfluoroalkylene group.

The C₁₋₁₆ perfluoroalkylene group may be linear or branched, and is preferably a linear or branched C₁₋₆ perfluoroalkylene group, more preferably a linear or branched C₁₋₃ perfluoroalkylene group, and specifically —CF₂—, —CF₂CF₂—, CF₂CF₂CF₂—, or CF₂CF(CF₃)—.

R^{F} represents a divalent fluoro(poly)ether group. In the present disclosure, the term “fluoro(poly)ether group” means a fluoroether group and/or a fluoropolyether group. The fluorine-containing polymer of the present disclosure include comprising R^{F} may be given a property of a fluoro(poly)ether group and thus may be good in flexibility, heat resistance, a friction property, an antifouling property, and water/oil repellency.

R^{F} is preferably a group represented by the formula:

—(OC₄F₈)_{c}—(OC₃R^{Fa}₆)_{d}—(OC₂F₄)ₑ—(OCF₂)_{f}—
wherein
R^{Fa} each independently represents a hydrogen atom, fluorine atom, or chlorine atom,
c, d, e, and f each independently represent an integer of 0 to 200, the sum of c, d, e, and f is 1 or more, repeating units enclosed in parentheses with c, d, e, and f appear in any order in the formula, however, when R^{Fa} is a hydrogen atom or a chlorine atom at every occurrence, at least one of c, e, or f is one or more
(hereinafter, such a group is also referred to as a group represented by “PFPE”).

R^{Fa} is preferably hydrogen atom or fluorine atom, and more preferably fluorine atom. However, when R^{Fa} is hydrogen atom or chlorine atom at every occurrence, at least one of c, e, or f is one or more.

c, d, e, and f may be preferably each independently an integer of 0 to 100 or an integer of 0 to 20.

The sum of c, d, e, and f is preferably 5 or more, and more preferably 10 or more, and may be, for example, 15 or more, or 20 or more. The sum of c, d, e, and f is preferably 200 or less, more preferably 100 or less, and still more preferably 60 or less, and may be, for example, 50 or less, 30 or less, or 20 or less.

These repeating units may be linear or branched. For example, —(OC₄F₈)— may be any of —(OCF₂CF₂CF₂CF₂)—, —(OCF(CF₃)CF₂CF₂)—, —(OCF₂CF(CF₃)CF₂)—, —(OCF₂CF₂CF(CF₃))—, —(OC(CF₃)₂CF₂)—, —(OCF₂C(CF₃)₂)—, —(OCF(CF₃)CF(CF₃))—, —(OCF(C₂F₅)CF₂)—, and —(OCF₂CF(C₂F₅)). —(OC₃F₆)— (that is, R^{Fa} is fluorine atom in the above formula) may be any of —(OCF₂CF₂CF₂)—, —(OCF(CF₃)CF₂)—, and —(OCF₂CF(CF₃))—, and is preferably —(OCF(CF₃)CF₂)— or —(OCF₂CF(CF₃))—. —(OC₂F₄)— may be —(OCF₂CF₂)— or —(OCF(CF₃))—.

In one aspect, R^{F} is each independently a group represented by Formula (f1):

—(OC₃F₆)_{d}—(OCF₂)_{f}— (f1)
wherein d is an integer of 0 to 200, and f is an integer of 1 to 200.

OC₃F₆ in Formula (f1) is preferably (OCF₂CF₂CF₂), (OCF(CF₃)CF₂), or (OCF₂CF(CF₃)), and more preferably (OCF₂CF(CF₃)).

In Formula (f1), d is preferably an integer of 0 to 100, more preferably 0 to 50, and still more preferably 0 to 10. In one aspect, d is 0. In another aspect, d is preferably 1 to 100, more preferably 2 to 50, and still more preferably 3 to 10.

In Formula (f1), f is preferably 1 to 100, more preferably 1 to 10, still more preferably 1 to 5, and still even more preferably 1 to 3. In one aspect, f is 1.

p is 0 or 1. In one aspect, p is 0. In another aspect, p is 1.

q is 0 or 1. In one aspect, q is 0. In another aspect, q is 1.

r is 0 or 1. In one aspect, r is 0. In another aspect, r is 1.

X¹ represents a C₁₋₁₆ alkylene group optionally substituted with one or more halogen atoms; or single bond. The “C₁₋₁₆ alkylene moiety” in the C₁₋₁₆ alkylene group optionally substituted with one or more halogen atoms may be linear or branched, and is preferably a linear or branched C₁₋₁₀ alkylene moiety, and more preferably a linear or branched C₁₋₅ alkylene moiety. In one aspect, the “C₁₋₁₆ alkylene moiety” is preferably a branched C₂₋₄ alkylene moiety, and in another aspect, preferably a linear C₂₋₅ alkylene moiety.

Examples of the halogen atom in the C₁₋₁₆ alkylene group optionally substituted with one or more halogen atoms include a fluorine atom, a chlorine atom, a bromine atom, and an iodine atom, and a fluorine atom and an iodine atom are preferable.

The C₁₋₁₆ alkylene group optionally substituted with one or more halogen atoms is preferably —CF₂—, —CF₂CF₂—, —CF(CF₃)—, —CF₂CF₂CF₂—, —CF₂CF(CF₃)—, —CF₂CF₂CF₂CF₂—, —CF₂CF₂CF₂CF₂CF₂—, or CHI—CH₂—CF₂CF₂CF₂—, and more preferably —CF₂CF₂—, —CF(CF₃)—, —CF₂CF(CF₃)—, —CF₂CF₂CF₂CF₂CF₂—, or CHI—CH₂—CF₂CF₂CF₂—.

X¹ preferably represents a linear or branched C₁₋₁₀ alkylene group optionally substituted with one or more halogen atoms; or single bond, and more preferably represents a linear or branched C₁₋₅ alkylene group optionally substituted with one or more of one kind of atom selected from a fluorine atom and an iodine atom; or single bond.

X³ represents a C₁₋₁₆ alkylene group optionally substituted with one or more halogen atoms; or single bond. The “C₁₋₁₆ alkylene moiety” in the C₁₋₁₆ alkylene group optionally substituted with one or more halogen atoms may be linear or branched, and is preferably a linear or branched C₁₋₁₀ alkylene moiety, and more preferably a linear or branched C₁₋₅ alkylene moiety. In one aspect, the “C₁₋₁₆ alkylene moiety” is preferably a branched C₂₋₄ alkylene moiety, and in another aspect, preferably a linear C₂₋₅ alkylene moiety.

Examples of the halogen atom in the C₁₋₁₆ alkylene group optionally substituted with one or more halogen atoms include a fluorine atom, a chlorine atom, a bromine atom, and an iodine atom, and a fluorine atom and an iodine atom are preferable.

The C₁₋₁₆ alkylene group optionally substituted with one or more halogen atoms is preferably —CF₂—, —CF₂CF₂—, —CF(CF₃)—, —CF₂CF₂CF₂—, —CF₂CF(CF₃)—, —CF₂CF₂CF₂CF₂—, —CF₂CF₂CF₂CF₂CF₂—, or CHI—CH₂—CF₂CF₂CF₂—, and more preferably —CF₂CF₂—, —CF(CF₃)—, —CF₂CF(CF₃)—, —CF₂CF₂CF₂CF₂CF₂—, or CHI—CH₂—CF₂CF₂CF₂—.

X³ preferably represents a linear or branched C₁₋₁₀ alkylene group optionally substituted with one or more halogen atoms, and more preferably represents a linear or branched C₁₋₅ alkylene group optionally substituted with one or more of one kind of atom selected from a fluorine atom and an iodine atom.

R³¹ represents a C₁₋₁₆ alkyl group optionally substituted with one or more halogen atoms; a C₆₋₂₀ aromatic hydrocarbon group optionally having one or more substituents; a silsesquioxane residue optionally having one or more substituents; —COOR^{f2}; —OR^{f2}; —SO₂R^{f3}; —CR^{f4}═CR^{f4}₂; fluorine atom; bromine atom; or iodine atom, and R³² represents a C₁₋₁₆ alkyl group optionally substituted with one or more halogen atoms; a C₆₋₂₀ aromatic hydrocarbon group optionally having one or more substituents; a silsesquioxane residue optionally having one or more substituents; —COOR^{f2}; —OR^{f2}; —SO₂R^{f3}; —CR^{f4}═CR^{f4}₂; fluorine atom; bromine atom; or iodine atom.

The “C₁₋₁₆ alkyl moiety” in the C₁₋₁₆ alkyl group represented by R³¹ or R³² and optionally substituted with one or more halogen atoms may be linear or branched, and is preferably a linear or branched C₁₋₁₀ alkyl moiety, and more preferably a linear or branched C₁₋₆ alkyl moiety. In one aspect, the “C₁₋₁₆ alkyl moiety” is a linear or branched C₁₋₄ alkyl moiety, and may be specifically —CH₃, —CH₂CH₃, —CH₂CH₂CH₃, —CH(CH₃)₂, —CH₂CH₂CH₂CH₃, —CH₂CH(CH₃)₂, or —CH(CH₃)₃.

Examples of the halogen atom in the C₁₋₁₆ alkyl group optionally substituted with one or more halogen atoms include a fluorine atom, a chlorine atom, a bromine atom, and an iodine atom, and a fluorine atom and an iodine atom are preferable.

In one aspect, the C₁₋₁₆ alkyl group optionally substituted with one or more halogen atoms is a C₁₋₁₆ alkyl group that is not substituted with a halogen atom. In another aspect, the C₁₋₁₆ alkyl group optionally substituted with one or more halogen atoms is preferably a C₁₋₁₆ fluoroalkyl group substituted with one or more fluorine atoms, more preferably a C₁₋₁₆ perfluoroalkyl group, and still more preferably a C₁₋₆ perfluoroalkyl group.

The C₁₋₁₆ perfluoroalkyl group may be linear or branched, and is preferably a linear or branched C₁₋₁₀ perfluoroalkyl group, and more preferably a linear or branched C₁₋₆ perfluoroalkyl group, and may be specifically —CF₃, —CF₂CF₃, —CF₂CF₂CF₃, —CF(CF₃)₂, —CF₂CF₂CF₂CF₃, —CF₂CF(CF₃)₂, or —CF(CF₃)₃.

The “C₆₋₂₀ aromatic hydrocarbon moiety” in the C₆₋₂₀ aromatic hydrocarbon group represented by R³¹ or R³² and optionally having one or more substituents may be monocyclic or polycyclimayd in the polycyclic ring, two or more rings may or may not form a fused ring. The “C₆₋₂₀ aromatic hydrocarbon moiety” in the C₆₋₂₀ aromatic hydrocarbon group optionally having one or more substituents is preferably a C₆₋₁₅ aromatic hydrocarbon moiety, more preferably a C₆₋₁₀ aromatic hydrocarbon moiety, and still more preferably a phenyl moiety.

Examples of the substituent in the C₆₋₂₀ aromatic hydrocarbon group optionally having one or more substituents include halogen atoms such as a fluorine atom, a chlorine atom, a bromine atom, and an iodine atom; a C₁₋₄ alkyl group; a C₁₋₄ alkoxy group; and R²⁰—O—CO— (wherein R²⁰ represents a C₁₋₄ alkyl group). Among them, a halogen atom is preferable, and a fluorine atom is particularly preferable. R²⁰ may be linear or branched, and is preferably a linear or branched C₁₋₃ alkyl group, and specifically, —CH₃ and —CH₂CH₃ are preferable.

The C₆₋₂₀ aromatic hydrocarbon group represented by R³¹ or R³² is preferably a C₆₋₁₀ aromatic hydrocarbon group optionally having one or more substituents, and more preferably a C₆₋₁₀ aromatic hydrocarbon group optionally having one or more substituents. In one aspect, the C₆₋₂₀ aromatic hydrocarbon group represented by R³¹ or R³² preferably comprises a substituent, and in another aspect, the C₆₋₂₀ aromatic hydrocarbon group represented by R³¹ or R³² preferably comprises no substituent.

The “silsesquioxane residue” in the silsesquioxane residue represented by R³¹ or R³² and optionally having one or more substituents is a monovalent moiety obtained by eliminating one substituent on Si in silsesquioxane, and may have any of a cage structure, a ladder structure, and a random structure.

The substituent in the silsesquioxane residue optionally having one or more substituents is preferably a C₁₋₁₀ alkyl group optionally substituted with one or more halogen atoms, or phenyl group, and more preferably a C₁₋₆ alkyl group optionally substituted with one or more halogen atoms, or phenyl group.

The “C₁₋₁₀ alkyl moiety” in the C₁₋₁₀ alkyl group that is a substituent of the silsesquioxane residue and is optionally substituted with one or more halogen atoms may be linear or branched, and is preferably a linear or branched C₁₋₈ alkyl moiety, and more preferably a linear C₁₋₆ alkyl moiety.

Examples of the halogen atom in the C₁₋₁₀ alkyl group that is a substituent of the silsesquioxane residue and is optionally substituted with one or more halogen atoms include a fluorine atom, a chlorine atom, a bromine atom, and an iodine atom, and a fluorine atom and an iodine atom are preferable.

The C₁₋₁₀ alkyl group that is a substituent of the silsesquioxane residue and is optionally substituted with one or more halogen atoms is preferably —CHI—CH₂—CF₂CF₂CF₂—I.

The substituent in the silsesquioxane residue optionally having one or more substituents is preferably phenyl group or isobutyl group.

R^{f2} each independently represents a C₁₋₁₆ alkyl group optionally substituted with one or more fluorine atoms; or a hydrogen atom, and preferably represents a C₁₋₁₆ alkyl group optionally substituted with one or more fluorine atoms.

The “C₁₋₁₆ alkyl moiety” in the C₁₋₁₆ alkyl group optionally substituted with one or more fluorine atoms may be linear or branched, and is preferably a linear or branched C₁₋₁₀ alkyl moiety, more preferably a linear or branched C₁₋₅ alkyl moiety, and particularly preferably a C₁₋₂ alkyl moiety.

The C₁₋₁₆ alkyl group optionally substituted with one or more fluorine atoms is preferably methyl group, ethyl group, trifluoromethyl group, or pentafluoroethyl group.

R^{f3} represents a C₁₋₁₆ alkyl group optionally substituted with one or more halogen atoms; or fluorine atom or hydrogen atom. The “C₁₋₁₆ alkyl moiety” in the C₁₋₁₆ alkyl group optionally substituted with one or more halogen atoms may be linear or branched, and is preferably a linear or branched C₁₋₁₀ alkyl moiety, more preferably a linear or branched C₁₋₅ alkyl moiety, and particularly preferably a C₁₋₂ alkyl moiety.

Examples of the halogen atom in the C₁₋₁₆ alkyl group optionally substituted with one or more halogen atoms include a fluorine atom, a chlorine atom, a bromine atom, and an iodine atom, and a fluorine atom is preferable.

The C₁₋₁₆ alkyl group optionally substituted with one or more fluorine atoms is preferably methyl group, ethyl group, trifluoromethyl group, or pentafluoroethyl group.

RP is preferably a C₁₋₅ alkyl group optionally substituted with one or more halogen atoms, phenyl group, an alkoxy group, a hydroxy group, ONa, OK, chlorine atom, or fluorine atom, and more preferably fluorine atom.

R^{f4} each independently represents hydrogen atom or fluorine atom. In one aspect, R^{f4} is hydrogen atom, and in another aspect, R^{f4} is fluorine atom.

When R³¹ and R³² are each an iodine atom, in a unit represented by Formula (I), R³¹ and R³² may be each replaced with a bond, and X¹ bonded to R³¹ or R³² may be bonded to another aromatic ring (an aromatic ring other than the group to which R³¹ or R³² is bonded via —X¹—(R^{F1})ᵣ—CF₂—, for example, another aromatic ring comprised in a unit represented by Formula (I)). Although the present disclosure should not be construed as limited to a specific theory, the above structure is considered as follows. That is, in the method for producing a fluorine-containing polymer of the present disclosure, an iodine atom of a compound represented by Formula (II) is considered to be abstracted to form a reaction point, which the reaction point is bonded to an aromatic ring of a unit represented by Formula (I-1), and thus a structure represented by Formula (I) is obtained. When R³¹ and R³² are each an iodine atom, the iodine atom corresponding to R³¹ or R³² is considered to be similarly abstracted and the resulting reaction point may be bonded to another aromatic ring. Similarly, when a substituent of the group represented by R³¹ or R³² comprises an I atom, the group bonded to the I atom may be bonded to another aromatic ring.

R³¹ is preferably a C₁₋₁₆ alkyl group optionally substituted with one or more halogen atoms, a C₆₋₂₀ aromatic hydrocarbon group optionally having one or more substituents, —COOR^{f2}, —OR^{f2}, —SO₂R^{f3}, —CR^{f4}═CR^{f4}₂, fluorine atom, bromine atom, or iodine atom.

R³² is preferably a C₁₋₁₆ alkyl group optionally substituted with one or more halogen atoms, a C₆₋₂₀ aromatic hydrocarbon group optionally having one or more substituents, —COOR^{f2}, —OR^{f2}, —SO₂R^{f3}, —CR^{f4}=CR^{f4}^{²}, fluorine atom, bromine atom, or iodine atom.

* represents a bond.

Formula (1A) comprises 2 to 20 carbon atoms in total, and may preferably comprise 3 to 15, and more preferably 4 to 15 carbon atoms in total. The smaller the number of carbon atoms is, the more easily the properties of the aromatic polymer will be maintained, and the larger the number of carbon atoms is, the more easily the properties of the fluorine-containing organic group will be exhibited.

Formula (1B) comprises 2 to 20 carbon atoms in total, and may preferably comprise 3 to 10, and more preferably 3 to 5 carbon atoms in total. The smaller the number of carbon atoms is, the more easily the properties of the aromatic polymer will be maintained, and the larger the number of carbon atoms is, the more easily the properties of the fluorine-containing organic group will be exhibited.

Formula (2A) comprises 1 to 20 carbon atoms in total, and may preferably comprise 1 to 15 carbon atoms in total. The smaller the number of carbon atoms is, the more easily the properties of the aromatic polymer will be maintained, and the larger the number of carbon atoms is, the more easily the properties of the fluorine-containing organic group will be exhibited.

Formula (2B) comprises 1 to 20 carbon atoms in total, and may preferably comprise 3 to 10, and more preferably 3 to 5 carbon atoms in total. The smaller the number of carbon atoms is, the more easily the properties of the aromatic polymer will be maintained, and the larger the number of carbon atoms is, the more easily the properties of the fluorine-containing organic group will be exhibited.

The C₂₋₂₀ fluorine-containing organic group represented by Formula (1A) is preferably a C₄₋₂₀ fluoroalkyl group, a C₄₋₂₀ fluorine-containing organic group having a functional moiety, or a C₄₋₂₀ fluoro(poly)ether group. Specifically, Formula (1A) and (1B) are preferably a group selected from Formula (1-a), Formula (1-b), Formula (1-c), and Formula (1B):

F—X³—CF₂—* (1-a)

R³¹—X¹—CF₂—* (1-b)

R³¹—X¹—R^{F1}—CF₂—* (1-c)

*—X³—CF₂—* (1B)
wherein
R^{F1} represents —(Rf)ₚ—R^{F}—(O)_{q},
Rf each independently represents a C₁₋₁₆ alkylene group optionally substituted with one or more fluorine atoms,
R^{F} represents a divalent fluoro(poly)ether group,
X¹ represents a C₁₋₁₆ alkylene group optionally substituted with one or more halogen atoms; or single bond,
X² represents a C₁₋₁₆ alkylene group optionally substituted with one or more halogen atoms,
X³ represents a C₃₋₁₆ alkylene group optionally substituted with one or more halogen atoms,
R³¹ represents a C₁₋₁₆ alkyl group optionally substituted with one or more halogen atoms; a C₆₋₂₀ aromatic hydrocarbon group optionally having one or more substituents; a silsesquioxane residue optionally having one or more substituents; —COOR^{f2}; —OR^{f2}; —SO₂R^{f3}; —CR^{f4}═CR^{f4}₂; fluorine atom; or bromine atom,
R^{f2} each independently represents a C₁₋₁₆ alkyl group optionally substituted with one or more fluorine atoms; or hydrogen atom,
R^{f3} represents a C₁₋₁₆ alkyl group optionally substituted with one or more halogen atoms; fluorine atom; or hydrogen atom,
R^{f4} each independently represents hydrogen atom or fluorine atom,
p is 0 or 1, q is 0 or 1, r is 0 or 1,
* represents a bond,
Formula (1-a) comprises 2 to 20 carbon atoms,
Formula (1-b) comprises 2 to 20 carbon atoms,
Formula (1-c) comprises 2 to 20 carbon atoms, and
Formula (1B) comprises 2 to 20 carbon atoms.

When the C₄₋₂₀ fluorine organic group represented by Formula (1A) is a group represented by Formula (1-a), the fluorine-containing aromatic polymer may be given a property derived from a fluoroalkyl group, when the C₄₋₂₀ fluorine organic group represented by Formula (1A) is a group represented by Formula (1-b), the fluorine-containing aromatic polymer may be given a property derived from a specific functional group, and when the C₄₋₂₀ fluorine organic group represented by Formula (1A) is a group represented by Formula (1-c), the fluorine-containing aromatic polymer may be given a property derived from a fluoro(poly)ether group.

The C₁₋₂₀ fluorine-containing organic group represented by Formula (2A) and (2B) is preferably a C₁₋₂₀ fluoroalkyl group, a C₁₋₂₀ fluorine-containing organic group having a functional moiety, or a C₁₋₂₀ fluoro(poly)ether group. Specifically, Formula (2A) and (2B) are preferably a group selected from the following Formula (2-a), Formula (2-b), Formula (2-c), and Formula (2B):

F—X¹—CF₂—* (2-a)

R³²—X¹—CF₂—* (2-b)

R³²—X¹—R^{F1}—CF₂—* (2-c)

*—X¹—CF₂—* (2B)
wherein
R^{F1} represents —(Rf)ₚ—R^{F}—(O)_{q},
Rf each independently represents a C₁₋₁₆ alkylene group optionally substituted with one or more fluorine atoms,
R^{F} represents a divalent fluoro(poly)ether group,
X¹ represents a C₁₋₁₆ alkylene group optionally substituted with one or more halogen atoms; or single bond,
R³² represents a C₁₋₁₆ alkyl group optionally substituted with one or more halogen atoms; a C₆₋₂₀ aromatic hydrocarbon group optionally having one or more substituents; a silsesquioxane residue optionally having one or more substituents; —COOR^{f2}; —OR²; —SO₂R^{f}; —CR^{f4}═CR^{f4}₂; fluorine atom; or bromine atom,
R^{f2} each independently represents a C₁₋₁₆ alkyl group optionally substituted with one or more fluorine atoms; or a hydrogen atom,
R^{f3} represents a C₁₋₁₆ alkyl group optionally substituted with one or more halogen atoms; fluorine atom; or hydrogen atom,
R^{f4} each independently represents hydrogen atom or fluorine atom,
p is 0 or 1, q is 0 or 1, r is 0 or 1,
* represents a bond,
Formula (2-a) comprises 1 to 20 carbon atoms,
Formula (2-b) comprises 1 to 20 carbon atoms,
Formula (2-c) comprises 1 to 20 carbon atoms, and
Formula (2B) comprises 1 to 20 carbon atoms.

When the C₄₋₂₀ fluorine organic group represented by Formula (2A) is a group represented by Formula (2-a), the fluorine-containing aromatic polymer may be given a property derived from a fluoroalkyl group, when the C₄₋₂₀ fluorine organic group represented by Formula (2A) is a group represented by Formula (2-b), the fluorine-containing aromatic polymer may be given a property derived from a specific functional group, and when the C₄₋₂₀ fluorine organic group represented by Formula (2A) is a group represented by Formula (2-c), the fluorine-containing aromatic polymer may be given a property derived from a fluoro(poly)ether group.

X³ has the same meaning as described above, and preferably represents a linear or branched C₃₋₁₀ alkylene group optionally substituted with one or more halogen atoms, and more preferably represents a linear or branched C₃₋₅ alkylene group optionally substituted with one or more of one kind of atom selected from a fluorine atom and an iodine atom.

The substituents that may be comprised in the aliphatic or aromatic imide-diyl group represented by A; the divalent group represented by Ar that comprises a C₆₋₂₀ aromatic hydrocarbon moiety; the divalent group represented by A¹⁰ that comprises a C₆₋₂₀ aromatic hydrocarbon moiety; the C₆₋₁₀ aromatic hydrocarbon group represented by Ar¹¹; and the C₆₋₁₀ aromatic hydrocarbon group represented by Ar¹²; and the C₁₋₁₆ alkyl moiety in the C₁₋₁₆ alkyl group that is a substituent represented by R¹⁰ that is optionally substituted with one or more fluorine atoms may be linear or branched, and is preferably a linear or branched C₁₋₁₀ alkyl moiety, more preferably a linear or branched C₁₋₅ alkyl moiety, and in one aspect, a linear or branched C₁₋₄ alkyl moiety, and may be specifically —CH₃, —CH₂CH₃, —CH₂CH₂CH₃, —CH(CH₃)₂, —CH₂CH₂CH₂CH₃, —CH₂CH(CH₃)₂, or —CH(CH₃)₃.

The C₁₋₁₆ alkyl group substituted with one or more fluorine atoms is preferably a C₁₋₁₆ fluoroalkyl group, more preferably a C₁₋₁₆ perfluoroalkyl group, still more preferably a linear or branched C₁₋₁₉ perfluoroalkyl group, and still even more preferably a linear or branched C₁₋₅ perfluoroalkyl group, and may be specifically —CF₃, —CF₂CF₃, —CF₂CF₂CF₃, —CF(CF₃)₂, —CF₂CF₂CF₂CF₃, —CF₂CF(CF₃)₂, or —C(CF₃)₃.

In one aspect, the C₁₋₁₆ alkyl group optionally substituted with one or more fluorine atoms is a C₁₋₁₆ alkyl group that is not substituted with a fluorine atom, and in another aspect, the C₁₋₁₆ alkyl group may be a C₁₋₁₆ fluoroalkyl group.

The substituents that may be comprised in the aliphatic or aromatic imide-diyl group represented by A; the divalent group represented by Ar that comprises a C₆₋₂₀ aromatic hydrocarbon moiety; the divalent group represented by A¹⁰ that comprises a C₆₋₂₀ aromatic hydrocarbon moiety; the C₆₋₁₀ aromatic hydrocarbon group represented by Ar¹¹; and the C₆₋₁₀ aromatic hydrocarbon group represented by Ar¹²; and the “C₆₋₂₀ aromatic hydrocarbon moiety” in the C₆₋₂₀ aromatic hydrocarbon group that is a substituent represented by R¹⁰ that optionally has one or more substituents may be monocyclic or polycyclimayd in the a polycyclic ring, two or more rings may or may not form a fused ring The C₆₋₂₀ aromatic hydrocarbon group optionally having one or more substituents is preferably a C₆₋₁₀ aromatic hydrocarbon group, and more preferably phenylene group, tolylene group, xylylene group, or naphthylene group. In one aspect, the C₆₋₂₀ aromatic hydrocarbon group is more preferably phenylene group, tolylene group, or xylylene group, and in another aspect, may be still more preferably naphthylene group.

Examples of the substituent that may be comprised in the C₆₋₂₀ aromatic hydrocarbon group comprise a hydroxyl group and a fluorine-containing organic group. The fluorine-containing organic group is preferably a group represented by Formula (1A), Formula (1B), Formula (2A), or Formula (2B), and more preferably a group represented by Formula (1-a), Formula (1-b), Formula (1-c), Formula (1B), Formula (2-a), Formula (2-b), Formula (2-c), or Formula (2B). In one aspect, the fluorine-containing organic group is preferably a group represented by Formula (1A) or Formula (2A), and more preferably a group represented by Formula (1-a), Formula (1-b), Formula (1-c), Formula (2-a), Formula (2-b), or Formula (2-c).

The substituents that may be comprised in the aliphatic or aromatic imide-diyl group represented by A; the divalent group represented by Ar that comprises a C₆₋₂₀ aromatic hydrocarbon moiety; the divalent group represented by A¹⁰ that comprises a C₆₋₂₀ aromatic hydrocarbon moiety; the C₆₋₁₀ aromatic hydrocarbon group represented by Ar¹¹; and the C₆₋₁₀ aromatic hydrocarbon group represented by Ar¹²; and the C₁₋₁₆ alkoxy group as a substituent represented by R¹⁰ may be linear or branched, and is preferably a linear or branched C₁₋₁₀ alkoxy group, more preferably a linear or branched C₁₋₅ alkoxy group, and in one aspect, a linear or branched C₁₋₄ alkoxy group, and may be specifically —O—CH₃, —O—CH₂CH₃, —O—CH₂CH₂CH₃, —O—CH(CH₃)₂, —O—CH₂CH₂CH₂CH₃, —O—CH₂CH(CH₃)₂, or —O—CH(CH₃)₃.

The substituents that may be comprised in the aliphatic or aromatic imide-diyl group represented by A; the divalent group represented by Ar that comprises a C₆₋₂₀ aromatic hydrocarbon moiety; the divalent group represented by A¹⁰ that comprises a C₆₋₂₀ aromatic hydrocarbon moiety; the C₆₋₁₀ aromatic hydrocarbon group represented by Ar¹¹; and the C₆₋₁₀ aromatic hydrocarbon group represented by Ar¹²; and the C₁₋₁₆ hydroxyalkyl group as a substituent represented by R¹⁰ may be linear or branched, and is preferably a linear or branched C₁₋₁₀ hydroxyalkyl group, more preferably a linear or branched C₁₋₅ hydroxyalkyl group, and in one aspect, a linear or branched C₁₋₄ hydroxyalkyl group, and may be specifically —CH₂—OH, —CH₂CH₂—OH, —CH₂CH₂CH₂—OH, —CH₂CH(OH)CH₂CH₃, or —CH₂CH₂CH₂CH₂—OH.

The C₆₋₂₀ aromatic hydrocarbon group as a substituent may be monocyclic or polycyclic. When the C₆₋₂₀ aromatic hydrocarbon group is polycyclic, two or more rings may or may not form a fused ring. The C₆₋₂₀ aromatic hydrocarbon group is preferably a C₆₋₁₀ aromatic hydrocarbon group, and more preferably may be phenyl group, tolyl group, xylyl group, or naphthyl group.

The substituents that may be comprised in the aliphatic or aromatic imide-diyl group represented by A and the divalent group represented by A¹⁰ that comprises a C₆₋₂₀ aromatic hydrocarbon moiety; and the substituent represented by R¹⁰ are preferably one or more selected from C₁₋₁₆ alkyl groups, C₁₋₁₆ fluoroalkyl groups, C₁₋₁₆ alkoxy groups, and a fluorine atom, and more preferably one or more selected from C₁₋₅ alkyl groups, C₁₋₅ fluoroalkyl groups, and a fluorine atom.

The substituents that may be comprised in the divalent group represented by Ar that comprises a C₆₋₂₀ aromatic hydrocarbon moiety, the C₆₋₁₀ aromatic hydrocarbon group represented by Ar¹¹, and the C₆₋₁₀ aromatic hydrocarbon group represented by Ar¹² are preferably one or more selected from C₁₋₂₀ fluorine-containing organic groups or C₂₋₂₀ fluorine-containing organic groups, C₁₋₁₆ alkoxy groups, C₁₋₁₆ hydroxyalkyl groups, a hydroxyl group, a carboxyl group, a glycidyl group, and a fluorine atom.

The substituent that may be comprised in the C₁₋₁₆ alkylene group represented by R¹ and the divalent group represented by R¹ and include comprising a C₃₋₁₆ alicyclic hydrocarbon moiety are preferably one or more selected from C₆₋₂₀ aromatic hydrocarbon groups optionally having one or more substituents, a hydroxyl group, and a fluorine atom.

The substituent that may be comprised in the C₁₋₁₆ alkyl group represented by R² is preferably a fluorine atom.

k each independently represents an integer of 0 to 4, and preferably an integer of 0 to 1.

l each independently represents an integer of 1 to 4, and preferably an integer of 1 to 3.

m each independently represents an integer of 0 to 4, and preferably an integer of 0 to 3.

The fluorine-containing aromatic polymer represented by Formula (I) satisfies the following (i) or (ii):
(i) k is 0, and Formula (I) comprises one or more C₂₋₂₀ fluorine-containing organic groups, or
(ii) k is 1 to 4, and Formula (I) comprises one or more C₁₋₂₀ fluorine-containing organic groups.

It should be noted that, in the case of (i), the fluorine-containing aromatic polymer may comprise a C₁ fluorine-containing organic group, particularly —CF₃.

The fluorine-containing aromatic polymer of the present disclosure has the C₂₋₂₀ fluorine-containing organic group or the C₁₋₂₀ fluorine-containing organic group, and the fluorine-containing organic group is directly bonded to an aromatic ring. Thus, the fluorine-containing aromatic polymer may be given a property of the fluorine-containing organic group, and is expected to be excellent in various properties such as flexibility, an antifouling property, a friction property, an antifouling property, water/oil repellency, low tackiness, an antifouling property, solvent solubility, and high surface hardness while further improving or maintaining the heat resistance of the aromatic polymer at a high level.

In the fluorine-containing aromatic polymer of the present disclosure, the number of fluorine-containing organic groups comprised in the unit enclosed in parentheses with n may be preferably 1 or more, more preferably 1 to 6, and still more preferably 1 to 4 per unit. The number of C₂₋₂₀ fluorine-containing organic groups comprised in the unit enclosed in parentheses with n may be preferably 1 or more, and more preferably 1 to 2 per unit. The number of C₁ fluorine-containing organic groups (particularly —CF₃) comprised in the unit enclosed in parentheses with n may be preferably 2 to 6, more preferably 2 to 4, and still more preferably 3 to 4 per unit.

That is, the fluorine-containing organic group may be introduced into an aromatic polymer via a hydrocarbon group, an oxygen atom, or the like, but a bond via a hydrocarbon group, an oxygen atom, or the like is weak against heat, light, an acid, a base, or the like, and the introduced fluorine-containing organic group may be easily eliminated. In the fluorine-containing aromatic polymer of the present disclosure, it is considered that the fluorine-containing organic group directly bonded to an aromatic ring is less likely to be eliminated to achieve heat resistance, and in addition, flexibility, an antifouling property, a friction property, and water/oil repellency at a high level.

n represents an integer of 1 or more, and may be preferably 3 to 2,000, more preferably 5 to 1,000, and still more preferably 10 to 1,000.

A number average molecule weight of the fluorine-containing aromatic polymer represented by Formula (I) may be preferably 1,000 to 1,000,000, more preferably 2,000 to 500,000, and still more preferably 2,000 to 200,000.

In the present disclosure, the number average molecular weight may be measured by gel permeation chromatography, and a converted value obtained by using polystyrene as a standard sample may be taken as the number average molecular weight.

The Formula (I) is preferably represented by the following Formula (I-a):

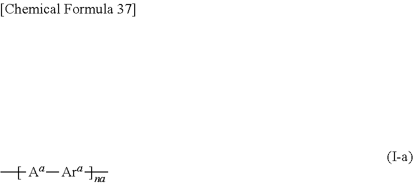

wherein
A^{a} each independently represents an aliphatic or aromatic imide-diyl group,
Ar^{a} each independently represents a divalent group comprising a C₆₋₂₀ aromatic hydrocarbon moiety optionally having one or more substituents,
na represents an integer of 1 or more, and
Formula (I-a) comprises one or more C₁₋₂₀ fluorine-containing organic groups.

The fluorine-containing aromatic polymer represented by Formula (I-a) comprises an imide-N-yl group in a repeating unit, and may be a polyimide, a polyetherimide, or a polyamideimide. The fluorine-containing aromatic polymer is expected to be excellent in various properties such as flexibility, adhesion (reactivity) and affinity with another material, a low dielectric property, transparency, water/oil repellency, low tackiness, an antifouling property, solvent solubility, and high surface hardness while maintaining the properties of these resins.

A^{a} each independently represents an aliphatic or aromatic imide-diyl group, and examples of the aliphatic or aromatic imide-diyl group include groups explained as the aliphatic or aromatic imide-diyl group represented by A.

A^{a} is preferably an aliphatic or aromatic imide-diyl group comprising one or more imide rings and optionally having one or more substituents, more preferably a group represented by Formula (A1), still more preferably a group represented by Formula (A2), and still even more preferably a group represented by one of Formulas (A1-1) to (A1-19).

Ar^{a} each independently represents a divalent group comprising a C₆₋₂₀ aromatic hydrocarbon moiety optionally having one or more substituents, and examples of such a group include groups explained as the divalent group represented by Ar that comprises a C₆₋₂₀ aromatic hydrocarbon moiety optionally having one or more substituents.

Ar^{a} is preferably a group represented by Formula (Ar1), more preferably one selected from phenylene group, xylylene group, hydroxyphenylene group, hydroxyxylylene group, naphthylene group, 2,2-diphenylpropane-4,4′-diyl group, 1,1-diphenylmethane-4,4′-diyl group, benzophenone-4,4′-diyl group, diphenylsulfone-4,4′-diyl group, and oxybisphenyl-4,4′-diyl group, and still more preferably phenylene group.

The C₁₋₂₀ fluorine-containing organic group is an organic group containing a fluorine atom. The C₁₋₂₀ fluorine-containing organic group is preferably a group represented by one or more selected from Formula (2A) and Formula (2B), and is preferably a group represented by Formula (2A).

na represents an integer of 1 or more, and may be preferably 3 to 2,000, more preferably 5 to 1,000, and still more preferably 10 to 1,000.

A number average molecule weight of the fluorine-containing aromatic polymer represented by Formula (I-a) may be preferably 1,000 to 1,000,000, more preferably 2,000 to 500,000, and still more preferably 2,000 to 200,000.

The Formula (I) is preferably represented by the following Formula (I-b):

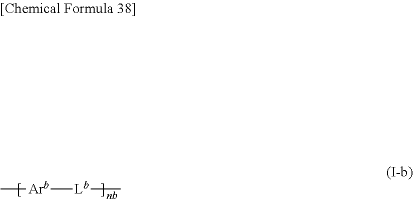

wherein
Ar^{b} each independently represents a divalent group comprising a C₆₋₂₀ aromatic hydrocarbon moiety optionally having one or more substituents,
L^{b} each independently represents one selected from the group consisting of —R¹—, —O—, —S—, —NR²—, —CO—, —CO—O—, —O—CO—, —O—CO—O—, —SO₂—, —NR²—CO—, and CO—NR²—,
R¹ each independently represents one selected from a C₁₋₁₆ alkylene group optionally having a substituent; and a divalent group comprising a C₃₋₁₆ alicyclic hydrocarbon moiety optionally having one or more substituents,
R² each independently represents a C₁₋₁₆ alkyl group optionally having one or more substituents; a C₆₋₂₀ aromatic hydrocarbon group optionally having one or more substituents; or a hydrogen atom,
nb represents an integer of 1 or more, and
Formula (I-b) comprises one or more C₂₋₂₀ fluorine-containing organic groups.

The fluorine-containing aromatic polymer represented by Formula (I-b) may be, for example, polycarbonate, polyphenylene sulfide, polyphenylene ether, or the like, and is expected to be excellent in various properties such as flexibility, adhesion (reactivity) and affinity with another material, a low dielectric property, transparency, water/oil repellency, low tackiness, an antifouling property, solvent solubility, and high surface hardness while maintaining the properties of these resins.

Ar^{b} each independently represents a divalent group comprising a C₆₋₂₀ aromatic hydrocarbon moiety optionally having one or more substituents, and examples of such a group include groups explained as the divalent group represented by Ar that comprises a C₆₋₂₀ aromatic hydrocarbon moiety optionally having one or more substituents.

Ar^{b} is preferably a group represented by Formula (Ar1), more preferably one selected from phenylene group, xylylene group, hydroxyphenylene group, hydroxyxylylene group, naphthylene group, 2,2-diphenylpropane-4,4′-diyl group, 1,1-diphenylmethane-4,4′-diyl group, benzophenone-4,4′-diyl group, diphenylsulfone-4,4′-diyl group, and oxybisphenyl-4,4′-diyl group, and still more preferably phenylene group.

L^{b} each independently represents one selected from the group consisting of —R¹—, —O—, —S—, —NR²—, —CO—, —CO—O—, —O—CO—, —O—CO—O—, —SO₂—, —NR²—CO—, and CO—NR²—. R¹ and R² have the same meaning as described above. L^{b} is preferably —O—CO—O—, —S—, or —O—.

The C₂₋₂₀ fluorine-containing organic group is an organic group containing a fluorine atom. The C₂₋₂₀ fluorine-containing organic group is preferably a group represented by one or more selected from Formula (1A) and Formula (1B), and more preferably a group represented by Formula (1A).

nb represents an integer of 1 or more, and may be preferably 3 to 2,000, more preferably 5 to 1,000, and still more preferably 10 to 1,000.

A number average molecule weight of the fluorine-containing aromatic polymer represented by Formula (I-b) may be preferably 1,000 to 1,000,000, more preferably 2,000 to 500,000, and still more preferably 2,000 to 200,000.

The Formula (I-b) is preferably represented by the following Formula (I-b1), (I-b2), (I-b3), (I-b4), (I-b5), (I-b6) or (I-b7):

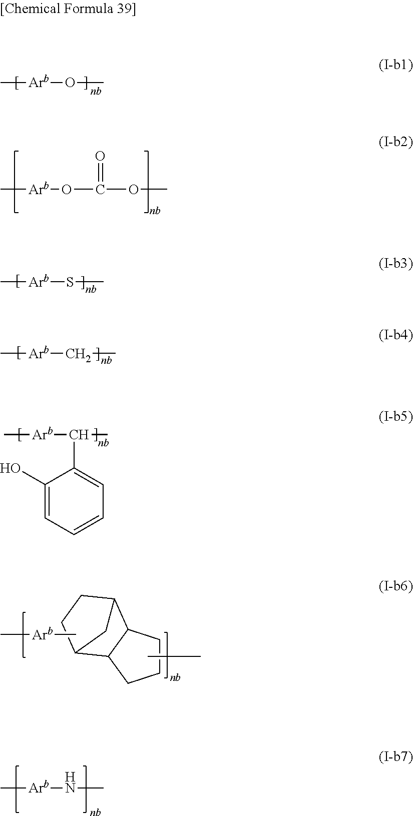

wherein
Ar^{b} each independently represents a divalent group comprising a C₆₋₂₀ aromatic hydrocarbon moiety optionally having one or more substituents,
nb represents an integer of 1 or more, and
Formulas (I-b1), (I-b2), (I-b3), (I-b4), (I-b5), (I-b6), and (I-b7) each comprise one or more C₂₋₂₀ fluorine-containing organic groups.

The C₂₋₂₀ fluorine-containing organic group is an organic group containing a fluorine atom. The C₂₋₂₀ fluorine-containing organic group is preferably a group represented by one or more selected from Formula (1A) and Formula (1B), and more preferably a formula represented by Formula (1A).

A number average molecule weight of the fluorine-containing aromatic polymer represented by Formula (I-b1) may be preferably 1,000 to 1,000,000, more preferably 2,000 to 500,000, and still more preferably 2,000 to 200,000.

A number average molecule weight of the fluorine-containing aromatic polymer represented by Formula (I-b2) may be preferably 1,000 to 1,000,000, more preferably 2,000 to 500,000, and still more preferably 2,000 to 200,000.

A number average molecule weight of the fluorine-containing aromatic polymer represented by Formula (I-b3) may be preferably 1,000 to 1,000,000, more preferably 2,000 to 500,000, and still more preferably 2,000 to 200,000.

A number average molecule weight of the fluorine-containing aromatic polymer represented by Formula (I-b4) may be preferably 1,000 to 1,000,000, more preferably 2,000 to 500,000, and still more preferably 2,000 to 200,000.

A number average molecule weight of the fluorine-containing aromatic polymer represented by Formula (I-b5) may be preferably 1,000 to 1,000,000, more preferably 2,000 to 500,000, and still more preferably 2,000 to 200,000.

A number average molecule weight of the fluorine-containing aromatic polymer represented by Formula (I-b6) may be preferably 1,000 to 1,000,000, more preferably 2,000 to 500,000, and still more preferably 2,000 to 200,000.

A number average molecule weight of the fluorine-containing aromatic polymer represented by Formula (I-b7) may be preferably 1,000 to 1,000,000, more preferably 2,000 to 500,000, and still more preferably 2,000 to 200,000.

The Formula (I) is preferably represented by the following Formula (I-c):

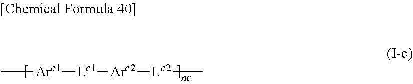

wherein
Ar^{c1} each independently represents a divalent group comprising a C₆₋₂₀ aromatic hydrocarbon moiety optionally having one or more substituents,
Ar^{c2} each independently represents a divalent group comprising a C₆₋₂₀ aromatic hydrocarbon moiety optionally having one or more substituents,
L^{c1} each independently represents one selected from the group consisting of —R¹—, —O—, —S—, —NR²—, —CO—, —CO—O—, —O—CO—, —O—CO—O—, —SO₂—, —NR²—CO—, and CO—NR²—,
L^{c2} each independently represents one selected from the group consisting of —R¹—, —O—, —S—, —NR²—, —CO—, —CO—O—, —O—CO—, —O—CO—O—, —SO₂—, —NR²—CO—, and CO—NR²—,
in at least one combination of Ar^{c1} and Ar^{c2}; or L^{c1} and L^{c2}, one group is different from the other,
R¹ each independently represents one selected from a C₁₋₁₆ alkylene group optionally having a substituent; and a divalent group comprising a C₃₋₁₆ alicyclic hydrocarbon moiety optionally having one or more substituents,
R² each independently represents a C₁₋₁₆ alkyl group optionally having one or more substituents; a C₆₋₂₀ aromatic hydrocarbon group optionally having one or more substituents; or a hydrogen atom,
nc represents an integer of 1 or more, and
Formula (I-c) comprises one or more C₂₋₂₀ fluorine-containing organic groups.

The fluorine-containing aromatic polymer represented by Formula (I-c) may be, for example, polysulfone, a polyamide, or the like, and is expected to be excellent in various properties such as flexibility, adhesion (reactivity) and affinity with another material, a low dielectric property, transparency, water/oil repellency, low tackiness, an antifouling property, solvent solubility, and high surface hardness while maintaining the properties of these resins.

Ar^{c1} each independently represents a divalent group comprising a C₆₋₂₀ aromatic hydrocarbon moiety optionally having one or more substituents, and examples of such a group include groups explained as the divalent group represented by Ar that comprises a C₆₋₂₀ aromatic hydrocarbon moiety optionally having one or more substituents.

Ar^{c1} is preferably a group represented by Formula (Ar1), more preferably one selected from phenylene group, xylylene group, hydroxyphenylene group, hydroxyxylylene group, naphthylene group, 2,2-diphenylpropane-4,4′-diyl group, 1,1-diphenylmethane-4,4′-diyl group, benzophenone-4,4′-diyl group, diphenylsulfone-4,4′-diyl group, and oxybisphenyl-4,4′-diyl group, and still more preferably phenylene group.

Ar^{c2} each independently represents a divalent group comprising a C₆₋₂₀ aromatic hydrocarbon moiety optionally having one or more substituents, and examples of such a group include groups explained as the divalent group represented by Ar that comprises a C₆₋₂₀ aromatic hydrocarbon moiety optionally having one or more substituents.

Ar^{c2} is preferably a group represented by Formula (Ar1), more preferably one selected from phenylene group, xylylene group, hydroxyphenylene group, hydroxyxylylene group, naphthylene group, 2,2-diphenylpropane-4,4′-diyl group, 1,1-diphenylmethane-4,4′-diyl group, benzophenone-4,4′-diyl group, diphenylsulfone-4,4′-diyl group, and oxybisphenyl-4,4′-diyl group, and still more preferably phenylene group.

L^{c1} each independently represents one selected from the group consisting of —R¹—, —O—, —S—, —NR²—, —CO—, —CO—O—, —O—CO—, —O—CO—O—, —SO₂—, —NR²—CO—, and CO—NR²—. R¹ and R² have the same meaning as described above. L^{c1} is preferably —SO₂— or —NR²—CO—.

L^{c2} each independently represents one selected from the group consisting of —R¹—, —O—, —S—, —NR²—, —CO—, —CO—O—, —O—CO—, —O—CO—O—, —SO₂—, —NR²—CO—, and CO—NR²—. R¹ and R² have the same meaning as described above. L^{c2} is preferably —O— or —CO—NR²—.

The C₂₋₂₀ fluorine-containing organic group is an organic group containing a fluorine atom. The C₂₋₂₀ fluorine-containing organic group is preferably a group represented by one or more selected from Formula (1A) and Formula (1B), and more preferably a group represented by Formula (1A).

In Formula (I-c), in at least one combination of Ar^{c1} and Ar^{c2} or L^{c1} and L^{c2}, one group is different from the other, and preferably in the combination of L^{c1} and L^{c2}, one group is different from the other.

nc represents an integer of 1 or more, and may be preferably 3 to 2,000, more preferably 5 to 1,000, and still more preferably 10 to 1,000.

A number average molecule weight of the fluorine-containing aromatic polymer represented by Formula (I-c) may be preferably 1,000 to 1,000,000, more preferably 2,000 to 500,000, and still more preferably 2,000 to 200,000.

The Formula (I-c) is preferably represented by the following Formula (I-c1), (I-c2) or (I-c3):

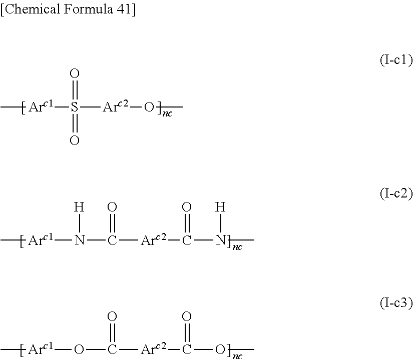

wherein
Ar^{c1} each independently represents a divalent group comprising a C₆₋₂₀ aromatic hydrocarbon moiety optionally having one or more substituents,
Ar^{c2} each independently represents a divalent group comprising a C₆₋₂₀ aromatic hydrocarbon moiety optionally having one or more substituents,
nc each independently represents an integer of 1 or more, and
Formulas (I-c1), (I-c2), and (I-c3) each comprise one or more C₂₋₂₀ fluorine-containing organic groups.

A number average molecule weight of the fluorine-containing aromatic polymer represented by Formula (I-c1) may be preferably 1,000 to 1,000,000, more preferably 2,000 to 500,000, and still more preferably 2,000 to 200,000.
A number average molecule weight of the fluorine-containing aromatic polymer represented by Formula (I-c2) may be preferably 1,000 to 1,000,000, more preferably 2,000 to 500,000, and still more preferably 2,000 to 200,000.

A number average molecule weight of the fluorine-containing aromatic polymer represented by Formula (I-c3) may be preferably 1,000 to 1,000,000, more preferably 2,000 to 500,000, and still more preferably 2,000 to 200,000.

The Formula (I) is preferably represented by the following Formula (I-d):

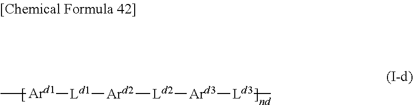

wherein
Ar^{d1} each independently represents a divalent group comprising a C₆₋₂₀ aromatic hydrocarbon moiety optionally having one or more substituents,
Ar^{d2} each independently represents a divalent group comprising a C₆₋₂₀ aromatic hydrocarbon moiety optionally having one or more substituents,
Ar^{d3} each independently represents a divalent group comprising a C₆₋₂₀ aromatic hydrocarbon moiety optionally having one or more substituents,
L^{d1} each independently represents one selected from the group consisting of —R¹—, —O—, —S—, —NR²—, —CO—, —CO—O—, —O—CO—, —O—CO—O—, —SO₂—, —NR²—CO—, and CO—NR²—,
L^{d2} each independently represents one selected from the group consisting of —R¹—, —O—, —S—, —NR²—, —CO—, —CO—O—, —O—CO—, —O—CO—O—, —SO₂—, —NR²—CO—, and CO—NR²—,
L^{d3} each independently represents one selected from the group consisting of —R¹—, —O—, —S—, —NR²—, —CO—, —CO—O—, —O—CO—, —O—CO—O—, —SO₂—, —NR²—CO—, and CO—NR²—,
in at least one combination of Ar^{d1} Ar^{d2}, and Ar^{d3}; or L^{d1}, L^{d2}, and L^{d3}; one group is different from at least one of the other two groups,
R¹ each independently represents one selected from a C₁₋₁₆ alkylene group optionally having one or more substituents; and a divalent group comprising a C₃₋₁₆ alicyclic hydrocarbon moiety optionally having one or more substituents,
R² each independently represents a C₁₋₁₆ alkyl group optionally having one or more substituents; a C₆₋₂₀ aromatic hydrocarbon group optionally having one or more substituents; or a hydrogen atom,
nd represents an integer of 1 or more, and
Formula (I-d) comprises one or more C₂₋₂₀ fluorine-containing organic groups.

The fluorine-containing aromatic polymer represented by Formula (I-d) may be, for example, polyether ether ketone, polyether sulfone, or the like, and is expected to be excellent in various properties such as flexibility, adhesion (reactivity) and affinity with another material, a low dielectric property, transparency, water/oil repellency, low tackiness, an antifouling property, solvent solubility, and high surface hardness while maintaining the properties of these resins.

Ar^{d1} each independently represents a divalent group comprising a C₆₋₂₀ aromatic hydrocarbon moiety optionally having one or more substituents, and examples of such a group comprise groups explained as the divalent group represented by Ar that comprises a C₆₋₂₀ aromatic hydrocarbon moiety optionally having one or more substituents.

Ar^{d1} is preferably a group represented by Formula (Ar1), more preferably one selected from phenylene group, xylylene group, hydroxyphenylene group, hydroxyxylylene group, naphthylene group, 2,2-diphenylpropane-4,4′-diyl group, 1,1-diphenylmethane-4,4′-diyl group, benzophenone-4,4′-diyl group, adiphenylsulfone-4,4′-diyl group, and oxybisphenyl-4,4′-diyl group, and still more preferably phenylene group.

Ar^{d2} each independently represents a divalent group comprising a C₆₋₂₀ aromatic hydrocarbon moiety optionally having one or more substituents, and examples of such a group comprise groups explained as the divalent group represented by Ar that comprises a C₆₋₂₀ aromatic hydrocarbon moiety optionally having one or more substituents.

Ar^{d2} is preferably a group represented by Formula (Ar1), more preferably one selected from phenylene group, xylylene group, hydroxyphenylene group, hydroxyxylylene group, naphthylene group, 2,2-diphenylpropane-4,4′-diyl group, 1,1-diphenylmethane-4,4′-diyl group, benzophenone-4,4′-diyl group, diphenylsulfone-4,4′-diyl group, and oxybisphenyl-4,4′-diyl group, and still more preferably phenylene group.

Ar^{d3} each independently represents a divalent group comprising a C₆₋₂₀ aromatic hydrocarbon moiety optionally having one or more substituents, and examples of such a group comprise groups explained as the divalent group represented by Ar that comprises a C₆₋₂₀ aromatic hydrocarbon moiety optionally having one or more substituents.

Ar^{d3} is preferably a group represented by Formula (Ar1), and more preferably one selected from phenylene group, xylylene group, hydroxyphenylene group, hydroxyxylylene group, naphthylene group, 2,2-diphenylpropane-4,4′-diyl group, 1,1-diphenylmethane-4,4′-diyl group, benzophenone-4,4′-diyl group, diphenylsulfone-4,4′-diyl group, and oxybisphenyl-4,4′-diyl group.

L^{d1} each independently represents one selected from the group consisting of —R¹—, —O—, —S—, —NR²—, —CO—, —CO—O—, —O—CO—, —O—CO—O—, —SO₂—, —NR²—CO—, and CO—NR²—. R¹ and R² have the same meaning as described above. L^{d1} is preferably one selected from the group consisting of —CO— and —SO₂—.

L^{d2} each independently represents one selected from the group consisting of —R¹—, —O—, —S—, —NR²—, —CO—, —CO—O—, —O—CO—, —O—CO—O—, —SO₂—, —NR²—CO—, and CO—NR²—. R¹ and R² have the same meaning as described above. L^{d2} is preferably —O—.

L^{d3} each independently represents one selected from the group consisting of —R¹—, —O—, —S—, —NR²—, —CO—, —CO—O—, —O—CO—, —O—CO—O—, —SO₂—, —NR²—CO—, and CO—NR²—. R¹ and R² have the same meaning as described above. L^{d3} is preferably —O—.

The C₂₋₂₀ fluorine-containing organic group is an organic group containing a fluorine atom. The C₂₋₂₀ fluorine-containing organic group is preferably a group represented by one or more selected from Formula (1A) and Formula (1B), and more preferably a group represented by Formula (1A).

In Formula (I-d), in at least one combination of Ar^{d1}, Ar^{d2}, and Ar^{d3}; or Lal, L^{d2}, and L^{d3}; one group is different from at least one of the other two groups, in at least one combination of Ar^{d1}, Ar^{d2}, and Ar^{d3}; or L^{d1}, L^{d2}, and L^{d3}; one group is different from at least one of the other two groups, and preferably in the combination of L^{d1}, L^{d2}, and L^{d3}; one group is different from at least one of the other two groups.

nd represents an integer of 1 or more, and may be preferably 3 to 2,000, more preferably 5 to 1,000, and still more preferably 10 to 1,000.

A number average molecule weight of the fluorine-containing aromatic polymer represented by Formula (I-d) may be preferably 1,000 to 1,000,000, more preferably 2,000 to 500,000, and still more preferably 2,000 to 200,000.

The Formula (I-d) is preferably represented by the following Formula (1-d1) or (I-d2):

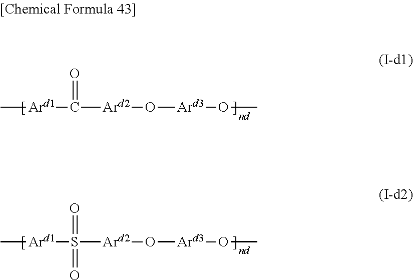

wherein
Ar^{d1} each independently represents a divalent group comprising a C₆₋₂₀ aromatic hydrocarbon moiety optionally having one or more substituents,
Ar^{d2} each independently represents a divalent group comprising a C₆₋₂₀ aromatic hydrocarbon moiety optionally having one or more substituents,
Ar^{d3} each independently represents a divalent group comprising a C₆₋₂₀ aromatic hydrocarbon moiety optionally having one or more substituents,
nd each independently represents an integer of 1 or more, and
Formulas (I-d1) and (I-d2) each comprise one or more C₂₋₂₀ fluorine-containing organic groups.

A number average molecule weight of the fluorine-containing aromatic polymer represented by Formula (I-d1) may be preferably 1,000 to 1,000,000, more preferably 2,000 to 500,000, and still more preferably 2,000 to 200,000.

A number average molecule weight of the fluorine-containing aromatic polymer represented by Formula (I-d2) may be preferably 1,000 to 1,000,000, more preferably 2,000 to 500,000, and still more preferably 2,000 to 200,000.

The Formula (I) is preferably represented by the following Formula (I-e):

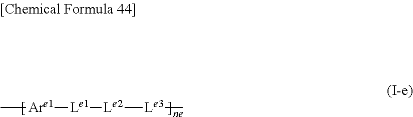

wherein
Ar^{e1} each independently represents a divalent group comprising a C₆₋₂₀ aromatic hydrocarbon moiety optionally having one or more substituents,
L^{e1} each independently represents one selected from the group consisting of —R¹—, —O—, —S—, —NR²—, —CO—, —CO—O—, —O—CO—, —O—CO—O—, —SO₂—, —NR²—CO—, and CO—NR²—,
L^{e2} each independently represents one selected from the group consisting of —R¹—, —O—, —S—, —NR²—, —CO—, —CO—O—, —O—CO—, —O—CO—O—, —SO₂—, —NR²—CO—, and CO—NR²—,
L^{e3} each independently represents one selected from the group consisting of —R¹—, —O—, —S—, —NR²—, —CO—, —CO—O—, —O—CO—, —O—CO—O—, —SO₂—, —NR²—CO—, and CO—NR²—,
R¹ each independently represents one selected from a C₁₋₁₆ alkylene group optionally having one or more substituents; and a divalent group comprising a C₃₋₁₆ alicyclic hydrocarbon moiety optionally having one or more substituents,
R² each independently represents a C₁₋₁₆ alkyl group optionally having one or more substituents; a C₆₋₂₀ aromatic hydrocarbon group optionally having one or more substituents; or a hydrogen atom,
ne represents an integer of 1 or more, and
Formula (I-e) comprises one or more C₂₋₂₀ fluorine-containing organic groups.

The fluorine-containing aromatic polymer represented by Formula (I-e) may be a polyether, a polyester, or a polyamide, and is expected to be excellent in various properties such as flexibility, adhesion (reactivity) and affinity with another material, a low dielectric property, transparency, water/oil repellency, low tackiness, an antifouling property, solvent solubility, and high surface hardness while maintaining the properties of these resins.

Ar^{e1} each independently represents a divalent group comprising a C₆₋₂₀ aromatic hydrocarbon moiety optionally having one or more substituents, and examples of such a group comprise groups explained as the divalent group represented by Ar that comprises a C₆₋₂₀ aromatic hydrocarbon moiety optionally having one or more substituents.

Ar^{e1} is preferably a group represented by Formula (Ar1), more preferably one selected from phenylene group, xylylene group, hydroxyphenylene group, hydroxyxylylene group, naphthylene group, 2,2-diphenylpropane-4,4′-diyl group, 1,1-diphenylmethane-4,4′-diyl group, benzophenone-4,4′-diyl group, diphenylsulfone-4,4′-diyl group, and oxybisphenyl-4,4′-diyl group, and still more preferably phenylene group.

L^{e1} each independently represents one selected from the group consisting of —R¹—, —O—, —S—, —NR²—, —CO—, —CO—O—, —O—CO—, —O—CO—O—, —SO₂—, —NR²—CO—, and CO—NR²—. R¹ and R² have the same meaning as described above. L^{c1} is preferably one selected from the group consisting of —CO—O—, —O—, and CO—NH—.

L^{e2} each independently represents one selected from the group consisting of —R¹—, —O—, —S—, —NR²—, —CO—, —CO—O—, —O—CO—, —O—CO—O—, —SO₂—, —NR²—CO—, and CO—NR²—. R¹ and R² have the same meaning as described above. L^{e2} is preferably —R¹—.

L^{e3} each independently represents one selected from the group consisting of —R¹—, —O—, —S—, —NR²—, —CO—, —CO—O—, —O—CO—, —O—CO—O—, —SO₂—, —NR²—CO—, and CO—NR²—. R¹ and R² have the same meaning as described above. L^{e3} is preferably one selected from the group consisting of —O—CO—, —O—, and NH—CO—.

The C₂₋₂₀ fluorine-containing organic group is an organic group containing a fluorine atom. The C₂₋₂₀ fluorine-containing organic group is preferably a group represented by one or more selected from Formula (1A) and Formula (1B), and more preferably a group represented by Formula (1A).

ne represents an integer of 1 or more, and may be preferably 3 to 2,000, more preferably 5 to 1,000, and still more preferably 10 to 1,000.

A number average molecule weight of the fluorine-containing aromatic polymer represented by Formula (I-e) may be preferably 1,000 to 1,000,000, more preferably 2,000 to 500,000, and still more preferably 2,000 to 200,000.

The Formula (I-e) is preferably represented by the following Formula (I-e1), (I-e2) or (I-e3):

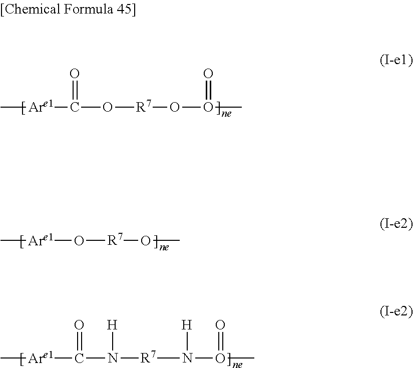

wherein
Ar^{e1} each independently represents a divalent group comprising a C₆₋₂₀ aromatic hydrocarbon moiety optionally having one or more substituents,
R⁷ represents one selected from a C₁₋₁₆ alkylene group optionally having one or more substituents; and a divalent group comprising a C₃₋₁₆ alicyclic hydrocarbon moiety optionally having one or more substituents,
ne each independently represents an integer of 1 or more, and
Formulas (I-e1), (I-e2), and (I-e3) each comprise one or more C₂₋₂₀ fluorine-containing organic groups.

A number average molecule weight of the fluorine-containing aromatic polymer represented by Formula (I-e1) may be preferably 1,000 to 1,000,000, more preferably 2,000 to 500,000, and still more preferably 2,000 to 200,000.

A number average molecule weight of the fluorine-containing aromatic polymer represented by Formula (I-e2) may be preferably 1,000 to 1,000,000, more preferably 2,000 to 500,000, and still more preferably 2,000 to 200,000.

A number average molecule weight of the fluorine-containing aromatic polymer represented by Formula (I-e3) may be preferably 1,000 to 1,000,000, more preferably 2,000 to 500,000, and still more preferably 2,000 to 200,000.

The Formula (I) is preferably represented by the following Formula (I-g):

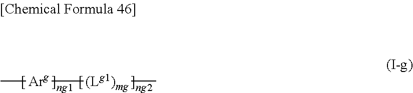

wherein
Ar^{g} each independently represents a divalent group comprising a C₆₋₂₀ aromatic hydrocarbon moiety optionally having one or more substituents,
mg each independently represents an integer of 0 to 4,
ng1 represents an integer of 1 or more,
ng2 represents an integer of 1 or more, and
Formula (I-g) comprises one or more C₂₋₂₀ fluorine-containing organic groups.

The fluorine-containing aromatic polymer represented by Formula (I-g) may be a copolymer of an aromatic polymer and a polymer containing an aliphatic or an alicyclic group, and is expected to be excellent in various properties such as flexibility, adhesion (reactivity) and affinity with another material, a low dielectric property, transparency, water/oil repellency, low tackiness, an antifouling property, solvent solubility, and high surface hardness while maintaining the properties of these resins.

Ar^{g} each independently represents a divalent group comprising a C₆₋₂₀ aromatic hydrocarbon moiety optionally having one or more substituents, and examples of such a group include groups explained as the divalent group represented by Ar that comprises a C₆₋₂₀ aromatic hydrocarbon moiety optionally having one or more substituents.

Ar^{g} is preferably a group represented by Formula (Ar1), more preferably one selected from phenylene group, xylylene group, hydroxyphenylene group, hydroxyxylylene group, naphthylene group, 2,2-diphenylpropane-4,4′-diyl group, 1,1-diphenylmethane-4,4′-diyl group, benzophenone-4,4′-diyl group, diphenylsulfone-4,4′-diyl group, and oxybisphenyl-4,4′-diyl group, and still more preferably phenylene group.

L^{g1} each independently represents one selected from the group consisting of —R¹—, —O—, —S—, —NR²—, —CO—, —CO—O—, —O—CO—, —O—CO—O—, —SO₂—, —NR²—CO—, and CO—NR²—. R¹ and R² have the same meaning as described above. L⁹¹ is preferably —R¹—, more preferably a divalent group comprising a C₃₋₁₆ alicyclic hydrocarbon moiety optionally having one or more substituents, and still more preferably a C₃₋₁₆ alicyclic hydrocarbon moiety optionally having one or more substituents.

mg represents an integer of 1 to 4, and may be preferably 1.

The C₂₋₂₀ fluorine-containing organic group is an organic group containing a fluorine atom. The C₂₋₂₀ fluorine-containing organic group is preferably a group represented by one or more selected from Formula (1A) and Formula (1B), and more preferably a group represented by Formula (1A).

In the fluorine-containing aromatic polymer represented by Formula (I-g), the order of appearance of the unit enclosed in parentheses with ng1 and the unit enclosed in parentheses with ng2 is not particularly limited. The fluorine-containing aromatic polymer represented by Formula (I-g) may be a random copolymer in which units enclosed in parentheses with ng1 and units enclosed in parentheses with ng2 are randomly arranged, or may be a block copolymer comprising a block comprising units enclosed in parentheses with ng1 and a block comprising units enclosed in parentheses with ng2.

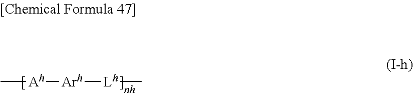

wherein
A^{h} each independently represents an aliphatic or aromatic imide-diyl group,
Ar^{h} each independently represents a divalent group comprising a C₆₋₂₀ aromatic hydrocarbon moiety optionally having one or more substituents,
L^{h} each independently represents one selected from the group consisting of —R¹—, —O—, —S—, —NR²—, —CO—, —CO—O—, —O—CO—, —O—CO—O—, —SO₂—, —NR²—CO—, and CO—NR²—,
R¹ each independently represents one selected from a C₁₋₁₆ alkylene group optionally having a substituent; and a divalent group comprising a C₃₋₁₆ alicyclic hydrocarbon moiety optionally having one or more substituents,
R² each independently represents a C₁₋₁₆ alkyl group optionally having one or more substituents; a C₆₋₂₀ aromatic hydrocarbon group optionally having one or more substituents; or a hydrogen atom,
nh represents an integer of 1 or more, and
Formula (1-h) comprises one or more C₁₋₂₀ fluorine-containing organic groups.

The fluorine-containing aromatic polymer represented by Formula (I-h) may be a polyamideimide comprising an imide-N-yl group in a repeating unit, and is expected to be excellent in various properties such as flexibility, adhesion (reactivity) and affinity with another material, a low dielectric property, transparency, water/oil repellency, low tackiness, an antifouling property, solvent solubility, and high surface hardness while maintaining the properties of these resins.

A^{h} each independently represents an aliphatic or aromatic imide-diyl group, and examples of the aliphatic or aromatic imide-diyl group include groups explained as the aliphatic or aromatic imide-diyl group represented by A.

A^{h} is preferably an aliphatic or aromatic imide-diyl group comprising one or more imide rings and optionally having one or more substituents, more preferably a group represented by Formula (A1-II), and still more preferably a group represented by Formula (A2-II).

Ar^{h} each independently represents a divalent group comprising a C₆₋₂₀ aromatic hydrocarbon moiety optionally having one or more substituents, and examples of such a group comprise groups explained as the divalent group represented by Ar that comprises a C₆₋₂₀ aromatic hydrocarbon moiety optionally having one or more substituents.

Ar^{h} is preferably a group represented by Formula (Ar1), more preferably one selected from phenylene group, xylylene group, hydroxyphenylene group, hydroxyxylylene group, naphthylene group, 2,2-diphenylpropane-4,4′-diyl group, 1,1-diphenylmethane-4,4′-diyl group, benzophenone-4,4′-diyl group, diphenylsulfone-4,4′-diyl group, and oxybisphenyl-4,4′-diyl group, and still more preferably phenylene group.

L^{h} each independently represents one selected from the group consisting of —R¹—, —O—, —S—, —NR²—, —CO—, —CO—O—, —O—CO—, —O—CO—O—, —SO₂—, —NR²—CO—, and CO—NR²—. R¹ and R² have the same meaning as described above. L^{h} is preferably —NH—CO—.

The C₁₋₂₀ fluorine-containing organic group is an organic group containing a fluorine atom. The C₁₋₂₀ fluorine-containing organic group is preferably a group represented by one or more selected from Formula (2A) and Formula (2B), and more preferably a group represented by Formula (2A).

nh represents an integer of 1 or more, and may be preferably 3 to 2,000, more preferably 5 to 1,000, and still more preferably 10 to 1,000.

A number average molecule weight of the fluorine-containing aromatic polymer represented by Formula (I-h) may be preferably 1,000 to 1,000,000, more preferably 2,000 to 500,000, and still more preferably 2,000 to 200,000.

The Formula (I-h) is preferably represented by the following Formula (I-h1):

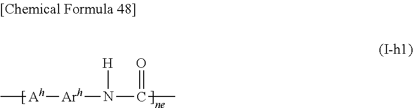

wherein
A^{h} each independently represents an aliphatic or aromatic imide-diyl group,
Ar^{h} each independently represents a divalent group comprising a C₆₋₂₀ aromatic hydrocarbon moiety optionally having one or more substituents,
nh each independently represents an integer of 1 or more, and
Formula (I-h1) comprises one or more C₁₋₂₀ fluorine-containing organic groups.

A number average molecule weight of the fluorine-containing aromatic polymer represented by Formula (I-h1) may be preferably 1,000 to 1,000,000, more preferably 2,000 to 500,000, and still more preferably 2,000 to 200,000.

### (Method for Producing Fluorine-Containing Aromatic Polymer)

The fluorine-containing aromatic polymer of the present disclosure may be produced with a production method comprising introducing a fluorine-containing organic group into an aromatic polymer to obtain a fluorine-containing aromatic polymer (production method 1). The fluorine-containing aromatic polymer of the present disclosure may also be produced with a production method comprising introducing a fluorine-containing group into an aromatic monomer to obtain a fluorine-containing aromatic monomer and using the fluorine-containing aromatic monomer as a monomer to obtain a fluorine-containing aromatic polymer (production method 2).

In the production method of the present disclosure, a compound represented by the following Formula (II) is used as a compound for introduction of a fluorine-containing organic group, and thus various fluorine-containing organic groups may be introduced. In the production method of the present disclosure, a fluorine-containing organic group may be introduced into both a monomer and a polymer by using the compound represented by Formula (II), and the distribution of fluorine-containing organic groups in the fluorine-containing aromatic polymer may also be controlled.

### Production Method 1

The present disclosure comprises a method for producing a fluorine-containing aromatic polymer represented by the following Formula (I-1):

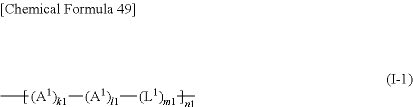

wherein
A¹ each independently represents an aliphatic or aromatic imide-diyl group,
Ar¹ each independently represents a divalent group comprising a C₆₋₂₀ aromatic hydrocarbon moiety optionally having one or more substituents,
L¹ each independently represents one selected from the group consisting of —R¹¹—, —O—, —S—, —NR¹²—, —CO—, —CO—O—, —O—CO—, —O—CO—O—, —SO₂—, —NR¹²—CO—, and CO—NR¹²—,
R¹¹ each independently represents one selected from a C₁₋₁₆ alkylene group optionally having a substituent; and a divalent group comprising a C₃₋₁₆ alicyclic hydrocarbon moiety optionally having one or more substituents,
R¹² each independently represents a C₁₋₁₆ alkyl group optionally having a substituent; a C₆₋₂₀ aromatic hydrocarbon group optionally having one or more substituents; or hydrogen atom,
k1 each independently represents an integer of 0 to 4,
l1 each independently represents an integer of 1 to 4,
m1 each independently represents an integer of 0 to 4,
n1 represents an integer of 1 or more,
in a unit enclosed in parentheses with n1, units enclosed in parentheses with k1, l1, and m1 appear in any order, and
Formula (I-1) comprises 1 or more C₁₋₂₀ fluorine-containing organic groups,
   the method comprising reacting an aromatic polymer represented by the following Formula (I-2):

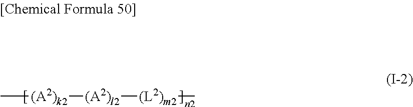

wherein
A² each independently represents an aliphatic or aromatic imide-diyl group,
Ar² each independently represents a divalent group comprising a C₆₋₂₀ aromatic hydrocarbon moiety optionally having one or more substituents,
L each independently represents one selected from the group consisting of —R²¹—, —O—, —S—, —NR²²—, —CO—, —CO—O—, —O—CO—, —O—CO—O—, —SO₂—, —NR²²—CO—, and CO—NR²²—
R²¹ each independently represents one selected from a C₁₋₁₆ alkylene group optionally having one or more substituents; and a divalent group comprising a C₃₋₁₆ alicyclic hydrocarbon moiety optionally having one or more substituents,
R²² each independently represents a C₁₋₁₆ alkyl group optionally having one or more substituents; a C₆₋₂₀ aromatic hydrocarbon group optionally having one or more substituents; or a hydrogen atom,
k2 each independently represents an integer of 0 to 4,
l2 each independently represents an integer of 1 to 4,
m2 each independently represents an integer of 0 to 4,
n2 represents an integer of 1 or more, and
in a unit enclosed in parentheses with n2, units enclosed in parentheses with k2, l2, and m2 appear in any order,
with a compound represented by the following Formula (II):

I—R^{f1} (II)
wherein R^{f1} represents a C₁₋₂₀ fluorine-containing organic group (hereinafter referred to as “Reaction of Introducing Fluorine-Containing Organic Group” into Aromatic Polymer) (Production Method 1).

According to the production method 1, a fluorine-containing organic group is introduced after production of an aromatic polymer, and therefore the structure and the number average molecular weight of the polymer may be easily selected from a wide range. For the same reason, a widely distributed and easily available aromatic polymer may be utilized as a raw material, and a fluorine-containing aromatic polymer may be easily produced. The raw material aromatic polymer is not limited to a powdery or pellet-shaped non-molded article, and easily available molded articles may be used such as plates, films, and various parts. In this case, a fluorine-containing organic group may be introduced only to the surface of a molded article without changing the shape of the molded article. Furthermore, in this production method, a fluorine-containing organic group tends to be easily introduced into a plurality of positions in an aromatic ring, and a polymer having a composition like a random copolymer may be produced due to the form. Such a random copolymer-like polymer has low order and thus exhibits an effective molecular design for expression of flexibility represented by low Tg and high thermal expansion (CTE). In general, a substituent effect is recognized in the introduction of a fluorine-containing organic group into such an aromatic ring, and an electron-attracting substituent deactivates the aromatic ring. However, according to the production method 1, a fluorine-containing organic group may be effectively introduced also into an inert aromatic ring having an electron-attracting substituent.

A¹ each independently represents an aliphatic or aromatic imide-diyl group, and examples of the aliphatic or aromatic imide-diyl group include groups explained as the aliphatic or aromatic imide-diyl group represented by A.

A¹ is preferably an aliphatic or aromatic imide-diyl group comprising one or more imide rings and optionally having one or more substituents, more preferably a group represented by Formula (A1), still more preferably a group represented by Formula (A2), and still even more preferably a group represented by one of Formulas (A1-1) to (A1-19).

The aliphatic or aromatic imide-diyl group represented by A¹ may have a substituent. Examples of the substituent include one or more selected from C₁₋₂₀ fluorine-containing organic groups, C₁₋₁₆ alkyl groups, C₁₋₁₆ alkoxy groups, and a fluorine atom, and one or more selected from C₁₋₁₆ alkyl groups, C₁₋₁₆ alkoxy groups, and a fluorine atom are preferable. The C₁₋₂₀ fluorine-containing organic group is an organic group containing a fluorine atom. The C₁₋₂₀ fluorine-containing organic group is preferably a group represented by one or more selected from Formula (2A) and Formula (2B), and more preferably a group represented by Formula (2-a), Formula (2-b), Formula (2-c), or Formula (2B). In one aspect, the C₁₋₂₀ fluorine-containing organic group is an organic group containing a fluorine atom. The C₁₋₂₀ fluorine-containing organic group is preferably a group represented by Formula (2A), and more preferably a group represented by Formula (2-a), Formula (2-b), or Formula (2-c).

A² each independently represents an aliphatic or aromatic imide-diyl group, and examples of the aliphatic or aromatic imide-diyl group include groups explained as the aliphatic or aromatic imide-diyl group represented by A.

A² is preferably an aliphatic or aromatic imide-diyl group comprising one or more imide rings and optionally having one or more substituents, more preferably a group represented by Formula (A1), still more preferably a group represented by Formula (A2), and still even more preferably a group represented by one of Formulas (A1-1) to (A1-19).

The aliphatic or aromatic imide-diyl group represented by A² may have a substituent. Examples of the substituent comprise one or more selected from C₁₋₁₆ alkyl groups, C₁₋₁₆ alkoxy groups, and a fluorine atom.

Ar¹ each independently represents a divalent group comprising a C₆₋₂₀ aromatic hydrocarbon moiety optionally having one or more substituents, and examples of such a group include groups explained as the divalent group represented by Ar that comprises a C₆₋₂₀ aromatic hydrocarbon moiety optionally having one or more substituents.

Ar¹ is preferably a group represented by Formula (Ar1), more preferably one selected from phenylene group, xylylene group, 2,2-diphenylpropane-4,4′-diyl group, 1,1-diphenylmethane-4,4′-diyl group, benzophenone-4,4′-diyl group, diphenylsulfone-4,4′-diyl group, and oxybisphenyl-4,4′-diyl group, and still more preferably phenylene group.

The divalent group represented by Ar¹ that comprises a C₆₋₂₀ aromatic hydrocarbon moiety may have a substituent. Examples of the substituent include groups explained as the substituent that may be comprised in the divalent group represented by Ar that comprises a C₆₋₂₀ aromatic hydrocarbon moiety, and include one or more selected from C₁₋₂₀ fluorine-containing organic groups, C₁₋₁₆ alkyl groups, C₁₋₁₆ alkoxy groups, and a fluorine atom, and C₁₋₂₀ fluorine-containing organic groups, C₁₋₁₆ alkoxy groups, and a fluorine atom are preferable. Two or more of the substituents that may be comprised in the C₆₋₂₀ aromatic hydrocarbon moiety may be bonded to each other to form a ring together with the C₆₋₂₀ aromatic hydrocarbon moiety.

Ar² each independently represents a divalent group comprising a C₆₋₂₀ aromatic hydrocarbon moiety optionally having one or more substituents, and examples of such a group comprise groups explained as the divalent group represented by Ar that comprises a C₆₋₂₀ aromatic hydrocarbon moiety optionally having one or more substituents.

Ar² is preferably a group represented by Formula (Ar1), more preferably one selected from phenylene group, xylylene group, 2,2-diphenylpropane-4,4′-diyl group, 1,1-diphenylmethane-4,4′-diyl group, benzophenone-4,4′-diyl group, diphenylsulfone-4,4′-diyl group, and oxybisphenyl-4,4′-diyl group, and still more preferably phenylene group.

The divalent group represented by Ar² that comprises a C₆₋₂₀ aromatic hydrocarbon moiety may have a substituent. Examples of the substituent include groups explained as the substituent that may be comprised in the divalent group represented by Ar that comprises a C₆₋₂₀ aromatic hydrocarbon moiety, and include one or more selected from C₁₋₁₆ alkyl groups, C₁₋₁₆ alkoxy groups, and a fluorine atom, and C₁₋₁₆ alkoxy groups and a fluorine atom are preferable. Two or more of the substituents that may be comprised in the divalent group comprising a C₆₋₂₀ aromatic hydrocarbon moiety may be bonded to each other to form a ring together with the C₆₋₂₀ aromatic hydrocarbon moiety.

L¹ each independently represents one selected from the group consisting of —R¹¹, —O—, —S—, —NR¹²—, —CO—, —CO—O—, —O—CO—, —O—CO—O—, —SO₂—, —NR¹²—CO—, and CO—NR¹²—.

R¹¹ each independently represents one selected from a C₁₋₁₆ alkylene group optionally having a substituent and a divalent group comprising a C₃₋₁₆ alicyclic hydrocarbon moiety optionally having one or more substituents.

The “C₁₋₁₆ alkylene moiety” in the C₁₋₁₆ alkylene group optionally having one or more substituents may be linear or branched, and is preferably a linear or branched C₁₋₁₀ alkylene moiety, and more preferably a linear or branched C₁₋₅ alkylene moiety. In one aspect, the “C₁₋₁₆ alkylene moiety” is a linear or branched C₁₋₃ alkylene moiety, and may be specifically —CH₂—, —CH₂CH₂—, or —CH₂CH₂CH₂—.

In one aspect, R¹¹ may be a C₁₋₁₆ alkylene group having no substituent. In another aspect, R¹¹ may be a C₁₋₁₆ alkylene group having a substituent.

The C₁₋₁₆ alkylene group optionally having one or more substituents may be substituted with one or more fluorine atoms. In one aspect, R¹¹ is preferably a C₁₋₁₆ fluoroalkylene group substituted with one or more fluorine atoms, more preferably a C₁₋₁₆ perfluoroalkylene group, still more preferably a C₁₋₆ perfluoroalkylene group, and still even more preferably a C₁₋₃ perfluoroalkylene group.

The C₁₋₁₆ perfluoroalkylene group may be linear or branched, and is preferably a linear or branched C₁₋₆ perfluoroalkylene group, more preferably a linear or branched C₁₋₃ perfluoroalkylene group, and specifically —CF₂—, —CF₂CF₂—, CF₂CF₂CF₂—, or CF₂CF(CF₃)—.

Examples of another substituent that may be comprised in the C₁₋₁₆ alkylene group represented by R¹¹ comprise a C₁₋₂₀ fluorine-containing organic group. The C₁₋₂₀ fluorine-containing organic group is an organic group containing a fluorine atom. The C₁₋₂₀ fluorine-containing organic group is preferably a group represented by one or more selected from Formula (2A) and Formula (2B), and more preferably a group represented by Formula (2A).

The “C₃₋₁₆ alicyclic hydrocarbon moiety” in the divalent group comprising a C₃-16 alicyclic hydrocarbon moiety optionally having one or more substituents may be monocyclic or polycyclimayd in the polycyclic ring, two or more rings may or may not form a bridged ring. In the divalent group comprising a C₃₋₁₆ alicyclic hydrocarbon moiety optionally having one or more substituents, the number of alicyclic hydrocarbon moieties is 1 or more, and may be preferably 1 to 4, more preferably 1 to 3, and still more preferably 1 or 2. The divalent group comprising the alicyclic hydrocarbon moiety is preferably a divalent C₃₋₁₆ alicyclic hydrocarbon group, and more preferably a divalent C₆₋₁₂ alicyclic hydrocarbon group, and may be still more preferably cyclohexanediyl group, decahydronaphthyl group, isobornyl group, tricyclo[5.2.1.0^{2,6}]demayediyl group, or adamantyl group.

In the divalent group comprising a C₃₋₁₆ alicyclic hydrocarbon moiety optionally having one or more substituents, two or more alicyclic hydrocarbon moieties may be bonded via a single bond or a divalent organic moiety. Examples of the organic moiety comprise a linear or branched C₁₋₄ alkyl moiety.

In one aspect, the divalent alicyclic hydrocarbon group represented by R¹¹ is a divalent alicyclic hydrocarbon group having a substituent, and in another aspect, is a divalent alicyclic hydrocarbon group having no substituent. Examples of the substituent that may be comprised in the divalent group represented by R¹¹ that comprises a C₃₋₁₆ alicyclic hydrocarbon moiety comprise a C₁₋₂₀ fluorine-containing organic group and a fluorine atom, and a fluorine atom is preferable. The C₁₋₂₀ fluorine-containing organic group is an organic group containing a fluorine atom. The C₁₋₂₀ fluorine-containing organic group is preferably a group represented by one or more selected from Formula (2A) and Formula (2B), and more preferably a group represented by Formula (2A).

In one aspect, the divalent C₃₋₁₆ alicyclic hydrocarbon group represented by R¹¹ is preferably a divalent C₃₋₁₆ alicyclic hydrocarbon group having no substituent, and more preferably may be a divalent C₆₋₁₂ alicyclic hydrocarbon group having no substituent.

In one aspect, R¹¹ may be a C₁₋₁₆ alkylene group having no substituent. In another aspect, R¹¹ may be a C₁₋₁₆ alkylene group having a substituent. In still another aspect, R¹¹ may be a divalent C₁₋₁₆ alicyclic hydrocarbon group having no substituent.

R¹² each independently represents a C₁₋₁₆ alkyl group optionally having one or more substituents, a C₆₋₂₀ aromatic hydrocarbon group optionally having one or more substituents, or a hydrogen atom.

The “C₁₋₁₆ alkyl moiety” in the C₁₋₁₆ alkyl group optionally having one or more substituents may be linear or branched, and is preferably a linear or branched C₁₋₁₀ alkyl moiety, and more preferably a linear or branched C₁₋₅ alkyl moiety. In one aspect, the “C₁₋₁₆ alkyl moiety” is a linear or branched C₁₋₄ alkyl moiety, and may be specifically —CH₃, —CH₂CH₃, —CH₂CH₂CH₃, —CH(CH₃)₂, —CH₂CH₂CH₂CH₃, —CH₂CH(CH₃)₂, or —CH(CH₃)₃.

In one aspect, R¹² may be a C₁₋₁₆ alkyl group having no substituent. In another aspect, R¹² may be a C₁₋₁₆ alkyl group having a substituent.

The C₁₋₁₆ alkyl group optionally having one or more substituents may be substituted with one or more fluorine atoms. In one aspect, R¹² is preferably a C₁₋₁₆ fluoroalkyl group substituted with one or more fluorine atoms, more preferably a C₁₋₁₆ perfluoroalkyl group, still more preferably a C₁₋₆ perfluoroalkyl group, and still even more preferably a C₁₋₄ perfluoroalkyl group, and may be specifically —CF₃, —CF₂CF₃, —CF₂CF₂CF₃, —CF(CF₃)₂, —CF₂CF₂CF₂CF₃, —CF₂CF(CF₃)₂, or —CF(CF₃)₃.

The “C₆₋₂₀ aromatic hydrocarbon moiety” in the C₆₋₂₀ aromatic hydrocarbon group optionally having one or more substituents may be monocyclic or polycyclimayd in the polycyclic ring, two or more rings may or may not form a fused ring. The C₆₋₂₀ aromatic hydrocarbon group optionally having one or more substituents is preferably a C₆₋₁₀ aromatic hydrocarbon group, and more preferably phenylene group, tolylene group, xylylene group, or naphthylene group. In one aspect, the C₆₋₂₀ aromatic hydrocarbon group is more preferably phenylene group, tolylene group, or xylylene group, and in another aspect, may be still more preferably naphthylene group.

Examples of the substituent that may be comprised in the C₆₋₂₀ aromatic hydrocarbon group include a hydroxyl group.

L¹ is preferably one selected from the group consisting of —O—, —S—, —CO—, —O—CO—O—, —SO₂—, —NR¹²—CO—, and CO—NR¹²_.

L² each independently represents one selected from the group consisting of —R²¹, —O—, —S—, —NR²²—, —CO—, —CO—O—, —O—CO—, —O—CO—O—, —SO₂—, —NR²²—CO—, and CO—NR²²—.

R²¹ each independently represents one selected from a C₁₋₁₆ alkylene group optionally having a substituent and a divalent group comprising a C₃₋₁₆ alicyclic hydrocarbon moiety optionally having one or more substituents.

The “C₁₋₁₆ alkylene moiety” in the C₁₋₁₆ alkylene group optionally having one or more substituents may be linear or branched, and is preferably a linear or branched C₁₋₁₀ alkylene moiety, and more preferably a linear or branched C₁₋₅ alkylene moiety. In one aspect, the “C₁₋₁₆ alkylene moiety” is a linear or branched C₁₋₃ alkylene moiety, and may be specifically —CH₂—, —CH₂CH₂—, or —CH₂CH₂CH₂—.

In one aspect, the alkylene group represented by R²¹ may be a C₁₋₁₆ alkylene group having no substituent. In another aspect, the alkylene group represented by R²¹ may be a C₁₋₁₆ alkylene group having a substituent.

The C₁₋₁₆ alkylene group optionally having one or more substituents may be substituted with one or more fluorine atoms. In one aspect, R¹¹ is preferably a C₁₋₁₆ fluoroalkylene group substituted with one or more fluorine atoms, more preferably a C₂₋₁₆ perfluoroalkylene group, still more preferably a C₁₋₆ perfluoroalkylene group, and still even more preferably a C₁₋₃ perfluoroalkylene group.

The C₁₋₁₆ perfluoroalkylene group may be linear or branched, and is preferably a linear or branched C₁₋₆ perfluoroalkylene group, more preferably a linear or branched C₁₋₃ perfluoroalkylene group, and specifically —CF₂—, —CF₂CF₂—, CF₂CF₂CF₂—, or CF₂CF(CF₃)—.

Examples of another substituent that may be comprised in the C₁₋₁₆ alkylene group represented by R²¹ include a C₁₋₂₀ fluorine-containing organic group. The C₁₋₂₀ fluorine-containing organic group is an organic group containing a fluorine atom. The C₁₋₂₀ fluorine-containing organic group is preferably a group represented by one or more selected from Formula (2A) and Formula (2B), and more preferably a group represented by Formula (2A).

The “C₃₋₁₆ alicyclic hydrocarbon moiety” in the divalent group comprising a C₃₋₁₆ alicyclic hydrocarbon moiety optionally having one or more substituents may be monocyclic or polycyclimayd in the polycyclic ring, two or more rings may or may not form a bridged ring. In the divalent group comprising a C₃₋₁₆ alicyclic hydrocarbon moiety optionally having one or more substituents, the number of alicyclic hydrocarbon moieties is 1 or more, and may be preferably 1 to 4, more preferably 1 to 3, and still more preferably 1 or 2. The divalent group comprising the alicyclic hydrocarbon moiety is preferably a divalent C₃₋₁₆ alicyclic hydrocarbon group, and more preferably a divalent C₆₋₁₂ alicyclic hydrocarbon group, and may be still more preferably cyclohexanediyl group, decahydronaphthyl group, isobornyl group, tricyclo[5.2.1.0^{2,6}]demayediyl group, or adamantyl group.

In the divalent group comprising a C₃₋₁₆ alicyclic hydrocarbon moiety optionally having one or more substituents, two or more alicyclic hydrocarbon moieties may be bonded via a single bond or a divalent organic moiety. Examples of the organic moiety comprise a linear or branched C₁₋₄ alkyl moiety.

In one aspect, the divalent alicyclic hydrocarbon group represented by R²¹ is a divalent alicyclic hydrocarbon group having a substituent, and in another aspect, is a divalent alicyclic hydrocarbon group having no substituent. Examples of the substituent that may be comprised in the divalent group represented by R¹¹ that comprises a C₃₋₁₆ alicyclic hydrocarbon moiety include a C₁₋₂₀ fluorine-containing organic group and a fluorine atom, and a fluorine atom is preferable. The C₁₋₂₀ fluorine-containing organic group is an organic group containing a fluorine atom. The C₁₋₂₀ fluorine-containing organic group is preferably a group represented by one or more selected from Formula (2A) and Formula (2B), and more preferably a group represented by Formula (2A).

In one aspect, the divalent C₃₋₁₆ alicyclic hydrocarbon group represented by R²¹ is preferably a divalent C₃₋₁₆ alicyclic hydrocarbon group having no substituent, and more preferably may be a divalent C₆₋₁₂ alicyclic hydrocarbon group having no substituent.

In one aspect, R²¹ may be a C₁₋₁₆ alkylene group having no substituent. In another aspect, R²¹ may be a C₁₋₁₆ alkylene group having a substituent. In still another aspect, R²¹ may be a divalent C₁₋₁₆ alicyclic hydrocarbon group having no substituent.

R²² each independently represents a C₁₋₁₆ alkyl group optionally having one or more substituents, a C₆₋₂₀ aromatic hydrocarbon group optionally having one or more substituents, or a hydrogen atom.

The “C₁₋₁₆ alkyl moiety” in the C₁₋₁₆ alkyl group optionally having one or more substituents may be linear or branched, and is preferably a linear or branched C₁₋₁₀ alkyl moiety, and more preferably a linear or branched C₁₋₅ alkyl moiety. In one aspect, the “C₁₋₁₆ alkyl moiety” is a linear or branched C₁₋₄ alkyl moiety, and may be specifically —CH₃, —CH₂CH₃, —CH₂CH₂CH₃, —CH(CH₃)₂, —CH₂CH₂CH₂CH₃, —CH₂CH(CH₃)₂, or —CH(CH₃)₃.

In one aspect, R²² may be a C₁₋₁₆ alkyl group having no substituent. In another aspect, R²² may be a C₁₋₁₆ alkyl group having a substituent.

The C₁₋₁₆ alkyl group optionally having one or more substituents may be substituted with one or more fluorine atoms. In one aspect, R²² is preferably a C₁₋₁₆ fluoroalkyl group substituted with one or more fluorine atoms, more preferably a C₁₋₁₆ perfluoroalkyl group, still more preferably a C₁₋₆ perfluoroalkyl group, and still even more preferably a C₁₋₄ perfluoroalkyl group, and may be specifically —CF₃, —CF₂CF₃, —CF₂CF₂CF₃, —CF(CF₃)₂, —CF₂CF₂CF₂CF₃, —CF₂CF(CF₃)₂, or —CF(CF₃)₃.

The “C₆₋₂₀ aromatic hydrocarbon moiety” in the C₆₋₂₀ aromatic hydrocarbon group optionally having one or more substituents may be monocyclic or polycyclimayd in the polycyclic ring, two or more rings may or may not form a fused ring. The C₆₋₂₀ aromatic hydrocarbon group optionally having one or more substituents is preferably a C₆₋₁₀ aromatic hydrocarbon group, and more preferably phenylene group, tolylene group, xylylene group, or naphthylene group. In one aspect, the C₆₋₂₀ aromatic hydrocarbon group is more preferably phenylene group, tolylene group, or xylylene group, and in another aspect, may be still more preferably a naphthylene group.

Examples of the substituent that may be comprised in the C₆₋₂₀ aromatic hydrocarbon group include a hydroxyl group.

L² is preferably one selected from the group consisting of —O—, —S—, —CO—, —O—CO—O—, —SO₂—, —NR²²—CO—, and CO—NR²²—.

k1 represents an integer of 0 to 4, and may be preferably 0 to 1.

l1 represents an integer of 1 to 4, may be preferably 1 to 3.

m1 represents an integer of 0 to 4, may be preferably 0 to 3.

k2 represents an integer of 0 to 4, may be preferably 0 to 1.

l2 represents an integer of 1 to 4, may be preferably 1 to 3.

m2 represents an integer of 0 to 4, may be preferably 0 to 3.

n1 represents an integer of 1 or more, and may be preferably 5 to 2,000, more preferably 10 to 1,000.

n2 represents an integer of 1 or more, and may be preferably 5 to 2,000, more preferably 10 to 1,000.

A number average molecule weight of the fluorine-containing aromatic polymer represented by Formula (I-1) may be preferably 1,000 to 1,000,000, more preferably 2,000 to 500,000, and still more preferably 2,000 to 200,000.

A number average molecule weight of the fluorine-containing aromatic polymer represented by Formula (I-2) may be preferably 1,000 to 1,000,000, more preferably 2,000 to 500,000, and still more preferably 2,000 to 200,000.

R^{f1} represents a C₁₋₂₀ fluorine-containing organic group. The C₁₋₂₀ fluorine-containing organic group is a C₁₋₂₀ organic group containing a fluorine atom. The C₁₋₂₀ fluorine-containing organic group is preferably a group represented by one or more selected from Formula (2A) and Formula (2B), and more preferably may be a group represented by Formula (2-a), Formula (2-b), Formula (2-c), or Formula (2B). In one aspect, the C₁₋₂₀ fluorine-containing organic group is a C₁₋₂₀ organic group containing a fluorine atom. The C₁₋₂₀ fluorine-containing organic group is preferably a group represented by Formula (2A), and more preferably may be a group represented by Formula (2-a), Formula (2-b), or Formula (2-c).

The ratio of the substance amount of the compound represented by Formula (II) to the substance amount of the whole aromatic rings comprised in the aromatic polymer (value obtained by dividing the substance amount of the compound represented by Formula (II) by the substance amount of the whole aromatic rings) may be preferably 0.01 or more, more preferably 0.02 to 10, still more preferably 0.05 to 5, and still even more preferably 0.05 to 3.

### Production Method 1: Reaction of Introducing Fluorine-Containing Organic Group into Aromatic Polymer

The above reaction may be performed under light irradiation. The light irradiation is preferably ultraviolet irradiation, and may be performed by irradiation with light having a wavelength of 300 to 400 nm, for example, a wavelength of 350 to 380 nm.

The light source used for such light irradiation is not particularly limited, and examples of the light source comprise an LED, a mercury lamp, a xenon lamp, a UV lamp, a halogen lamp, a fluorescent lamp, sunlight, and indoor light, and an LED is preferably used.

The above reaction may be preferably performed using a basic compound, a catalyst, a one-electron reducing agent, or a radical generator.

Examples of the basic compound comprise inorganic bases such as Cs₂CO₃, K₂CO₃, Na₂CO₃, Li₂CO₃, CsF, CsHCO₃, KHCO₃, NaHCO₃, and LiHCO₃, amine compounds such as triethylamine, tributylamine, diisopropylethylamine, N,N,N′,N′-tetramethylenediamine, N,N,N′,N′-tetraethylenediamine, pyrrolidine, pyridine, collidine, ammonia, dimethylamine, and DBU, tributylphosphine, triphenylphosphine, triarylphosphines, and disubstituted phosphines, and Cs₂CO₃ is preferably used.

Examples of the catalyst comprise transition metal complexes, organic dye compounds, and enamine compounds.

Examples of the central metal of the transition metal complex include cobalt, ruthenium, rhodium, rhenium, iridium, zinc, nickel, palladium, osmium, and platinum.

Examples of the organic dye compound include rose bengal, erythrosine, eosin (examples: Eosin B, Eosin Y), acriflavine, riboflavin, thionine, phenoxazine, and phenothiazine.

The enamine compound has a structure represented by

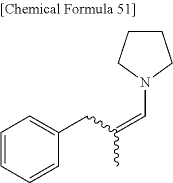

and is a chemical species generated by reacting an aldehyde

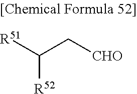

wherein R⁵¹ represents phenyl group or benzyl group, and R⁵² represents hydrogen atom, methyl group, or phenyl group
with a pyrrolidine

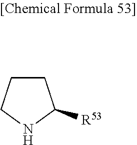

wherein R⁵³ represents hydrogen atom or bis(3,4-dimethoxyphenyl)methoxymethyl group. An enamine compound synthesized in advance may be added, or an aldehyde and a pyrrole may be directly added to generate a catalyst in the reaction system.

Examples of the aldehyde include 3-phenyl-2-methylpropanal, 2-phenylpropanal, diphenylacetaldehyde, and phenylacetaldehyde.

Examples of the pyrrolidine include pyrrolidine and (S)-2-[3,4-bis(dimethoxyphenyl)methoxymethyl]pyrrolidine.

Examples of the one-electron reducing agent comprise sodium thiosulfate, lithium dithionite, sodium dithionite, potassium dithionite, cesium dithionite, copper(I) iodide, copper(I) bromide, copper(I) chloride, triethylamine, tributylamine, tetrabutylammonium iodide, tetrabutylphosphonium iodide, ascorbic acid, an ascorbate, a zinc powder, an indium powder, and a magnesium powder. The one-electron reducing agent is preferably sodium thiosulfate, sodium dithionite, copper(I) iodide, or copper(I) bromide, and particularly preferably sodium thiosulfate or sodium dithionite.

Examples of the radical generator comprise organic peroxides, inorganic peroxides, and organic azo compounds, and an organic peroxide is preferably used. Although not limited to the following, examples of the organic peroxide comprise benzoyl peroxide, examples of the inorganic peroxide comprise potassium persulfite, and examples of the organic azo compound comprise azobisisobutyronitrile (AIBN).

The above reaction is preferably performed in a solvent. The solvent is not particularly limited, and examples of the solvent comprise dichloromethane, chloroform, carbon tetrachloride, dichloroethane, dichloropentafluoropropane (HCFC-225), a perfluoroaliphatic hydrocarbon having 5 to 12 carbon atoms (such as perfluorohexane, perfluoromethylcyclohexane, or perfluoro-1,3-dimethylcyclohexane); a polyfluoroaromatic hydrocarbon (such as bis(trifluoromethyl)benzene); a polyfluoroaliphatic hydrocarbon (for example, C₆F₁₃CH₂CH₃ (such as ASAHIKLIN (registered trademark) AC-6000 manufactured by Asahi Glass Co., Ltd.), 1,1,2,2,3,3,4-heptafluorocyclopentane (such as ZEORORA (registered trademark) H manufactured by Zeon Corporation); a hydrofluoroether (HFE) (such as an alkyl perfluoroalkyl ether (in which the perfluoroalkyl moiety and the alkyl moiety may be linear or branched), for example, perfluoropropyl methyl ether (C₃F₇₀CH₃) (such as Novec (trademark) 7000 manufactured by Sumitomo 3M Limited), perfluorobutyl methyl ether (C₄F₉OCH₃) (such as Novec (trademark) 7100 manufactured by Sumitomo 3M Limited), perfluorobutyl ethyl ether (C₄F₉OC₂H₅) (such as Novec (trademark) 7200 manufactured by Sumitomo 3M Limited), perfluorohexyl methyl ether (C₂F₅CF(OCH₃)C₃F₇) (such as Novec (trademark) 7300 manufactured by Sumitomo 3M Limited), or CF₃CH₂OCF₂CHF₂ (such as ASAHIKLIN (registered trademark) AE-3000 manufactured by Asahi Glass Co., Ltd.)), an aromatic hydrocarbon (such as benzene, toluene, xylene, or mesitylene); a sulfone-based solvent (such as dimethylsulfone or sulfolane); an ether-based solvent (such as tetrahydrofuran, 1,4-dioxane, 2-methyltetrahydrofuran, 4-methyltetrahydropyran, monoglyme, diglyme, triglyme, or tetraglyme); acetonitrile; nitromethane; an amide solvent (N,N-dimethylformamide, N,N-dimethylacetamide, N-methylpyrrolidone, N,N′-dimethylpropyleneurea, or 1,3-dimethyl-2-imidazolidinone); an ester-based solvent (such as ethyl acetate or butyl acetate); and a ketone-based solvent (such as acetone, methyl ethyl ketone, or methyl isobutyl ketone).

The reaction temperature in the above reaction may be preferably 0 to 60 °C, more preferably 10 to 40° Mayd for example, room temperature. The reaction time in the above reaction may be, for example, 1 to 72 hours, and preferably 12 to 48 hours.

### Production Method 1: Production of Aromatic Polymer

The aromatic polymer represented by Formula (I-2) may be produced by polymerization of aromatic monomers, and a commercially available product may be used.

Examples of the aromatic monomers include a compound comprising an aromatic ring and having two or more groups having an active hydrogen atom, and preferably include an aromatic monomer represented by the following Formula (III):

R⁴—Ar³—R⁴ (III)
wherein
Ar³ each independently represents a divalent group comprising a C₆₋₂₀ aromatic hydrocarbon moiety optionally having one or more substituents, and
R⁴ each independently represents —OH, —NH₂, a fluorine atom, or a chlorine atom.

Ar³ each independently represents a divalent group comprising a C₆₋₂₀ aromatic hydrocarbon moiety optionally having one or more substituents.

The “C₆₋₂₀ aromatic hydrocarbon moiety” in the divalent group comprising a C₆₋₂₀ aromatic hydrocarbon moiety optionally having one or more substituents may be monocyclic or polycyclimayd in the polycyclic ring, two or more rings may or may not form a fused ring. The number of aromatic hydrocarbon moieties comprised in the divalent group comprising a C₆₋₂₀ aromatic hydrocarbon moiety optionally having one or more substituents is 1 or more, and may be preferably 1 to 4, more preferably 1 to 3, and still more preferably 1 or 2. In the divalent group comprising a C₆₋₂₀ aromatic hydrocarbon moiety optionally having one or more substituents, and the two or more rings may be bonded via a single bond or a divalent organic moiety. Two or more of the substituents that may be comprised in the divalent group comprising a C₆₋₂₀ aromatic hydrocarbon moiety may be bonded to each other to form a ring together with the C₆₋₂₀ aromatic hydrocarbon moiety.

Ar³ is preferably a group represented by Formula (Ar1), and is more preferably phenylene group, xylylene group, naphthylene group, biphenylene group, 3,3′-dimethylbiphenylene group, 2,2′-dimethylbiphenylene group, 2,2′-dimethoxybiphenylene group, 3,3′,5,5′-tetramethylbiphenylene group, 3,3′,5,5′-tetraethylbiphenylene group, 2,2-diphenylpropane-4,4′-diyl group, 2,2-diphenylpropane-4,4′-diyl group, 1,1-diphenylmethane-4,4′-diyl group, benzophenone-4,4′-diyl group, diphenylsulfone-4,4′-diyl group, or oxybisphenyl-4,4′-diyl group, and still more preferably phenylene group, xylylene group, 2,2-diphenylpropane-4,4′-diyl group, 1,1-diphenylmethane-4,4′-diyl group, benzophenone-4,4′-diyl group, diphenylsulfone-4,4′-diyl group, or oxybisphenyl-4,4′-diyl group.

R⁴ each independently represents —OH, —NH₂, fluorine atom, or chlorine atom, and preferably may be —OH or NH₂. In one aspect, two R⁴s may be different from each other, and for example, one R⁴ may be —OH, and the other R⁴ may be fluorine atom. In another aspect, two R⁴s may be the same kind of groups.

The aromatic polymer represented by Formula (I-2) may be produced by reacting an aromatic monomer with a second monomer.

Examples of the second monomer include a monomer capable of reacting with the aromatic monomer represented by Formula (III), and the monomer preferably has two or more groups capable of reacting with an amino group or a hydroxyl group in one molecule. Examples of such a monomer include a compound represented by the following Formula (IV):

R⁵-L¹⁰-R⁵ (IV)
wherein
R⁵ each independently represents one selected from the following Formulas (r-1) to (r-18):

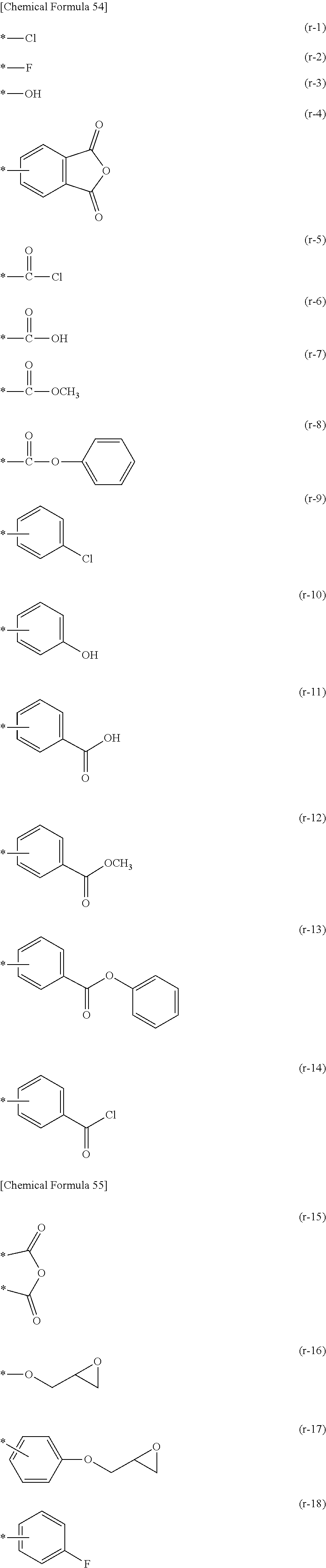

wherein * represents a bond, and
L¹⁰ represents one selected from the following Formulas (l-1) to (l-11):

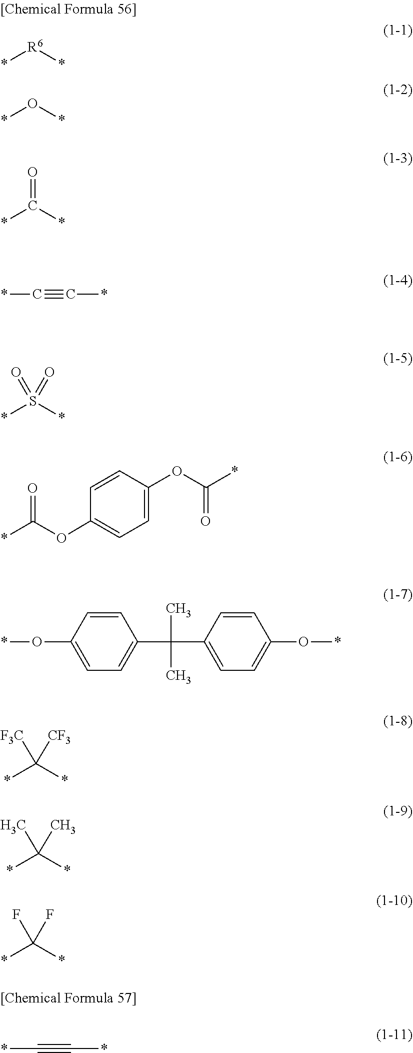

wherein R⁶ represents a C₁₋₁₆ alkylene group optionally substituted with one or more fluorine atoms, or a divalent group comprising a C₆₋₂₀ aromatic hydrocarbon moiety optionally having one or more substituents, and
* represents a bond.

In Formula (IV), when R⁵ is a divalent group, L¹⁰ may be a tetravalent group, and may be, for example, a group represented by the following formula:

(*—)₂R⁶⁰(-*)₂ (1-12)
wherein R⁶⁰ represents a C₁₋₁₆ alkanetetrayl group optionally substituted with one or more fluorine atoms, or a tetravalent C₆₋₂₀ aromatic hydrocarbon group optionally having one or more substituents.

R⁶ represents a C₁₋₁₆ alkylene group optionally substituted with one or more fluorine atoms, or a divalent group comprising a C₆₋₂₀ aromatic hydrocarbon moiety optionally having one or more substituents.

The “C₁₋₁₆ alkylene moiety” in the C₁₋₁₆ alkylene group optionally substituted with one or more fluorine atoms may be linear or branched, and is preferably a linear or branched C₁₋₁₀ alkylene moiety, and more preferably a linear or branched C₁₋₅ alkylene moiety. In one aspect, the “C₁₋₁₆ alkylene moiety” is a linear or branched C₁₋₃ alkylene moiety, and may be specifically —CH₂—, —CH₂CH₂—, or —CH₂CH₂CH₂—.

The C₁₋₁₆ alkylene group optionally having one or more substituents may be substituted with one or more fluorine atoms. In one aspect, R⁶ is preferably a C₁₋₁₆ fluoroalkylene group substituted with one or more fluorine atoms, more preferably a C₁₋₁₆ perfluoroalkylene group, still more preferably a C₁₋₆ perfluoroalkylene group, and still even more preferably a C₁₋₃ perfluoroalkylene group. In another aspect, R⁶ may be a C₁₋₁₆ alkylene group that is not substituted with a fluorine atom.

The C₁₋₁₆ perfluoroalkylene group may be linear or branched, and is preferably a linear or branched C₁₋₆ perfluoroalkylene group, more preferably a linear or branched C₁₋₃ perfluoroalkylene group, and specifically —CF₂—, —CF₂CF₂—, —CF₂CF₂CF₂—, or —CF₂CF(CF₃)—.

The “C₆₋₂₀ aromatic hydrocarbon moiety” in the divalent group comprising a C₆₋₂₀ aromatic hydrocarbon moiety optionally having one or more substituents may be monocyclic or polycyclimayd in the polycyclic ring, two or more rings may or may not form a fused ring. The number of aromatic hydrocarbon moieties comprised in the divalent group comprising a C₆₋₂₀ aromatic hydrocarbon moiety optionally having one or more substituents is 1 or more, and may be preferably 1 to 4, more preferably 1 to 3, and still more preferably 1 or 2. The aromatic hydrocarbon moiety is preferably a C₆₋₁₀ aromatic hydrocarbon moiety, and more preferably phenylene moiety, tolylene moiety, xylylene moiety, or naphthylene moiety, and may be still more preferably phenylene moiety, tolylene moiety, or xylylene moiety.

In the divalent group comprising a C₆₋₂₀ aromatic hydrocarbon moiety optionally having one or more substituents, two or more aromatic hydrocarbon moieties may be bonded via a single bond or an organic moiety. Examples of the organic moiety comprise a linear or branched C₁₋₄ alkyl moiety.

The divalent group represented by R⁶ that comprises an aromatic hydrocarbon moiety is preferably a group represented by Formula (Ar1), and is more preferably phenylene group, tolylene group, xylylene group, naphthylene group, biphenylene group, 3,3′-dimethylbiphenylene group, 2,2′-dimethylbiphenylene group, 2,2′-dimethoxybiphenylene group, 3,3′,5,5′-tetramethylbiphenylene group, 3,3′,5,5′-tetraethylbiphenylene group, 2,2-diphenylpropane-4,4′-diyl group, 1,1-diphenylmethane-4,4′-diyl group, benzophenone-4,4′-diyl group, diphenylsulfone-4,4′-diyl group, or oxybisphenyl-4,4′-diyl group, and still more preferably phenylene group, xylylene group, 2,2-diphenylpropane-4,4′-diyl group, 1,1-diphenylmethane-4,4′-diyl group, benzophenone-4,4′-diyl group, diphenylsulfone-4,4′-diyl group, or oxybisphenyl-4,4′-diyl group.

Preferred examples of the compound represented by Formula (IV) include a compound wherein R⁵ is a group represented by any of Formulas (r-1), (r-2), and (r-9) and L¹⁰ is a group represented by Formula (1-3), a compound wherein R⁵ is a group represented by Formula (r-3) or (r-10) and L¹⁰ is a group represented by any of Formulas (l-1), (l-4), (l-7), (l-8), and (l-9), a compound wherein R⁵ is a group represented by any of Formulas (r-3), (r-5), (r-6), (r-7), (r-8), (r-10), (r-11), (r-12), (r-13), and (r-14) and L¹⁰ is a group represented by any of Formulas (l-1), (l-4), (l-7), (l-8), (l-9), and (l-10), a compound wherein R⁵ is a group represented by Formula (r-4) and L¹⁰ is a group represented by any of Formulas (l-1) to (l-7), a compound wherein R⁵ is a group represented by Formula (r-15) and L¹⁰ is represented by Formula (l-12), a compound wherein R⁵ is a group represented by Formula (r-17) and L¹⁰ is represented by Formula (l-9), and a compound wherein R⁵ is a group represented by Formula (r-18) and L¹⁰ is represented by Formulas (l-3), (l-5), (l-8), or (l-10).

The amount of the second monomer based on 1 mol of the aromatic monomer may be preferably 0.1 mol to 10 mol, more preferably 0.2 mol to 5 mol, and still more preferably 0.5 mol to 2 mol.

The reaction using the aromatic monomer as a monomer and the reaction between the aromatic monomer and the second monomer may be performed with a publicly-known method.

### Production Method 2

The present disclosure comprises a method for producing a fluorine-containing aromatic polymer represented by the following Formula (I-1):

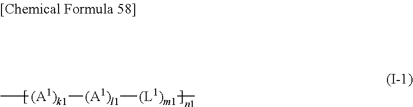

wherein
A¹ each independently represents an aliphatic or aromatic imide-diyl group,
Ar¹ each independently represents a divalent group comprising a C₆₋₂₀ aromatic hydrocarbon moiety optionally having one or more substituents,
L¹ each independently represents one selected from the group consisting of —R¹¹—, —O—, —S—, —NR¹²—, —CO—, —CO—O—, —O—CO—, —O—CO—O—, —SO₂—, —NR¹²—CO—, and CO—NR¹²—,
R¹¹ each independently represents one selected from a C₁₋₁₆ alkylene group optionally having a substituent; and a divalent group comprising a C₃₋₁₆ alicyclic hydrocarbon moiety optionally having one or more substituents,
R¹² each independently represents a C₁₋₁₆ alkyl group optionally having a substituent; a C₆₋₂₀ aromatic hydrocarbon group optionally having one or more substituents; or hydrogen atom,
k1 each independently represents an integer of 0 to 4,
l1 each independently represents an integer of 1 to 4,
m1 each independently represents an integer of 0 to 4,
n1 represents an integer of 1 or more,
in a unit enclosed in parentheses with n1, units enclosed in parentheses with k1, l1, and m1 appear in any order, and
Formula (I-1) comprises 1 or more C₁₋₂₀ fluorine-containing organic groups,
the method comprising reacting an aromatic monomer with a compound represented by the following Formula (II):
I—R^{f1} (II) wherein R¹ represents a C₁₋₂₀ fluorine-containing organic group
to obtain a fluorine-containing aromatic monomer (herein after referred to as “Reaction of Introducing Fluorine-Containing Organic Group” into Aromatic Monomer), and
the method comprising obtaining a fluorine-containing aromatic polymer by using the fluorine-containing aromatic monomer as a polymerization monomer

### (Production Method 2)

According to the production method 2, a fluorine-containing organic group is introduced at the stage of a monomer, and therefore the bonding position of the fluorine-containing organic group is clear in the obtained fluorine-containing aromatic polymer, and thus a more ordered main chain structure may be designed. This may be an effective production method, for example, for enhancement of the properties of crystallinity, high Tg, and low CTE. Furthermore, it may be easy to obtain a fluorine-containing aromatic polymer having a high distribution density of fluorine-containing organic groups and further exhibiting the properties of the fluorine-containing organic groups. Meanwhile, the distribution density of the fluorine-containing organic groups may be reduced and/or controlled to a desired range by copolymerizing a fluorine-free monomer as necessary.

A¹, Ar¹, L¹, k1, l1, m1, R¹¹, R¹², and R^{f1} have the same meaning as described above.

Examples of the aromatic monomer include a compound comprising an aromatic ring and having two or more groups having an active hydrogen atom, more preferably include a compound comprising an aromatic ring and having two or more of one kind of group selected from a hydroxy group (—OH) and an amino group (—NH₂), and more preferably include an aromatic monomer represented by the Formula (III).

When the fluorine-containing aromatic monomer is used as a monomer to obtain a fluorine-containing aromatic polymer, the fluorine-containing aromatic monomer may be reacted with a second monomer. Examples of the second monomer include a monomer capable of reacting with the aromatic monomer represented by Formula (III), and a monomer is preferable that has two or more groups capable of reacting with an amino group or a hydroxyl group in one molecule. Examples of the monomer include a compound represented by Formula (IV).

The amount of the second monomer based on 1 mol of the fluorine-containing aromatic monomer may be preferably 0.1 mol to 10 mol, more preferably 0.2 mol to 5 mol, and still more preferably 0.5 mol to 2 mol.

### Production Method 2: Reaction of Introducing Fluorine-Containing Organic Group into Aromatic Monomer

In the reaction between the aromatic monomer and the compound represented by Formula (II), the amount of the compound represented by Formula (II) based on 1 mol of the aromatic monomer may be preferably 0.01 mol or more, more preferably 0.02 mol to 10 mol, and still more preferably 0.05 mol to 5 mol.

The reaction between the aromatic monomer and the compound represented by Formula (II) may be performed under light irradiation. The light irradiation is preferably ultraviolet irradiation, and is performed by irradiation with light having a wavelength of 300 to 400 nm, for example, a wavelength of 350 to 380 nm.

The light source used for such light irradiation is not particularly limited, and examples of the light source include an LED, a mercury lamp, a xenon lamp, a UV lamp, and a halogen lamp, and an LED is preferably used.

The above reaction may be preferably performed using a basic compound, a catalyst, a one-electron reducing agent, or a radical generator. As the basic compound, the catalyst, the one-electron reducing agent, or the radical generator, any of the compounds described above in Production Method 1 may be used.

The above reaction is preferably performed in a solvent. As the solvent, any of the solvents described above in Production Method 1 may be used.

The reaction temperature in the above reaction may be preferably 0 to 60 °C, more preferably 10 to 40° Mayd for example, room temperature. The reaction time in the above reaction may be, for example, 1 to 72 hours, and preferably 12 to 48 hours.

### Production Method 2: Polymerization Reaction of Aromatic Polymer

The reaction using the fluorine-containing aromatic monomer as a monomer may be performed with a publicly-known method as a method of performing a reaction using an aromatic monomer as a monomer. The reaction between the fluorine-containing aromatic monomer and the second monomer may be performed with a publicly-known method as a method of performing a reaction between the aromatic monomer and the second monomer.

In such a reaction, the reaction solvent described in Production Method 1 may be used as a reaction solvent. The kind and the amount of the solvent used may be appropriately determined according to the fluorine-containing aromatic monomer and the second monomer to be used.

### (Fluorine-containing Monomer)

The present disclosure comprises one or more of a fluorine-containing monomer represented by the following formula (III-1):

R⁴¹—Ar³¹—R⁴¹ (III-1)
wherein
Ar³¹ each independently represents a divalent group comprising a C₆₋₂₀ aromatic hydrocarbon moiety optionally having one or more substituents,
R⁴¹ each independently represents —OH, —NH₂, glycidyloxy group, fluorine atom, or chlorine atom, and
Formula (III-1) comprises one or more C₁₋₂₀ fluorine-containing organic groups,
the C₁₋₂₀ fluorine-containing organic groups are represented by one or more selected from Formula (2-1A) and Formula (2B):

R³³—X—(R^{F1})ᵣ—CF₂—* (2-1A)

*—X¹—CF₂—* (2B)
wherein
R^{F1} represents —(Rf)ₚ—R_{F}—(O)_{q},
Rf each independently represents a C₁₋₁₆ alkylene group optionally substituted with one or more fluorine atoms,
R^{F} represents a divalent fluoro(poly)ether group,
X¹ represents a C₁₋₁₆ alkylene group optionally substituted with one or more halogen atoms; or single bond,
R³³ represents a C₆₋₂₀ aromatic hydrocarbon group optionally having one or more substituents; a silsesquioxane residue optionally having one or more substituents; —COOR^{f2}; —OR^{f2}; —SO₂R^{f3}; —CR^{f4}═CR^{f5}₂; fluorine atom; bromine atom; or iodine atom,
R^{f2} each independently represents a C₁₋₁₆ alkyl group optionally substituted with one or more fluorine atoms; or hydrogen atom,
R^{f3} represents a C₁₋₁₆ alkyl group optionally substituted with one or more halogen atoms; fluorine atom; or hydrogen atom,
R^{f4} each independently represents hydrogen atom or fluorine atom,
p is 0 or 1, q is 0 or 1, r is 0 or 1,
* represents a bond,
Formula (2-1A) or Formula (2B) comprises 1 to 20 carbon atoms.

A fluorine-containing aromatic polymer may be produced using such a fluorine-containing aromatic monomer. Using such a fluorine-containing aromatic monomer may clarify the bonding position of the fluorine-containing organic group in the obtained fluorine-containing aromatic polymer, and thus a more ordered main chain structure may be designed. This may be an effective production method, for example, for enhancement of the properties of crystallinity, high Tg, and low CTE. Furthermore, using such a fluorine-containing aromatic monomer may make it easy to obtain a fluorine-containing aromatic polymer having a high distribution density of fluorine-containing organic groups and further exhibiting the properties of the fluorine-containing organic groups. Meanwhile, the distribution density of the fluorine-containing organic groups may be reduced and controlled to a desired range by copolymerizing a fluorine-free monomer as necessary.

X¹, R^{F1}, R^{f2}, R^{f3}, p, q, and r have the same meaning as described above.

Ar³¹ each independently represents a divalent group comprising a C₆₋₂₀ aromatic hydrocarbon moiety optionally having one or more substituents.

The “C₆₋₂₀ aromatic hydrocarbon moiety” in the divalent group comprising a C₆₋₂₀ aromatic hydrocarbon moiety optionally having one or more substituents may be monocyclic or polycyclimayd in the polycyclic ring, two or more rings may or may not form a fused ring. The number of aromatic hydrocarbon moieties comprised in the divalent group comprising a C₆₋₂₀ aromatic hydrocarbon moiety optionally having one or more substituents is 1 or more, and may be preferably 1 to 4, more preferably 1 to 3, and still more preferably 1 or 2. In the divalent group comprising a C₆₋₂₀ aromatic hydrocarbon moiety optionally having one or more substituents, two or more rings may be bonded via a single bond or a divalent organic moiety.

Ar³¹ is preferably a group represented by Formula (Ar1), and is more preferably phenylene group, xylylene group, naphthylene group, biphenylene group, 2,2-diphenylpropane-4,4′-diyl group, 1,1-diphenylmethane-4,4′-diyl group, benzophenone-4,4′-diyl group, diphenylsulfone-4,4′-diyl group, or oxybisphenyl-4,4′-diyl group, and still more preferably phenylene group, xylylene group, 2,2-diphenylpropane-4,4′-diyl group, 1,1-diphenylmethane-4,4′-diyl group, benzophenone-4,4′-diyl group, diphenylsulfone-4,4′-diyl group, or oxybisphenyl-4,4′-diyl group.

R⁴¹ each independently represents —OH, —NH₂, glycidyloxy group, fluorine atom, or chlorine atom, and preferably may be —OH or NH₂. In one aspect, two R⁴¹s may be different from each other, and for example, one R⁴¹ may be —OH, and the other R⁴¹ may be fluorine atom. In another aspect, two R⁴¹s may be the same kind of groups.

R³³ represents a C₆₋₂₀ aromatic hydrocarbon group optionally having one or more substituents, a silsesquioxane residue optionally having one or more substituents, —COOR^{f2}, —OR^{f2}, —SO₂R^{f3}, —CR^{f4}═CR^{f4}₂, fluorine atom, bromine atom, or an iodine atom.

Examples of the substituent in the C₆₋₂₀ aromatic hydrocarbon group optionally having one or more substituents include halogen atoms such as fluorine atom, chlorine atom, bromine atom, and iodine atom, a C₁₋₄ alkyl group, a C₁₋₄ alkoxy group, and R²⁰, —O—CO— (wherein R²⁰ represents a C₁₋₄ alkyl group). Among them, a halogen atom is preferable, and fluorine atom is particularly preferable. R²⁰ may be linear or branched, and is preferably a linear or branched C₁₋₃ alkyl group, and specifically, —CH₃ and —CH₂CH₃ are preferable.

The C₆₋₂₀ aromatic hydrocarbon group represented by R³³ is preferably a C₆₋₁₀ aromatic hydrocarbon group optionally having one or more substituents, and more preferably a C₆₋₁₀ aromatic hydrocarbon group optionally having one or more substituents. In one aspect, the C₆₋₂₀ aromatic hydrocarbon group represented by R³³ preferably has a substituent, and in another aspect, the C₆₋₂₀ aromatic hydrocarbon group represented by R³³ preferably has no substituent.

The “silsesquioxane residue” in the silsesquioxane residue represented by R³³ and optionally having one or more substituents is a monovalent moiety obtained by eliminating one substituent on Si in silsesquioxane, and may have any of a cage structure, a ladder structure, and a random structure.

The substituent in the silsesquioxane residue optionally having one or more substituents is preferably a C₁₋₁₀ alkyl group optionally substituted with one or more halogen atoms, or phenyl group, and more preferably a C₁₋₆ alkyl group optionally substituted with one or more halogen atoms, or phenyl group.

The “C₁₋₁₀ alkyl moiety” in the C₁₋₁₀ alkyl group that is a substituent of the silsesquioxane residue and is optionally substituted with one or more halogen atoms may be linear or branched, and is preferably a linear or branched C₁₋₈ alkyl moiety, and more preferably a linear C₁₋₆ alkyl moiety.

Examples of the halogen atom in the C₁₋₁₀ alkyl group that is a substituent of the silsesquioxane residue and is optionally substituted with one or more halogen atoms include fluorine atom, chlorine atom, bromine atom, and iodine atom, and fluorine atom and iodine atom are preferable.

The C₁₋₁₀ alkyl group that is a substituent of the silsesquioxane residue and is optionally substituted with one or more halogen atoms is preferably —CHI—CH₂—CF₂CF₂CF₂—I.

The substituent in the silsesquioxane residue optionally having one or more substituents is preferably phenyl group or isobutyl group.

When R³³ is an iodine atom, R³³ may be replaced with a bond in a unit represented by Formula (2-1A), and X¹ bonded to R³³ may be bonded to an aromatic ring of another fluorine-containing aromatic monomer. Although the present disclosure should not be construed as limited to a specific theory, the above structure is considered as follows. That is, it is considered that when the fluorine-containing aromatic monomer of the present disclosure is produced, an iodine atom of a compound in which an iodine atom is bonded to a unit represented by Formula (2-1A) is abstracted to form a reaction point, the reaction point is bonded to an aromatic ring of an aromatic monomer, and thus a fluorine-containing aromatic monomer represented by Formula (III-1) is obtained. When R³³ is an iodine atom, it is considered that the iodine atom corresponding to R³³ may be similarly abstracted and the resulting reaction point may be bonded to another aromatic ring. Similarly when a substituent of the group represented by R³³ comprises an I atom, the group bonded to the I atom may be bonded to another aromatic ring.

R³³ is preferably a C₆₋₂₀ aromatic hydrocarbon group optionally having one or more substituents, —COOR^{f2}, —OR^{f2}, —SO₂R^{f3}, —CR^{f4}═CR^{f4}₂, fluorine atom, bromine atom, or iodine atom.
* represents a bond.

Formula (2-1A) has 1 to 20 carbon atoms in total, and may preferably have 1 to 15 carbon atoms in total.

Formula (2B) has 1 to 20 carbon atoms in total, and may preferably have 1 to 15 carbon atoms in total.

The C₁₋₂₀ fluorine-containing organic group represented by Formula (2-1A) and Formula (2B) is preferably a C₁₋₂₀ fluoroalkyl group, a C₁₋₂₀ fluorine-containing organic group having a functional moiety, or a C₁₋₂₀ fluoro(poly)ether group. Specifically, Formula (2-1A) and Formula (2B) are preferably a group selected from the following Formula (2-1a), Formula (2-1b), Formula (2-1c), and Formula (2B):

F—X¹—CF₂—* (2-1a)

R³³—X¹—CF₂—* (2-1b)

R³³—X¹—R^{F1}—CF₂—* (2-1c)

*—X¹—CF₂—* (2B)
wherein
R^{F1} represents —(Rf)ₚ—R^{F}—(O)_{q},
Rf each independently represents a C₁₋₁₆ alkylene group optionally substituted with one or more fluorine atoms,
R^{F} represents a divalent fluoro(poly)ether group,
X¹ represents a C₁₋₁₆ alkylene group optionally substituted with one or more halogen atoms; or single bond,
R³³ represents a C₆₋₂₀ aromatic hydrocarbon group optionally having one or more substituents, a silsesquioxane residue optionally having one or more substituents, —COOR^{f2}, —OR^{f2}, —SO₂R^{f3}, —CR^{f4}═CR^{f4}₂, fluorine atom, or bromine atom,
R^{f2} each independently represents a C₁₋₁₆ alkyl group optionally substituted with one or more fluorine atoms; or hydrogen atom,
R^{f3} represents a C₁₋₁₆ alkyl group optionally substituted with one or more halogen atoms; fluorine atom; or hydrogen atom,
R^{f4} each independently represents hydrogen atom or fluorine atom,
p is 0 or 1, q is 0 or 1, r is 0 or 1,
* represents a bond,
Formula (2-1a) has 1 to 20 carbon atoms,
Formula (2-1b) has 1 to 20 carbon atoms,
Formula (2-1c) has 1 to 20 carbon atoms, and
Formula (2B) has 1 to 20 carbon atoms.

The number of fluorine-containing organic groups comprised in the fluorine-containing aromatic monomer is 1 or more, and may be preferably 1 to 8, more preferably 1 to 4, and still more preferably 1 to 3. The number of fluorine-containing organic groups comprised in the fluorine-containing aromatic monomer may be preferably 1 to 4, and more preferably 1 to 2 per aromatic ring comprised in the fluorine-containing aromatic monomer. In one aspect, when the fluorine-containing organic groups are C₁ fluorine-containing organic groups (particularly —CF₃), the number of the groups may be preferably 2 to 6, more preferably 2 to 4, and still more preferably 3 to 4 per unit.
In the aromatic ring, the substitution position of the fluorine-containing organic group is preferably an ortho position with respect to R⁴¹.

### (Product)

The technical scope of the present disclosure comprises a product comprising a substrate; and a layer formed on a surface of the substrate using a surface treatment agent,
wherein the substrate comprising an aromatic polymer,
wherein the surface treatment agent comprising a compound represented by one or more selected from Formula (II-1A) and Formula (II-1B):

R³²—X¹—(R^{F1})ᵣ—CF₂—I (1I-1A)

I-X¹—CF₂—I (II-1B)
wherein
R^{F1} represents —(Rf)ₚ—R^{F}—(O)_{q},
Rf each independently represents a C₁₋₁₆ alkylene group optionally substituted with one or more fluorine atoms,
R^{F} represents a divalent fluoro(poly)ether group,
X¹ represents a C₁₋₁₆ alkylene group optionally substituted with one or more halogen atoms; or single bond,
R³² represents a C₁₋₁₆ alkyl group optionally substituted with one or more halogen atoms; a C₆₋₂₀ aromatic hydrocarbon group optionally having one or more substituents; a silsesquioxane residue optionally having one or more substituents; —COOR^{f2}; —OR^{f2}; —SO₂R^{f3}; —CR^{f4}═CR^{f4}₂; fluorine atom; bromine atom; or iodine atom,
R^{f2} each independently represents a C₁₋₁₆ alkyl group optionally substituted with one or more fluorine atoms; or a hydrogen atom,
R^{f3} represents a C₁₋₁₆ alkyl group optionally substituted with one or more halogen atoms; fluorine atom; or hydrogen atom,
R^{f4} each independently represents hydrogen atom or fluorine atom,
p is 0 or 1, q is 0 or 1, r is 0 or 1,
* represents a bond,
Formula (II-1A) comprises 1 to 20 carbon atoms, and
Formula (II-1B) comprises 1 to 20 carbon atoms.

The product of the present disclosure is given a fluorine-containing organic group on a substrate containing an aromatic polymer, and therefore is expected to further have flexibility, an antifouling property, a friction property, an antifouling property, and water/oil repellency while further improving the heat resistance of the aromatic polymer.

The substrate is to contain an aromatic polymer. Examples of the aromatic polymer include resins comprising an aromatic ring, such as a polyimide resin, a polyetherimide resin, a polyamideimide resin, a polysulfone resin, an aromatic polyamide resin, a polyetheretherketone resin, a polyethersulfone resin, an aromatic polyester resin, a phenol resin, a cresol resin, an epoxy resin, and a polyamic acid.

The substrate may contain only an aromatic polymer, or may contain an aromatic polymer and another material in combination. As another material, any suitable material may be contained such as glass, another resin, a metal (a simple metal such as aluminum, copper, or iron, or an alloy containing such a simple metal), a ceramic, a semiconductor (silicon, germanium, or the like), furs, leather, wood, paper, chinaware, stone, or fabric.

The substrate may be in the form of a powder, a membrane, a plate, a film, a pellet, a molded article (a component or the like), a fiber (yam, woven fabric, or non-woven fabric), or the like. The substrate surface region on which a layer is to be formed with the surface treatment agent is to be at least a part of the substrate surface, and may be appropriately determined according to, for example, the use and the specific specifications of the product to be produced. For example, it is possible to introduce a fluorine-containing organic group into only a part of the surface of a molded article.

The surface treatment agent contains a compound represented by one or more selected from Formula (II-1A) and Formula (II-1B), and preferably contains a compound represented by Formula (II-1A). In one aspect, the surface treatment agent may further contain a basic compound, a catalyst, a one-electron reducing agent, a radical generator, a solvent, or the like, in addition to the compound represented by one or more selected from Formula (II-1A) and Formula (II-1B). As the basic compound, the catalyst, the one-electron reducing agent, the radical generator, or the solvent, a compound that was described in Production Method 1 may be used.

### Method for Producing Product

The method for producing a product of the present disclosure comprises reacting the substrate with the surface treatment agent to form a layer on a surface of the substrate, the substrate contains an aromatic polymer, and the surface treatment agent contains a compound represented by one or more selected from Formula (II-1A) and Formula (II-1B), and preferably contains a compound represented by Formula (II-1A).

According to the method for producing a product of the present disclosure, a fluorine-containing organic group is given onto a substrate containing an aromatic polymer, and therefore it is expected that flexibility, an antifouling property, a friction property, an antifouling property, and water/oil repellency may be further imparted while the heat resistance of the aromatic polymer is further improved or maintained.

The above reaction may be performed under light irradiation. The light irradiation is preferably ultraviolet irradiation, and may be performed by irradiation with light having a wavelength of 300 to 400 nm, for example, a wavelength of 350 nm to 380 nm. As the light source used for such light irradiation, the light source described in Production Method 1 may be used.

The reaction temperature in the above reaction may be preferably 0 to 60 °C, more preferably 10 to 40° Mayd for example, room temperature. The reaction time in the above reaction may be, for example, 1 to 72 hours, and preferably 12 to 48 hours.

The method for producing a product may further comprise removing the surface treatment agent unreacted and/or a by-product after forming the layer on the surface of the substrate. The removal of the surface treatment agent unreacted and/or a by-product may be performed by one or more selected from washing and drying. A product obtained by removing the surface treatment agent unreacted and/or a by-product is also comprised in the technical scope of the product of the present disclosure.

### EXAMPLES

The present invention will be described more specifically with reference to the following Examples, but the present invention is not limited thereto.

### Example 1

Perfluorohexyl iodide (5 equivalents), 5 equivalents of an aqueous sodium thiosulfate solution (water: 2 mL), and 3 equivalents of cesium carbonate were added to a dichloromethane solution of 3,3′,5,5′-tetramethylbenzidine (1) (0.3 mmol), and light irradiation was performed with a 365 nm LED for 48 hours. After completion of the reaction, liquid separation operation was performed, followed by purification by column chromatography, and as a result, a desired diamine compound (2) was obtained in an isolation yield of 32%.

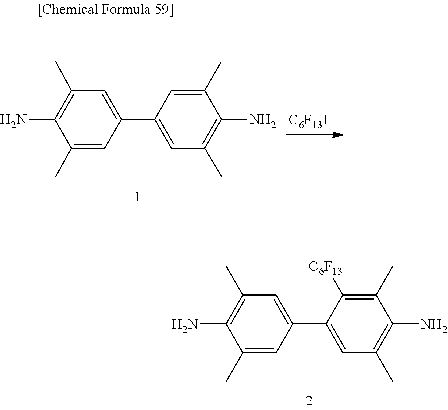

### Spectrum of Compound (2)

¹H NMR (400 MHz, CDCl₃)

δ 6.82 (s, 1H), 6.75 (s, 2H), 3.75 (s, 2H), 3.54 (s, 2H), 2.27 (s, 3H), 2.19 (s, 3H), 2.17 (s, 6H)

¹⁹F NMR (376 MHz, CDCl₃)

δ −81.29 (s, 3F), −95.18 (s, 2F), −118.13 (s, 2F), −122.34 (s, 2F), −123.20 (s, 2F), −126.65 (s, 2F)

### Example 2

To a dimethylacetamide solution (0.23 mL) of a diamine monomer (2) (58.9 mg, 0.11 mmol), 1 equivalent of 4,4′-oxydiphthalimayhydride (3) was added, and the mixture was stirred at room temperature for 1 hour. As a result, a viscous solution was obtained, and it was found from NMR and GPC measurements that a polyamic acid (4) was obtained that had a number average molecular weight of 1.3×10³ and a molecular weight distribution of 1.2.

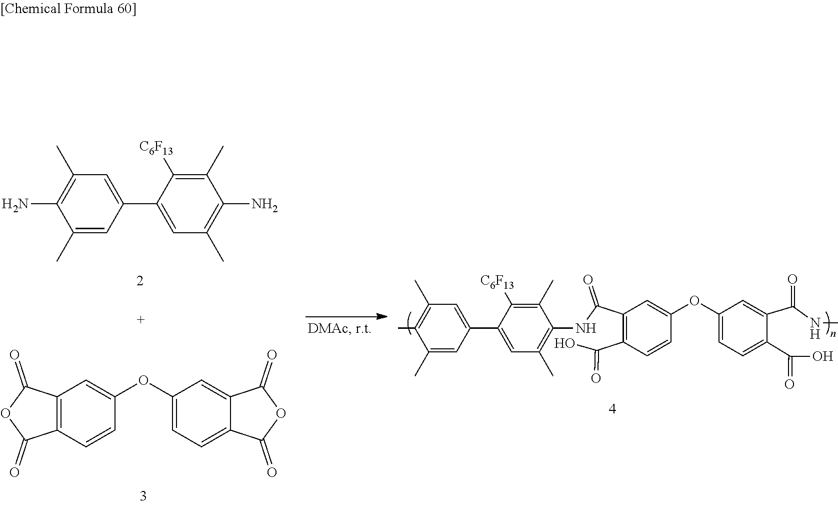

### Spectrum of Compound (4)

¹H NMR (400 MHz, CDCl₃)

δ 8.09-7.57 (6H, m), 7.18 (1H, s), 7.08 (2H, s), 2.33 (3H, s), 2.20 (3H, s), 2.18 (6H, s).

¹⁹F NMR (376 MHz, CDCl3)

δ −81.1 (3F, s), −96.1 (2F, s), −117.9 (2F, s), −122.2 (2F, s), −123.0 (2F, s), −126.4 (2F, s).

### Example 3

Perfluoropropyl iodide (5 equivalents), 5 equivalents of an aqueous sodium thiosulfate solution (water: 2 mL), and 3 equivalents of cesium carbonate were added to a dichloromethane solution (2.5 mL) of 3,3′,5,5′-tetramethylbenzidine (1) (0.3 mmol), and light irradiation was performed with a 365 nm LED for 48 hours. After completion of the reaction, liquid separation operation was performed, followed by purification by column chromatography, and as a result, a desired diamine compound (5) was obtained in an isolation yield of 35%.

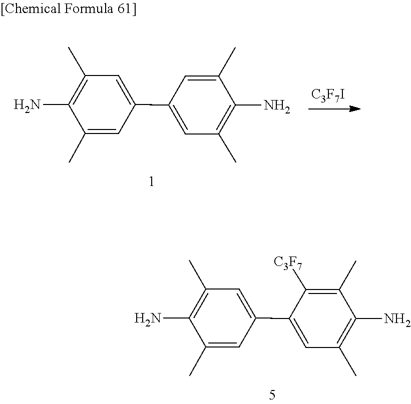

### Spectrum of Compound (5)

¹H NMR (400 MHz, CDCl₃)

δ 6.82 (s, 1H), 6.75 (s, 2H), 3.75 (s, 2H), 3.56 (s, 2H), 2.26 (s, 3H), 2.19 (s, 3H), 2.17 (s, 6H)

¹⁹F NMR (376 MHz, CDCl₃)

δ −80.67 (s, 3F), −95.73 (s, 2F), −122.34 (s, 2F)

### Example 4

Perfluoropropyl iodide (5 equivalents), 5 equivalents of an aqueous sodium thiosulfate solution (water: 2 mL), and 3 equivalents of cesium carbonate were added to a dichloromethane solution (2.5 mL) of 3,3′,5,5′-tetramethylbenzidine (1) (0.3 mmol), and light irradiation was performed with a 365 nm LED for 48 hours. After completion of the reaction, liquid separation operation was performed, followed by purification by column chromatography, and as a result, a desired diamine compound (6) was obtained in an isolation yield of 39%, and a compound (7) was obtained in an isolation yield of 7%.

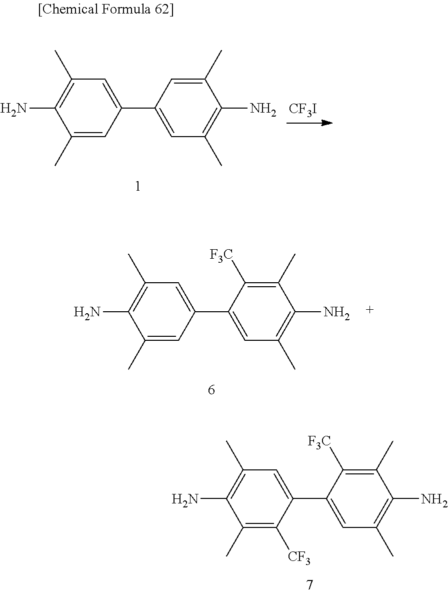

### Spectrum of Compound (6)

¹H NMR (400 MHz, CDCl₃)

δ 6.85 (1H, s), 6.83 (2H, s), 3.69 (4H, br s), 2.30 (3H, s), 2.30 (3H, s), 2.19 (6H, s).

¹⁹F NMR (376 MHz, CDCl₃)

δ=−51.2 (3F, s).

### Spectrum of Compound (7)

¹H NMR (400 MHz, CDCl₃)

δ 6.68 (2H, s), 3.69 (4H, br s), 2.29 (6H, s), 2.18 (6H, s).

¹⁹F NMR (376 MHz, CDCl₃)

δ −52.9 (6F, s).

### Example 5

To a dichloromethane solution (2.5 mL) of 3,3′,5,5′-tetramethylbenzidine (1) (0.3 mmol), 5 equivalents of 1,4-diiodoperfluorobutane, 5 equivalents of an aqueous sodium thiosulfate solution (water: 2 mL), and 3 equivalents of cesium carbonate were added, and light irradiation was performed with a 365 nm LED for 48 hours. After completion of the reaction, liquid separation operation was performed, followed by purification by column chromatography, and as a result, a desired diamine compound (8) was obtained in an isolation yield of 13%.

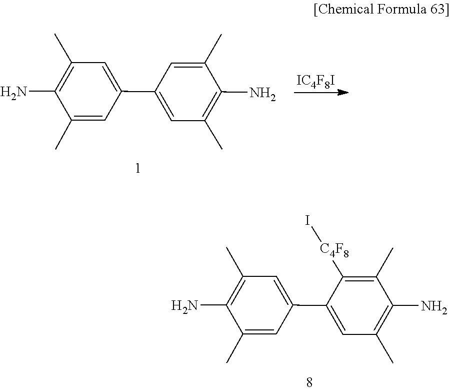

### Spectrum of Compound (8)

¹H NMR (400 MHz, CDCl₃)

δ 6.81 (1H, s), 6.74 (2H, s), 3.74 (2H, br s), 3.54 (2H, br s), 2.26 (3H, s), 2.18 (3H, s), 2.20 (6H, s).

¹⁹F NMR (376 MHz, CDCl₃)

δ −58.1 (2F, s), −95.1 (2F, s), −113.1 (2F, s), −117.1 (2F, s).

### Example 6

To a dichloromethane solution (2.5 mL) of 3,3′,5,5′-tetramethylbenzidine (1) (0.3 mmol), 5 equivalents of 1,6-diiodoperfluorohexane, 5 equivalents of an aqueous sodium thiosulfate solution (water: 2 mL), and 3 equivalents of cesium carbonate were added, and light irradiation was performed with a 365 nm LED for 48 hours. After completion of the reaction, liquid separation operation was performed, followed by purification by column chromatography, and as a result, a desired diamine compound (9) was obtained in an isolation yield of 14%.

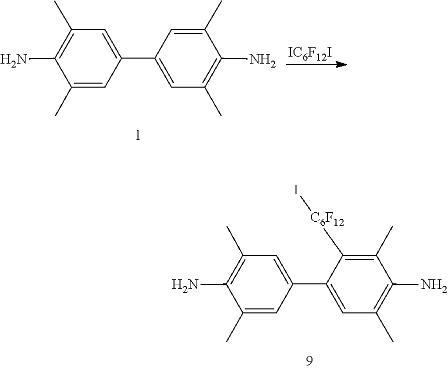

### Spectrum of Compound (9)

¹H NMR (400 MHz, CDCl₃)

δ 6.82 (1H, s), 6.75 (2H, s), 3.75 (2H, br s), 3.54 (2H, br s), 2.27 (3H, s), 2.19 (3H, s), 2.17 (6H, s).

¹⁹F NMR (376 MHz, CDCl₃)

δ −59.1 (2F, s), −95.1 (2F, s), −113.5 (2F, s), −118.0 (2F, s), −121.3 (2F, s), −123.9 (2F, s).

### Example 7

To a dichloromethane solution (2 mL) of 3,3′-tetramethylbenzidine (10), 1 equivalent of perfluorohexyl iodide, 5 equivalents of an aqueous sodium thiosulfate solution (2 mL), and 3 equivalents of cesium carbonate were added, and light irradiation was performed with a 365 nm LED for 24 hours. As a result, a desired diamine compound (11) was obtained in an isolation yield of 12%.

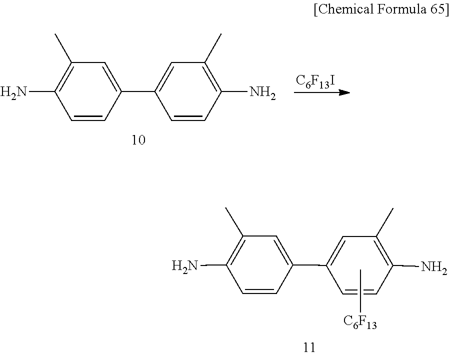

### Spectrum of Compound (11)

¹H NMR (400 MHz, CDCl₃)

δ 7.52-6.62 (5H, m), 4.20 (2H, br s), 3.48 (2H, br s), 2.32 (3H, s), 2.17 (3H, s).

¹⁹F NMR (376 MHz, CDCl₃)

δ −81.17 (3F, s), −108.27 (2F, s), −122.0 (4F, s), −123.1 (2F, s), −126.5 (2F, s).

### Example 8

To an acetonitrile (5 mL)/water (1 mL) mixed solution of 4,4′-dihydroxybiphenyl (12) (0.2 mmol), 6 equivalents of perfluorohexyl iodide, Phloxine B (20 mol %), ascorbic acid (4 equivalents), and cesium carbonate (3.5 equivalents) were added, and light irradiation was performed with a white LED for 24 hours under an argon atmosphere. As a result of NMR analysis, it was found that a desired dihydroxy monomer (13) was generated in a yield of 67% and a desired dihydroxy monomer (14) was generated in a yield of 14%.

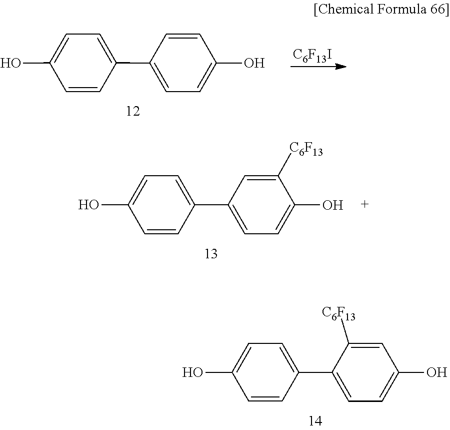

### Example 9

To 4,4′-diaminodiphenylphenylether (15) (0.6 mmol), 5 equivalents of perfluorohexyl iodide, 5 equivalents of an aqueous sodium thiosulfate solution (4 mL), and 3 equivalents of cesium carbonate were added, and light irradiation was performed at 365 nm for 24 hours. The obtained reaction mixture was purified by column chromatography to obtain a compound (16) into which one perfluorohexyl group was introduced in an isolation yield of 4%, a compound (17) into which two perfluorohexyl groups were introduced in an isolation yield of 30%, and a compound (18) into which three perfluorohexyl groups were introduced in an isolation yield of 22%.

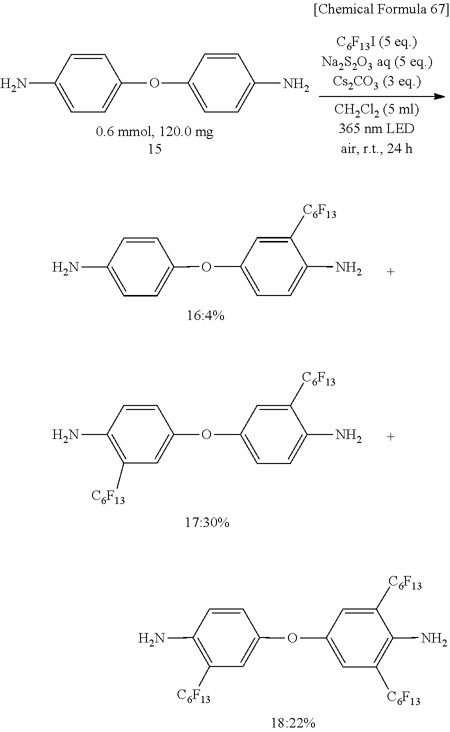

### Spectrum of Compound (17)

¹H NMR (400 MHz, CDCl₃)

δ 6.99 (dd, 2H, J=8.9, 3.0 Hz), 6.92 (d, 2H, J=2.8 Hz), 6.71 (d, 2H, J=9.2 Hz), 4.10 (s, 4H)

¹⁹F NMR (376 MHz, CDCl₃)

δ −81.32 (s, 6F), −109.38 (s, 4F), −122.22 (s, 4F), −122.34 (s, 4F), −123.27 (s, 4F), −126.68 (s, 4F)

¹H NMR (400 MHz, CDCl₃)

δ 7.21 (s, 2H), 7.00 (dd, 1H, J=8.9, 2.8 Hz), 6.93 (d, 1H, J=3.2 Hz), 6.72 (d, 1H, J=8.7 Hz), 4.75 (s, 2H), 4.15 (s, 2H)

¹⁹F NMR (376 MHz, CDCl₃)

δ −80.92 (s, 9F), −107.68 (s, 4F), −108.94 (s, 2F), −121.27 (s, 6F), −121.54 (s, 6F), −122.59 (s, 6F), −126.09 (s, 6F)

### Example 10

To 4,4′-diaminodiphenylphenylether (15) (0.6 mmol), 2 equivalents of perfluorohexyl iodide, 5 equivalents of an aqueous sodium thiosulfate solution (4 mL), and 3 equivalents of cesium carbonate were added, and light irradiation was performed at 365 nm for 24 hours. The obtained reaction mixture was subjected to NMR analysis, and it was confirmed that a compound (18) into which one perfluoropropyl group was introduced was generated in an NMR yield of 24% and a compound (19) into which two perfluoropropyl groups were introduced was generated in an NMR yield of 4%.

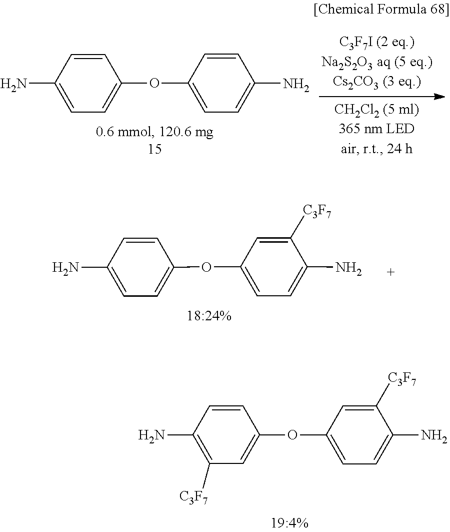

### Spectrum of Compound (18)

¹H NMR (400 MHz, CDCl₃)

δ 6.97 (dd, 2H, J=8.9, 3.0 Hz), 6.93 (d, 2H, J=2.8 Hz), 6.70 (d, 2H, J=9.2 Hz), 4.10 (s, 4H)

¹⁹F NMR (376 MHz, CDCl₃)

δ −80.70 (s, 6F), −110.36 (s, 4F), −126.92 (s, 4F)

### Example 11

To an acetonitrile (5 mL)/water (1 mL) mixed solution of 4,4′-dihydroxydiphenylether (20), 1 equivalent of perfluorohexyl iodide, Phloxine B (20 mol %), ascorbic acid (4 equivalents), and cesium carbonate (2.5 equivalents) were added, and light irradiation was performed with a white LED for 24 hours under an argon atmosphere. As a result of NMR analysis, it was found that synthesis of a desired dihydroxy monomer (21) was achieved in a yield of 21%.

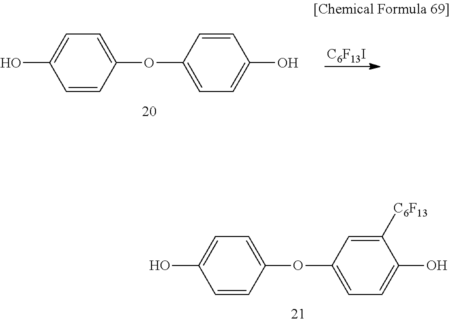

### Spectrum of Compound (21)

¹H NMR (400 MHz, CH₃CN) δ 7.81 (s, 1H), 7.54-7.53 (m, 2H), 7.33-7.32 (m, 2H), 7.20-7.18 (m, 1H), 7.14 (s, 1H), 3.96 (s, 1H), 3.91 (s, 1H)

¹⁹F NMR (376 MHz, CH₃CN) δ −79.8 (s, 3F), −106.2 (s, 2F), −120.0 (s, 2F), −120.6 (s, 2F), −121.6 (s, 2F), −125.0 (s, 2F)

### Example 12

To an acetonitrile (5 mL)/water (1 mL) mixed solution of 4,4′-methylenediphenol (22), 1 equivalent of perfluorohexyl iodide, Phloxine B (20 mol %), ascorbic acid (4 equivalents), and cesium carbonate (2.5 equivalents) were added, and light irradiation was performed with a white LED for 24 hours under an argon atmosphere. As a result of NMR analysis, it was found that synthesis of a desired dihydroxy monomer (23) was achieved in a yield of 12%.

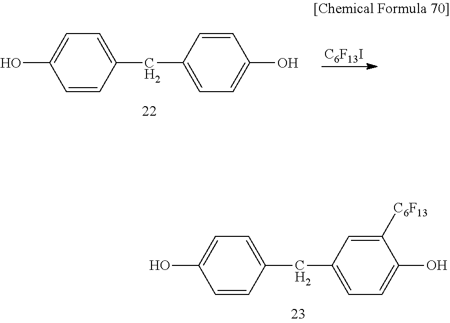

### Spectrum of Compound (23)

¹H NMR (400 MHz, CH₃CN) δ 7.73 (m, 1H), 7.24-7.23 (m, 2H), 7.01-6.99 (m, 1H), 6.92-6.90 (m, 2H), 6.71-6.70 (m, 1H), 3.87 (s, 1H), 3.81 (s, 1H), 2.05-2.04 (m, 2H) ¹⁹F NMR (376 MHz, CH₃CN) δ −79.4 (s, 3F), −106.3 (s, 2F), −119.8 (s, 2F), −120.2 (s, 2F), −124.5 (s, 2F)

### Example 13

In the air, 3 equivalents of perfluorohexyl iodide, 5 equivalents of an aqueous sodium thiosulfate solution (1 mL), and 3 equivalents of an aqueous cesium carbonate solution (1 mL) were added to a dichloromethane solution (5 mL) of polyetherimide (24) (the total amount of aromatic rings was 0.5 mmol) (Mₙ=1.2×10⁴, Mₙ/Mₙ=1.64), and light irradiation was performed with a 365 nm LED at room temperature for 24 hours. The obtained reaction mixture was reprecipitated, filtration was performed to obtain a solid, and the solid was dissolved in a solvent and filtered again. The obtained filtrate was concentrated, and then purified again by reprecipitation. As a result, a C₆F₁₃ group was introduced into 26 mol % of the whole benzene rings, and a desired polymer (25) (Mₙ=1.4×10⁴, M_{w}/Mₙ=2.90) having a fluorine content of 32 wt % was obtained in an isolation yield of 78%. However, in the following formula, units enclosed in parentheses with X, Y, and z appear in any order.

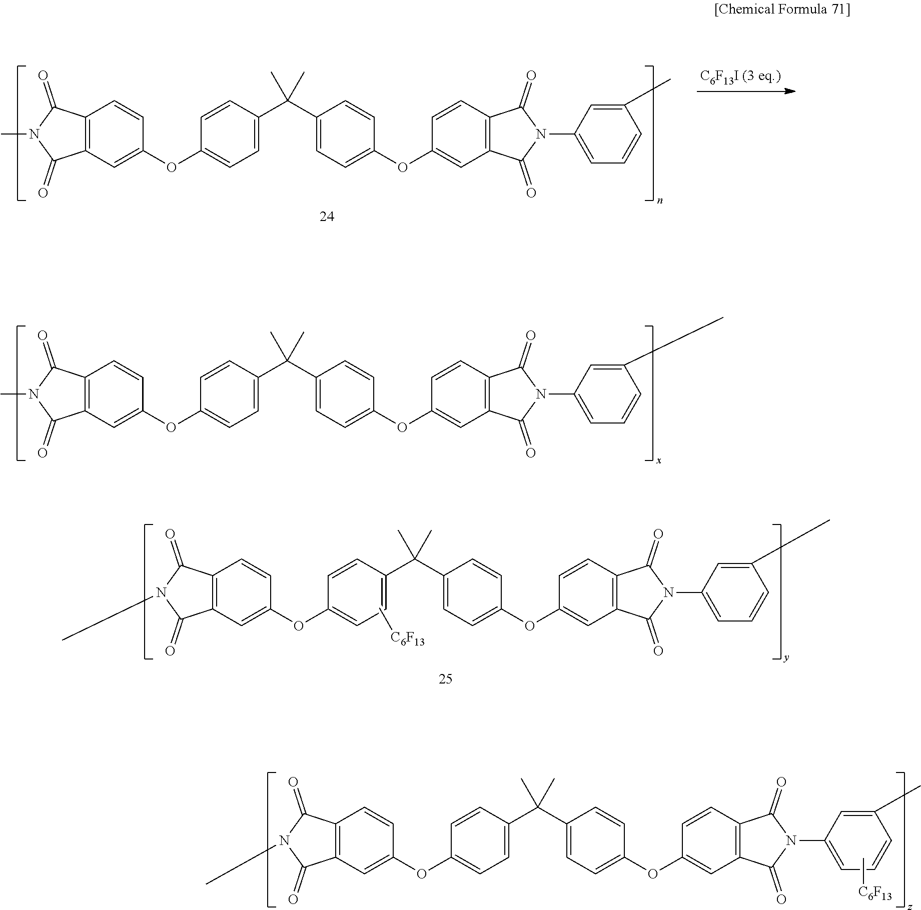

### Spectrum of Compound (26)

¹H NMR (400 MHz, CDCl₃): δ=8.24 (br), 7.91 (br), 7.64 (br), 7.51 (br), 7.43 (br), 7.34 (br), 7.07 (br), 1.75 (br)

¹⁹F NMR (471 MHz, CDCl₃): δ=−81.3 (3F, br), −108.6 (2F, br), −120.4 (2F, br), −121.1 (2F, br), −122.2 (2F, br), −123.2 (2F, br), −126.6 (2F, br)

### Example 14

In the air, 3 equivalents of perfluoropropyl iodide, 5 equivalents of an aqueous sodium thiosulfate solution (1 mL), and 3 equivalents of an aqueous cesium carbonate solution (1 mL) were added to a dichloromethane solution (5 mL) of polyetherimide (24) (the total amount of aromatic rings was 0.5 mmol) (Mₙ=1.2×10⁴, Mₙ/Mₙ=1.64), and light irradiation was performed with a 365 nm LED at room temperature for 24 hours. The obtained reaction mixture was reprecipitated, filtration was performed to obtain a solid, and the solid was dissolved in a solvent and filtered again. The obtained filtrate was concentrated, and then purified again by reprecipitation.

As a result, a C₃F₇ group was introduced into 18 mol % of the whole benzene rings, and a desired polymer (26) (Mₙ=1.7×10⁴, M_{w}/Mₙ=2.36) having a fluorine content of 16 wt % was obtained in an isolation yield of 70%. However, in the following formula, units enclosed in parentheses with X, Y, and z appear in any order. It was confirmed that the raw material polymer (24) was completely insoluble in acetone and acetonitrile, but the generated polymer (26) was partially soluble in acetone and acetonitrile, and thus the solvent solubility was improved by introduction of a perfluoropropyl group.

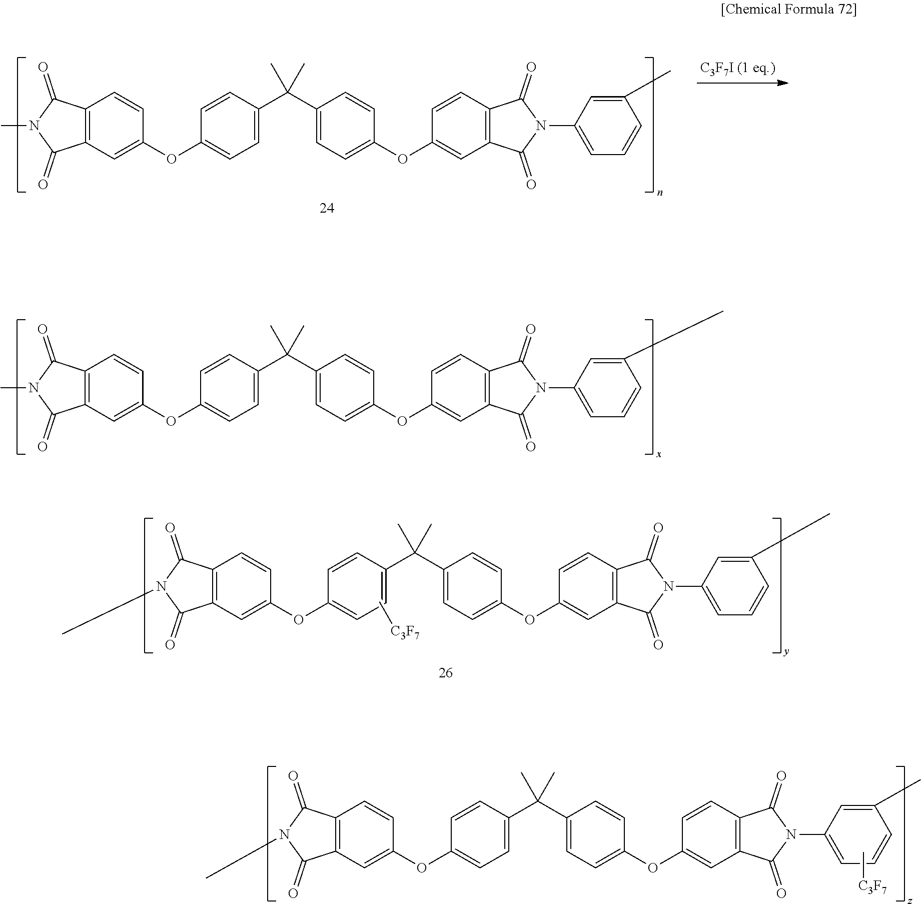

### Spectrum of Compound (26)

¹H NMR (400 MHz, CDCl₃): δ=8.20 (br), 7.87 (br), 7.64 (br), 7.63 (br), 7.50 (br), 7.42 (br), 7.26 (br), 7.02 (br), 1.75 (br)

¹⁹F NMR (471 MHz, CDCl₃): δ=−80.4 (3F, br), −80.6 (3F, br), −109.5 (2F, br), −124.6 (2F, br), −125.6 (2F, br), −126.3 (2F, br)

### Example 15

In the air, 1 equivalent of perfluoropropyl iodide, 5 equivalents of an aqueous sodium thiosulfate solution (1 mL), and 1.5 equivalents of an aqueous cesium carbonate solution (1 mL) were added to a dichloromethane solution (5 mL) of polycarbonate (27) (the total amount of aromatic rings was 0.5 mmol) (Mₙ=2.3×10⁴, Mₙ/Mₙ=3.26), and light irradiation was performed with a 365 nm LED at room temperature for 24 hours. The obtained reaction mixture was reprecipitated, filtration was performed to obtain a solid, and the solid was dissolved in a solvent and filtered again. The obtained filtrate was concentrated, and then purified again by reprecipitation.

As a result, it was confirmed that a C₃F₇ group was introduced into 6 mol % of the whole benzene rings and a desired polymer (28) (Mₙ=3.1×10⁴, M_{w}/Mⁿ=3.16) was obtained.

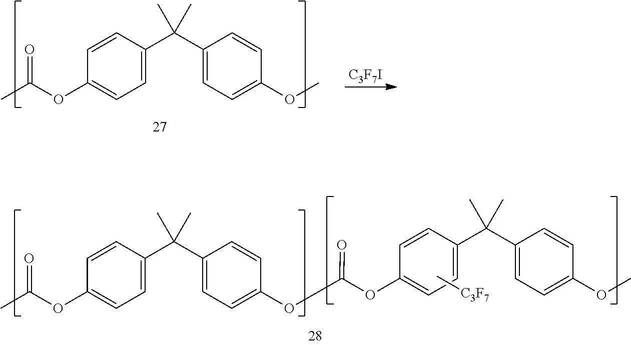

### Spectrum of Compound (28)

¹H NMR (400 MHz, CDCl₃): δ=7.26 (br), 7.18 (br), 1.70 (br)

¹⁹F NMR (471 MHz, CDCl₃): δ=−80.5 (3F, br), −110.0 (2F, br), −126.5 (2F, br)

### Example 16

In the air, 1 equivalent of perfluoropropyl iodide, 5 equivalents of an aqueous sodium thiosulfate solution (1 mL), and 1.5 equivalents of an aqueous cesium carbonate solution (1 mL) were added to a dichloromethane solution (5 mL) of polyethylene terephthalate (29) (the total amount of aromatic rings was 0.5 mmol) (Mₙ=2.0×10⁴, Mₙ/Mₙ=3.46), and light irradiation was performed with a 365 nm LED at room temperature for 16 hours. The obtained reaction mixture was reprecipitated, filtration was performed to obtain a solid, and the solid was dissolved in a solvent and filtered again. The obtained filtrate was concentrated, and then purified again by reprecipitation.

As a result, it was confirmed that a C₃F₇ group was introduced into 20 mol % of the whole benzene rings and a desired polymer (30) (Mₙ=1.8×10⁴, M_{w}/Mₙ=3.10) was obtained in an isolation yield of 72%.

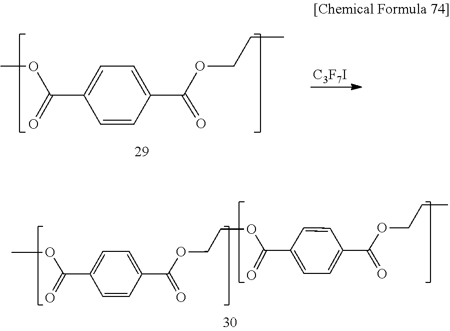

### Spectrum of Compound (30)

¹H NMR (400 MHz, CDCl₃): δ=8.28 (br), 8.10 (br), 4.69 (br), 1.93 (br), 1.67 (br), 1.18 (br)

¹⁹F NMR (471 MHz, CDCl₃): δ=−80.5 (3F, br), −106.4 (3F, br), −124.3 (2F, br)

### Example 17

Water (0.5 mL) and perfluorohexyl iodide (0.5 mL) were added to a petri dish to form two liquid layers. Subsequently, a polycarbonate sheet (manufactured by AS ONE CORPORATION: 63-508476, 2 cm square, thickness 1 mm) was floated between the two layers, and irradiated with a 365 nm LED from above to perform a surface reaction for 30 minutes. The film after completion of the photoreaction was taken out and washed with methanol. The water contact angle value of the film surface (the upper surface, which was closer to the LED light source) after washing was greatly improved from 440 to 102°. From this result, it was confirmed that a perfluorohexyl group was introduced and water repellency derived from the skeleton was imparted to the film surface.

### Example 18

To an acetonitrile (5 mL)/water (1 mL) mixed solution of 4,4′-dihydroxybiphenyl (12) (0.2 mmol), 6 equivalents of perfluoropropyl iodide, Phloxine B (20 mol %), ascorbic acid (4 equivalents), and cesium carbonate (2.5 equivalents) were added, and light irradiation was performed with a white LED for 24 hours under an argon atmosphere. As a result of NMR analysis, it was found that synthesis of a desired dihydroxy monomer (31) was achieved in a yield of 30% and synthesis of a desired dihydroxy monomer (32) was achieved in a yield of 3%.

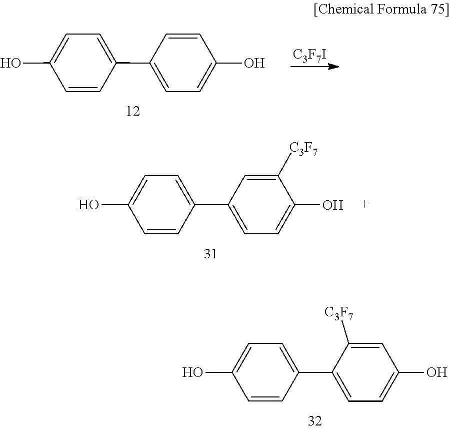

### Spectrum of Compound (31)

¹H NMR (400 MHz, CH₃CN) δ 7.27 (s, 1H), 7.43-7.42 (m, 1H), 7.20 (m, 1H), 7.05-7.04 (m, 2H), 7.03 (s, 1H), 6.88-6.86 (m, 1H), 4.61 (s, 1H), 4.54 (s, 1H)

¹⁹F NMR (376 MHz, CH₃CN) 6-79.0 (s, 3F), −107.2 (s, 2F), −124.2 (s, 2F)

### Spectrum of Compound (32)

¹⁹F NMR (376 MHz, CH₃CN) 6-79.0 (s, 3F), −106.4 (s, 2F), −120.4 (s, 2F)

### Example 19

To a dimethylacetamide solution (20 wt %) of the diamine monomer (2) (0.26 mmol), 1 equivalent of 4,4′-oxydiphthalimayhydride (3) was added, and the mixture was heated to 50° Mayd stirred for 50 hours, subsequently heated to 80° Mayd stirred for 14 hours, subsequently heated to 110° Mayd stirred for 24 hours, and subsequently heated to 140° Mayd stirred for 24 hours. As a result of purification by reprecipitation, a polyimide (33) having a number average molecular weight of 5.5×10³ and a molecular weight distribution of 1.7 was obtained in an isolation yield of 69%.

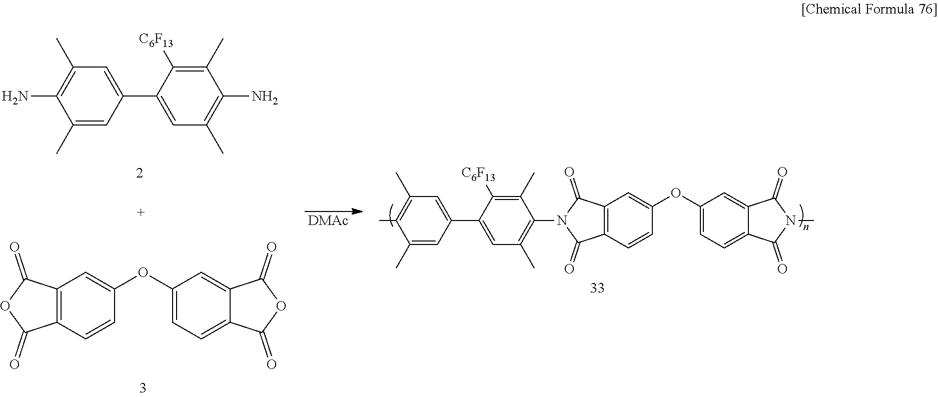

### Spectrum of Compound (33), Polyimide

¹H NMR (400 MHz, CDCl₃)

δ=8.09-7.57 (6H, m), 7.18 (1H, s), 7.08 (2H, s), 2.33 (3H, s), 2.20 (3H, s), 2.18 (6H, s).

¹⁹F NMR (376 MHz, CDCl₃)

δ=−81.1 (3F, s), −96.1 (2F, s), −117.9 (2F, s), −122.2 (2F, s), −123.0 (2F, s), −126.4 (2F, s).

### Example 20

To an acetonitrile (5 mL)/water (1 mL) mixed solution of 4-fluorophenol (34) (0.2 mmol), 6 equivalents of perfluorohexyl iodide, Phloxine B (20 mol %), ascorbic acid (4 equivalents), and cesium carbonate (2.5 equivalents) were added, and light irradiation was performed with a white LED for 24 hours under an argon atmosphere. As a result of NMR analysis, it was found that a desired AB monomer (35) was generated in a yield of 30% and a desired AB monomer (36) was generated in a yield of 8%.

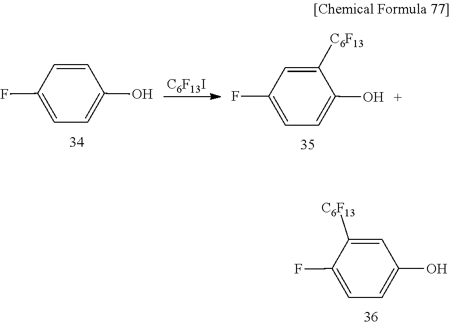

### Example 21

Under an argon atmosphere, 2 equivalents of heptafluoropropyl iodide, 10 mol % of Eosin Y-2Na, 4 equivalents of ascorbic acid, and 2.5 equivalents of cesium carbonate were added to a CH₃CN/H₂O (5 mL/1 mL) solution of 4,4′-oxydianiline (15, 0.3 mmol), and after freeze-degassing, light irradiation with a white LED and stirring were performed at room temperature for 24 hours. The obtained reaction mixture was purified by column chromatography, and as a result, a mono-substituted product (18) was obtained in an isolation yield of 32%, and a di-substituted product (19) was obtained in an isolation yield of 8%.

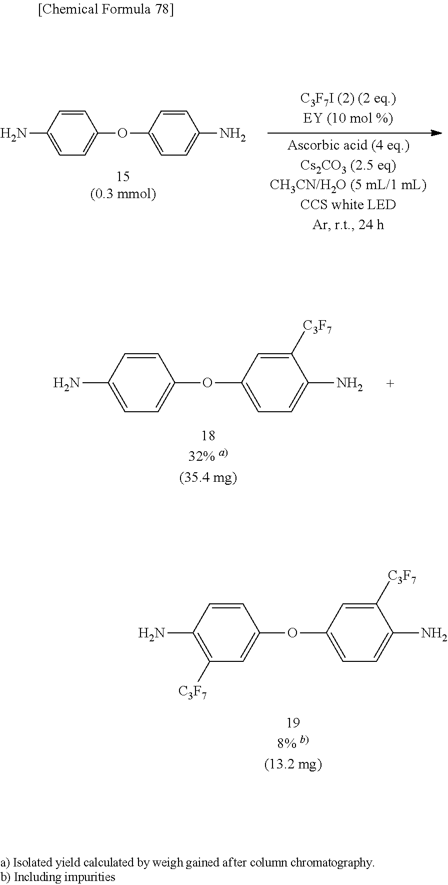

### Example 22

Under an argon atmosphere, 6 equivalents of perfluorohexyl iodide, 10 mol % of EY, 4 equivalents of ascorbic acid, and 1.5 equivalents of cesium carbonate were added to a CH₃CN/H₂O (5 mL/1 mL) mixed solution of 4,4′-oxydianiline (15) (0.2 mmol), and light irradiation with a white LED and stirring were performed for 24 hours. As a result of NMR analysis, it was confirmed that a mono-substituted product (37) was generated in a yield of 14% and a di-substituted product (38) was generated in a yield of 10%.

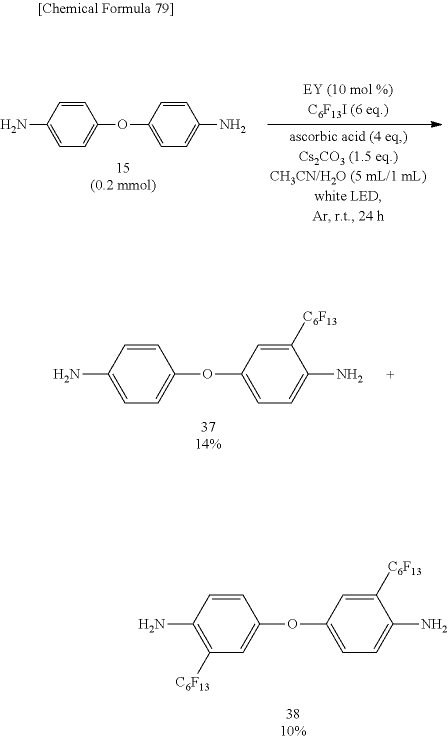

### Example 23

Under an argon atmosphere, 6 equivalents of perfluoropropyl iodide, 5 equivalents of Na₂S₂O₃, and 3 equivalents of cesium carbonate were added to a CH₂Cl₂/H₂O (5 mL/4 mL) mixed solution of a compound (39) (0.6 mmol), and light irradiation with a white LED and stirring were performed for 24 hours. As a result of NMR analysis, it was confirmed that a compound (40) was generated in a yield of 44%.

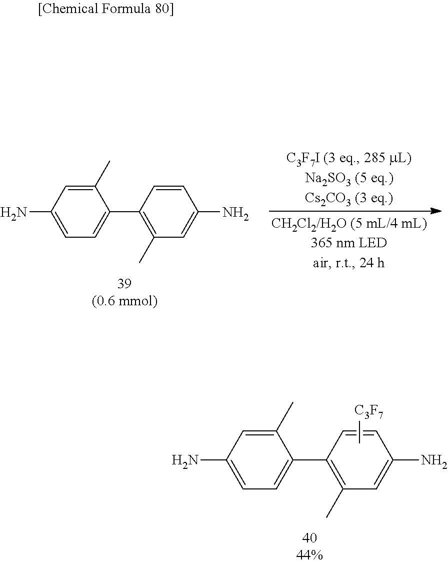

### Spectrum of Compound (40)

¹H NMR (400 MHz, CDCl₃)

δ 7.01 (s, 2H), 6.86 (s, 1H), 6.62 (s, 1H), 6.58 (s, 1H), 4.54 (s, 4H), 1.99 (s, 3H), 1.96 (s, 3H)

¹⁹F NMR (376 MHz, CDCl₃)

δ −80.61 (s, 3F), −102.25 (s, 2F), −126.95 (s, 2F)

### Example 24

Under an argon atmosphere, 6 equivalents of perfluoropropyl iodide, 5 equivalents of Na₂S₂O₃, and 3 equivalents of cesium carbonate were added to a CH₂Cl₂/H₂O (5 mL/4 mL) mixed solution of a compound (41) (0.6 mmol), and light irradiation with a white LED and stirring were performed for 24 hours. The reaction mixture was purified by recycling preparative size exclusion chromatography to obtain a compound (42) in an isolation yield of 12% and a compound (43) in an isolation yield of 5%.

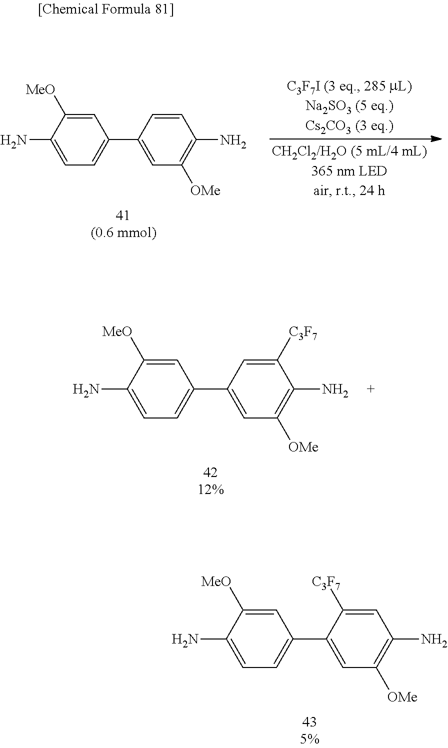

### Spectrum of Compound (42)

¹H NMR (400 MHz, CDCl₃)

δ 7.07 (s, 2H), 6.96 (dd, 1H, J=8.0, 1.6 Hz), 6.93 (d, 1H, J=1.8 Hz), 6.77 (d, 1H, J=8.2 Hz), 3.94 (s, 3H), 3.92 (s, 3H)

¹⁹F NMR (376 MHz, CDCl₃)

δ −80.58 (s, 3F), −109.71 (s, 2F), −126.80 (s, 2F)

### Example 25

Under an argon atmosphere, 6 equivalents of perfluoropropyl iodide, 5 equivalents of Na₂S₂O₃, and 3 equivalents of cesium carbonate were added to a CH₂Cl₂/H₂O (5 mL/4 mL) mixed solution of a compound (44) (0.6 mmol), and light irradiation with a white LED and stirring were performed for 24 hours. As a result of NMR analysis, it was confirmed that a compound (45) was generated in a yield of 7%.

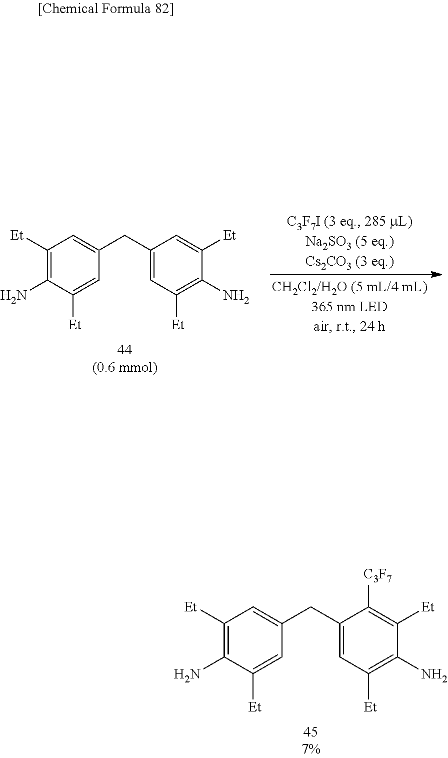

### Spectrum of Compound (45)

¹H NMR (400 MHz, CDCl₃)

δ 7.14 (s, 1H), 6.81 (s, 2H), 3.79 (s, 2H), 3.53 (s, 4H), 2.49 (s, 8H), 1.23 (s, 12H)

¹⁹F NMR (376 MHz, CDCl₃)

δ −80.46 (s, 3F), −110.54 (s, 2F), −126.803 (s, 2F)

### Example 26

Under an argon atmosphere, 0.3 mmmol of 1,4-diiodoperfluorobutane, 5.0 equivalents of Na₂S₂O₃, and 1.5 equivalents of cesium carbonate were added to a CH₂Cl₂/H₂O (3 mL/2 mL) mixed solution of a compound (46) (5 equivalents), and light irradiation with a white LED and stirring were performed for 24 hours. As a result of NMR analysis, it was confirmed that a compound (47) was generated in a yield of 20% and a compound (48) was generated in a yield of 9%.

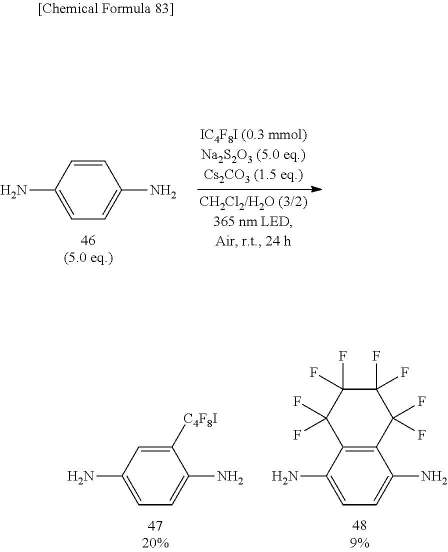

### Spectrum of Compound (47), Iodine-Containing Compound

¹H NMR (400 MHz, CDCl₃): δ=6.65 (s, 3H), δ=3.82 (4H, br)

¹⁹F NMR (376 MHz, CDCl₃): δ=−58.7 (2F, s), −109.0 (2F, s), −113.1 (2F, s), −121.2 (2F, s)

### Spectrum of Compound (48), Cyclized Compound

¹H NMR (400 MHz, CDCl₃): δ=6.72 (2H, d, J=2.3 Hz), 4.07 (4H, br)

¹⁹F NMR (376 MHz, CDCl₃): δ=−108.0 (2F, s), −110.2 (2F, s), −135.3 (2F, s), −136.1 (2F, s)

### Example 27

Under an argon atmosphere, 0.3 mmmol of 1,4-diiodoperfluorobutane, 5.0 equivalents of Na₂S₂O₃, and 1.5 equivalents of cesium carbonate were added to a CH₂Cl₂/H₂O (3 mL/2 mL) mixed solution of a compound (49) (5 equivalents), and light irradiation with a white LED and stirring were performed for 24 hours. As a result of purification by column chromatography, a compound (50) was obtained in an isolation yield of 20%, and a compound (51) was obtained in an isolation yield of 3%.

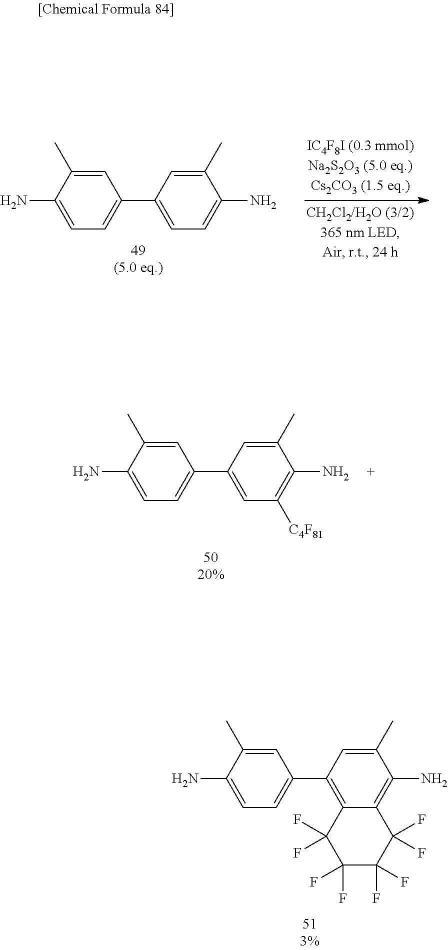

### Spectrum of Compound (50), Iodine-Containing Compound

¹H NMR (400 MHz, CDCl₃): δ=6.93 (4H, d, J=8.7 Hz), 6.58 (1H, d, J=7.8 Hz), 4.12 (4H, br), 2.21 (6H, s)

¹⁹F NMR (376 MHz, CDCl₃): δ=−58.6 (2F, s), −108.4 (2F, s), −113.1 (2F, s), −121.1 (2F, s)

### Spectrum of Compound (51), Cyclized Compound

¹H NMR (400 MHz, CDCl₃): δ=7.39 (3H, d, J=8.7 Hz), 6.65 (1H, d, J=7.8 Hz), 4.54 (4H, br), 2.16 (3H, s), 2.15 (3H, s)

¹⁹F NMR (376 MHz, CDCl₃): δ=−107.6 (2F, s), −108.4 (2F, s), −134.5 (2F, s), −136.3 (2F, s)

### Example 28

Under an argon atmosphere, 0.3 mmmol of 1,4-diiodoperfluorobutane, 5.0 equivalents of Na₂S₂O₃, and 1.5 equivalents of cesium carbonate were added to 5 equivalents of a CH₂Cl₂/H₂O (3 mL/2 mL) mixed solution of a compound (15), and light irradiation with a white LED and stirring were performed for 24 hours. As a result of purification by column chromatography, a compound (52) was obtained in an isolation yield of 22%.

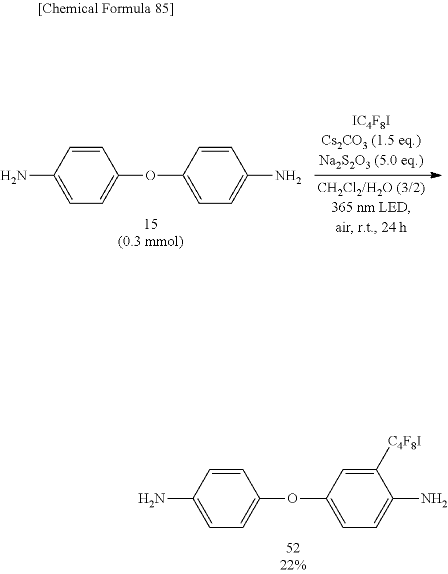

### Spectrum of Compound (52)

¹H NMR δ 6.71-6.73 (3H, m), 6.56-6.59 (4H, m), 5.25 (4H, s)

¹⁹F NMR δ −73.6 (2F, s), −114.1 (2F, s), −119.7 (2F, s), −126.9 (2F, s)

### Example 29

A polyimide was synthesized using mono-substituted 4,4′-oxydianiline (18). Under an argon atmosphere, 1 equivalent of 6FDA was added to a DMF (50 wt %) solution of mono-substituted 4,4′-oxydianiline (18, 0.5 mmol), and the mixture was stirred at 180 °C for 2.5 hours. Then, DMF was added to the reaction solution to dissolve the product, and reprecipitation was performed using water/methanol (50 mL/50 mL) as a poor solvent. The generated solid was collected by filtration, dried, and then subjected to NMR and GPC measurements (Scheme 8). As a result, a polyimide (53) having a number average molecular weight of 3900 and a molecular weight distribution of 2.83 was obtained in an isolation yield of 96%. The obtained polyimide 53 was soluble in tetrahydrofuran, DMF, and chloroform.

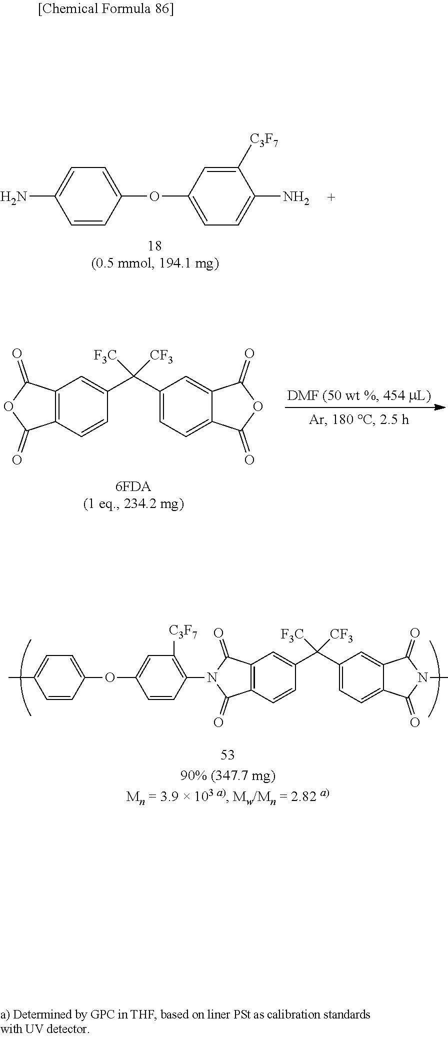

### Spectrum of Compound (53)

¹H NMR (400 MHz, CDCl₃)

δ=8.09-8.04 (2H, m), 8.00-7.90 (4H, m), 7.52-7.50 (2H, m), 7.34-7.32 (2H, m), 7.27-7.26 (3H, m)

¹⁹F NMR (376 MHz, CDCl₃)

δ=−63.71 (6F, s), −80.34 (3F, s), −109.74 (2F, s), −125.57 (2F, s)

### Example 30

In the air, 0.3 equivalents of 1,4-diiodoperfluorobutane, 5.0 equivalents of an aqueous sodium thiosulfate solution, and 1.5 equivalents of an aqueous cesium carbonate solution were added to a CH₂Cl₂/H₂O solution (5 mL/2 mL) of polycarbonate (27) (the total amount of aromatic rings was 0.5 mmol) (Mₙ=2.3×10⁴, Mₙ/Mₙ=3.26), and light irradiation was performed with a 365 nm LED at room temperature for 24 hours. The obtained reaction mixture was reprecipitated, filtration was performed to obtain a solid, and the solid was dissolved in a solvent and filtered again. The obtained filtrate was concentrated, and then purified again by reprecipitation.

As a result, a —C₄F₈— group was introduced into 4 mol % of the whole benzene rings, and a desired polymer (54) (Mₙ=1.5×10⁴, M_{w}/Mₙ=3.9) was obtained in an isolation yield of 80%.

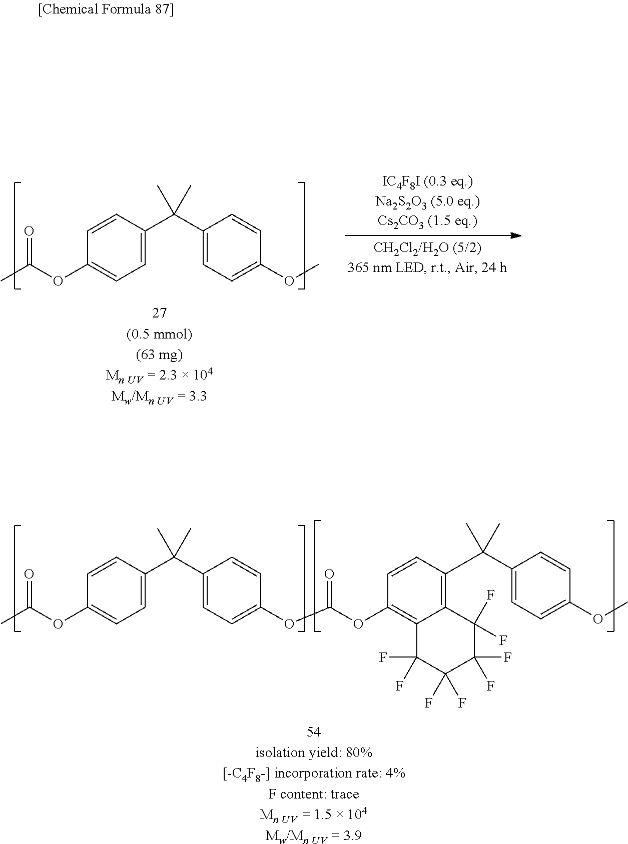

### Spectrum of Compound (54)

¹H NMR (400 MHz, CDCl₃)

δ 7.26-7.15 (m), 1.68 (s)

¹⁹F NMR (376 MHz, CDCl₃)

δ −103.07 (br), 134.73 (br)

### Example 31

Under an argon atmosphere, 6 equivalents of perfluoropropyl iodide (2), 10 mol % of Eosin Y, 4 equivalents of ascorbic acid, and 2.5 equivalents of cesium carbonate were added to a CH₃CN/H₂O (10 mL/2 mL) mixed solution of a diamine compound (55) (0.4 mmol), and light irradiation with a white LED and stirring were performed for 24 hours. The obtained reaction mixture was purified by column chromatography to obtain a mono-substituted product 56 in an isolation yield of 16%, a di-substituted product 57 in an isolation yield of 18%, and a tri-substituted product 58 in an isolation yield of 5%.

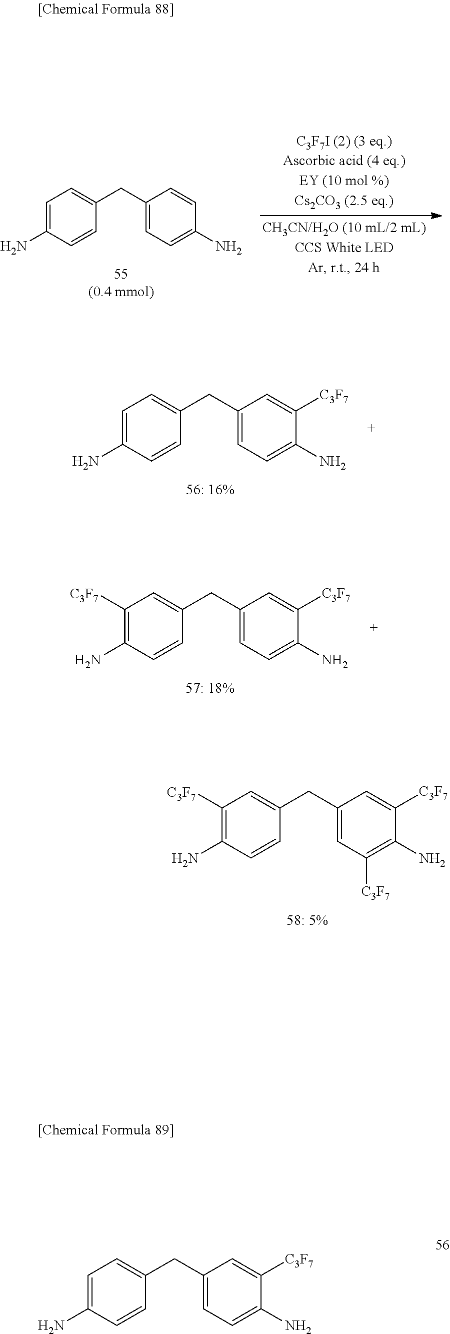

¹H NMR (400 MHz, CDCl₃)

δ 7.11 (s, 1H), 7.08 (d, 1H, J=8.24 Hz), 6.93 (d, 2H, J=8.7 Hz), 6.64-6.61 (m, 3H), 3.78 (s, 2H)

¹⁹F NMR (376 MHz, CDCl₃)

δ −80.61 (s, 3F), −109.87 (s, 2F), −126.86 (s, 2F)

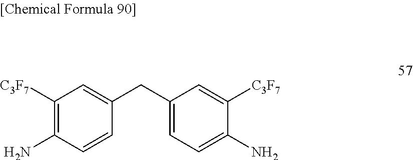

¹H NMR (400 MHz, CDCl₃)

δ 7.08 (s, 2H), 7.06 (d, 2H, J=8.2 Hz), 6.65 (d, 2H, 8.4 Hz), 4.13 (s, 4H), 3.79 (s, 2H)

¹⁹F NMR (376 MHz, CDCl₃)

δ −80.70 (s, 3F), −110.02 (s, 2F), −126.98 (s, 2F)

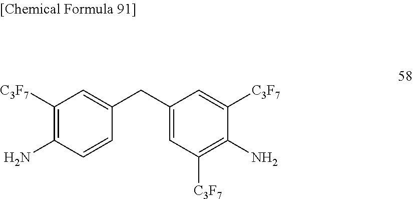

¹H NMR (400 MHz, CDCl₃)

δ 7.28 (s, 2H), 7.06-7.04 (m, 2H), 6.67 (d, 1H, J=8.7 Hz), 4.80 (s, 2H), 4.17 (s, 2H), 3.82 (s, 2H)

¹⁹F NMR (376 MHz, CDCl₃)

δ −80.73 (s, 6F), −80.80 (s, 3F), −109.13 (s, 4F), −110.17 (s, 2F), −126.61 (s, 4F), −127.14 (s, 2F)

### Example 32

Under an argon atmosphere, 3 equivalents of perfluoropropyl iodide, 3 equivalents of 1,8-diazabicyclo[5.4.0]7-undecene (DBU), and 1.5 equivalents of potassium phosphate were added to CH₃CN (3 mL) of a diamine compound (59) (0.2 mmol), and light irradiation with a white LED and stirring were performed for 24 hours. The obtained reaction mixture was purified by column chromatography to obtain a compound (60) in an isolation yield of 31%.

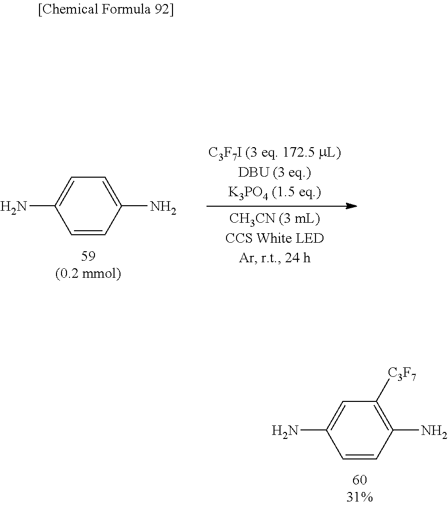

### Spectrum of Compound (60)

¹H NMR (400 MHz, CDCl₃)

δ 6.74 (dd, 1H, J=8.7, 2.8 Hz), 6.68 (d, 1H, J=2.3 Hz), 6.61 (d, 1H, J=8.7 Hz), 3.55 (s, 4H)

¹⁹F NMR (376 MHz, CDCl₃)

δ −80.64 (s, 3F), −109.90 (s, 2F), −126.74 (s, 2F)

### Example 33

Under an argon atmosphere, 4.5 equivalents of perfluorohexyl iodide, 10 mol % of Phloxine B, 2 equivalents of sodium ascorbate, and 1 equivalent of cesium carbonate were added to a CH₃CN/H₂O mixed solvent (7.5 mL/1.5 mL) of p-dihydroxybenzene (61) (0.2 mmol), and light irradiation with a white LED and stirring were performed for 24 hours. The obtained reaction mixture was purified by column chromatography to obtain a compound (62) in an isolation yield of 47%.

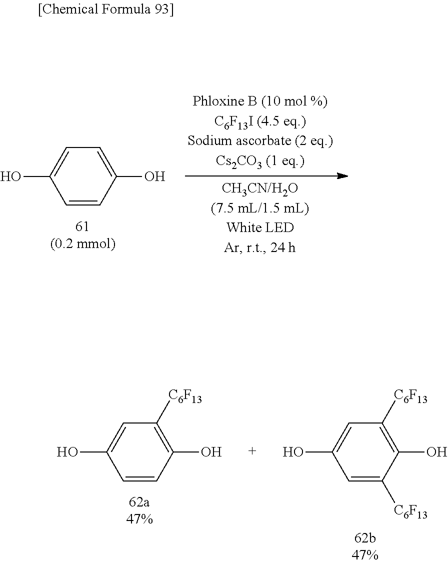

### Spectrum of Compound (62a)

1H NMR (400 MHz, CDCl3): δ=6.96 (dd, 1H, J=9.16), 6.88 (m, 2H), 5.34 (t, 1H), 4.87 (s, 1H)

19F NMR (376 MHz, CDCl3): δ=δ −81.2 (s, 3F), −109.0 (s, 2F), −122.3 (s, 4F), −123.2 (s, 2F), −126.2

### Spectrum of Compound (62b)

1H NMR (400 MHz, CDCl3): δ=δ 7.17 (s, 2H), 5.85 (t, 1H), 5.33 (s, 1H)

19F NMR (376 MHz, CDCl3): δ=δ −81.3 (s, 3F), −108.5 (s, 2F), −122.9 (s, 2F), −122.3 (s, 2F), −123.2 (s, 2F), −126.6 (s, 2F)

### Example 34

In the air, 1 equivalent of perfluoropropyl iodide, 3 equivalents of an aqueous sodium thiosulfate solution (1 mL), and 1.5 equivalents of an aqueous cesium carbonate solution (1 mL) were added to a dichloromethane solution (5 mL) of polysulfone (63) (the total amount of repeating units was 0.5 mmol) (Mₙ=1.9×10⁴, Mₙ/Mₙ=3.96), and light irradiation with a 365 nm LED and stirring were performed at room temperature for 24 hours. The obtained reaction mixture was reprecipitated, filtration was performed to obtain a solid, and the solid was dissolved in a solvent and filtered again. The obtained filtrate was concentrated, and then purified again by reprecipitation. As a result, a C₃F₇ group was introduced into 56 mol % of the whole repeating units, and a desired polymer (64) (Mₙ=2.7×10⁴, M_{w}/Mₙ=3.11) having a fluorine content of 15 wt % was obtained in an isolation yield of 99%.

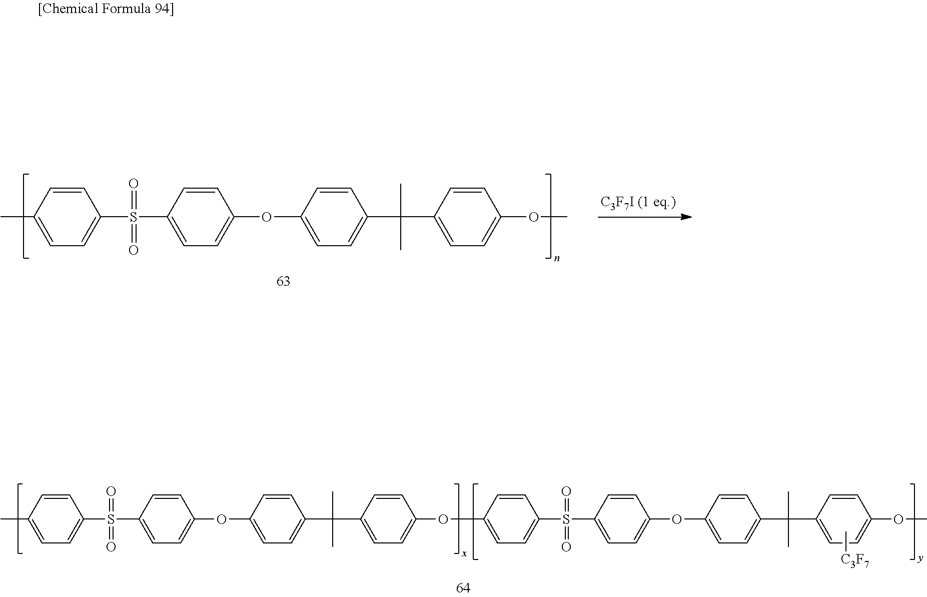

### Spectrum of Compound (64)

¹H NMR (400 MHz, CDCl₃): δ=8.16 (br), 7.90-6.93 (br), 1.75-1.67 (br).

¹⁹F NMR (471 MHz, CDCl₃): δ=−80.6-−80.9 (3F, br), −109.5-−109.7 (2F, br), −125.7-−126.4 (2F, br).

### Example 35

In the air, 5 equivalents of perfluorohexyl iodide, 3 equivalents of an aqueous sodium thiosulfate solution (1 mL), and 1.5 equivalents of an aqueous cesium carbonate solution (1 mL) were added to a dichloromethane solution (5 mL) of polysulfone (63) (the total amount of repeating units was 0.5 mmol) (Mₙ=1.9×10⁴, Mₙ/Mₙ=3.96), and light irradiation with a 365 nm LED and stirring were performed at room temperature for 24 hours. The obtained reaction mixture was reprecipitated, filtration was performed to obtain a solid, and the solid was dissolved in a solvent and filtered again. The obtained filtrate was concentrated, and then purified again by reprecipitation. As a result, a C₆F₁₃ group was introduced into 84 mol % of the whole repeating units, and a desired polymer (65) (Mₙ=2.3×10⁴, M_{w}/Mₙ=2.6) having a fluorine content of 31 wt % was obtained in an isolation yield of 87%. Subsequently, the water/oil repellency of the obtained polymer was evaluated, and as a result, the water contact angle was 101°, and the oil contact angle (using dodemaye as an oil) was 32°.

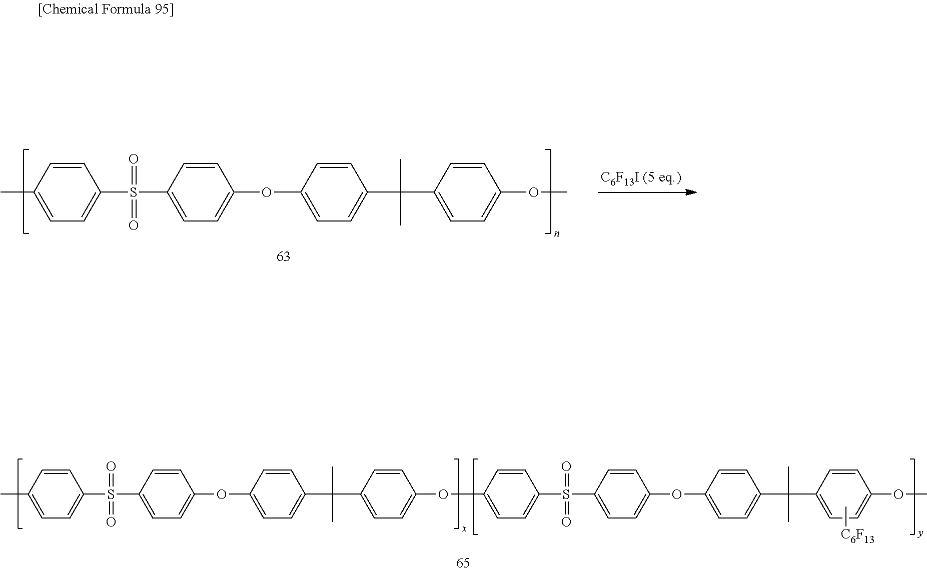

### Spectrum of Compound (65)

¹H NMR (400 MHz, CDCl₃): δ=8.19 (br), 7.93-7.85 (br), 7.29-7.22 (br), 7.04-6.94 (br), 1.72-1.70 (br).

¹⁹F NMR (471 MHz, CDCl₃): δ=−81.2 (3F, br), −108.6-−108.8 (2F, br), −121.3-−121.8 (2F, br), −122.2 (2F, br), −123.2 (2F, br), −126.6 (2F, br).

### Comparative Example 1

In the air, 20 equivalents of trifluoromethyl iodide, 3 equivalents of an aqueous sodium thiosulfate solution (1 mL), and 1.5 equivalents of an aqueous cesium carbonate solution (1 mL) were added to a dichloromethane solution (5 mL) of polysulfone (63) (the total amount of repeating units was 0.5 mmol) (Mₙ=1.9×10⁴, Mₙ/Mₙ=3.96), and light irradiation with a 365 nm LED and stirring were performed at room temperature for 24 hours. The obtained reaction mixture was reprecipitated, filtration was performed to obtain a solid, and the solid was dissolved in a solvent and filtered again. The obtained filtrate was concentrated, and then purified again by reprecipitation. As a result, a CF₃ group was introduced into 11 mol % of the whole repeating units, and a desired polymer (66) (Mₙ=1.7×10⁴, M_{w}/Mₙ=4.01) having a fluorine content of 2 wt % was obtained in an isolation yield of 62%. Subsequently, the water/oil repellency of the obtained polymer was evaluated, and as a result, the water contact angle was 91°, and the oil contact angle (using dodemaye as an oil) was 7°.

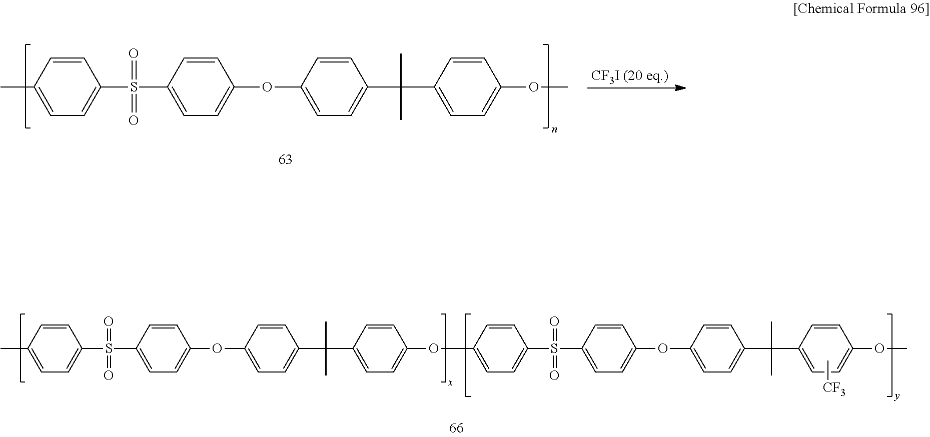

### Example 36

In the air, 1 equivalent of perfluoropropyl iodide, 3 equivalents of an aqueous sodium thiosulfate solution (1 mL), and 1.5 equivalents of an aqueous cesium carbonate solution (1 mL) were added to a dichloromethane solution (5 mL) of polyethersulfone (67) (the total amount of repeating units was 0.5 mmol) (Mₙ=5.6×10⁴, Mₙ/Mₙ=2.20), and light irradiation was performed with a 365 nm LED at room temperature for 24 hours. The obtained reaction mixture was reprecipitated, filtration was performed to obtain a solid, and the solid was dissolved in a solvent and filtered again. The obtained filtrate was concentrated, and then purified again by reprecipitation. As a result, a C₃F₇ group was introduced into 15 mol % of the whole repeating units, and a desired polymer (68) (Mₙ=5.8×10⁴, M_{w}/Mₙ=1.58) having a fluorine content of 8 wt % was obtained in an isolation yield of 77%.

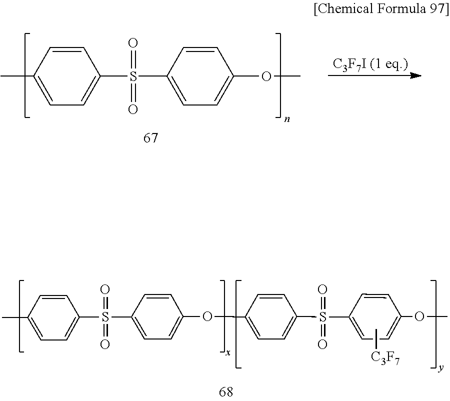

### Spectrum of Compound (68)

¹H NMR (400 MHz, CDCl₃): δ=8.08-7.97 (br), 7.38-7.25 (br).

¹⁹F NMR (471 MHz, CDCl₃): δ=−79.3 (3F, br), −108.0 (2F, br), −124.7 (2F, br).

### Example 37

In the air, 0.5 equivalents of perfluoropropyl iodide, 1.5 equivalents of an aqueous sodium thiosulfate solution (1 mL), and 0.75 equivalents of an aqueous cesium carbonate solution (1 mL) were added to a dichloromethane solution (5 mL) of an epoxy resin (69) (the total amount of repeating units was 1.0 mmol) (Mₙ=3.6×10², Mₙ/Mₙ=8.67), and light irradiation was performed with a 365 nm LED at room temperature for 24 hours. The obtained reaction mixture was reprecipitated, filtration was performed to obtain a solid, and the solid was dissolved in a solvent and filtered again. The obtained filtrate was concentrated, and then purified by reprecipitation. As a result, a C₃F₇ group was introduced into 7 mol % of the whole repeating units, and a desired polymer (70) (Mₙ=7.5×10³, Mₙ/Mₙ=3.89) having a fluorine content of 5 wt % was obtained in an isolation yield of 10%.

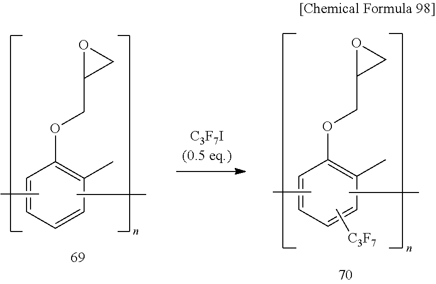

### Spectrum of Compound (70)

¹H NMR (400 MHz, CDCl₃): δ=7.04-6.75 (br), 4.17-1.63 (br)

¹⁹F NMR (471 MHz, CDCl₃): δ=−80.5 (3F, br), −80.8 (3F, br), −98.6 (2F, br), −124.3 (2F, br).

### Example 38

In the air, 1 equivalent of perfluoropropyl iodide, 3 equivalents of an aqueous sodium thiosulfate solution (1 mL), and 1.5 equivalents of an aqueous cesium carbonate solution (1 mL) were added to a dichloromethane solution (5 mL) of an epoxy resin (71) (the total amount of repeating units was 1.0 mmol) (Mₙ=5.7×10², Mₙ/Mₙ=12.7), and light irradiation was performed with a 365 nm LED at room temperature for 24 hours. The obtained reaction mixture was reprecipitated, filtration was performed to obtain a solid, and the solid was dissolved in a solution and filtered again. The obtained filtrate was concentrated, and then purified again by reprecipitation. As a result, a C₃F₇ group was introduced into 198 mol % of the whole repeating units, and a desired polymer (72) (Mₙ=3.1×10², M_{w}/Mₙ=147) having a fluorine content of 62 wt % was obtained in an isolation yield of 50%.

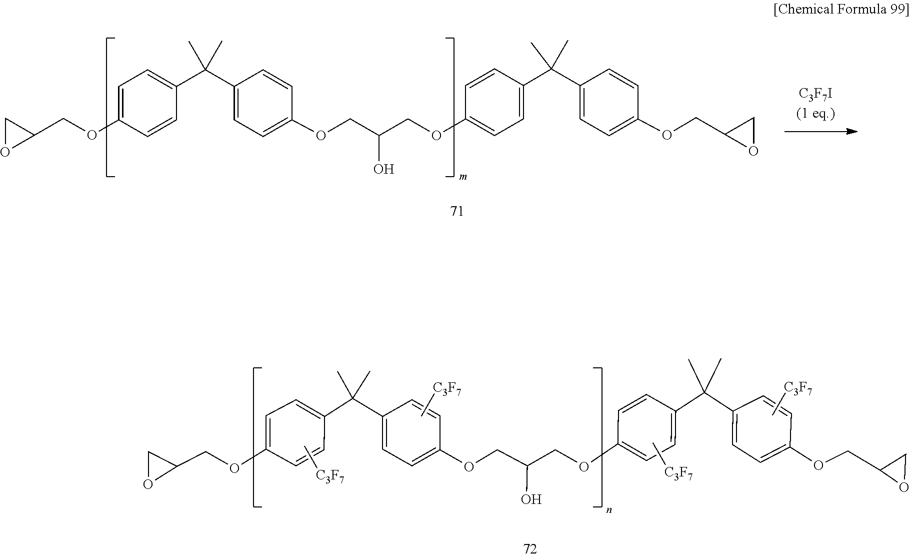

### Spectrum of Compound (72)

¹H NMR (400 MHz, CDCl₃): δ=7.99 (br), 7.37-6.69 (br), 4.64 (br), 4.34 (br), 4.16 (br), 4.12 (br), 3.95 (br), 3.45 (br), 3.40 (br), 3.32 (br), 3.24 (br) 2.97 (br), 2.91 (br), 2.85 (br), 2.74 (br), 2.66 (br), 2.57 (br), 2.33-2.06 (br), 1.63 (br), 1.47 (br).

¹⁹F NMR (471 MHz, CDCl₃): δ=−80.8 (3F, br), −83.3 (3F, br), −109.0 (2F, br), −121.0 (2F, br), −126.4 (2F, br).

### Example 39

Under an argon atmosphere, in an acetonitrile/water (7.5 mL/1.5 mL) mixed solvent of an epoxy monomer (73), 4.5 equivalents of perfluorohexyl iodide, 10 mol % of Phloxine B, 2 equivalents of sodium ascorbate, and 1 equivalent of cesium carbonate were added to a dichloromethane solution (5 mL), and light irradiation was performed with a white LED at room temperature for 24 hours. The obtained reaction mixture was purified by column chromatography to obtain a desired compound (74) in an isolation yield of 25%.

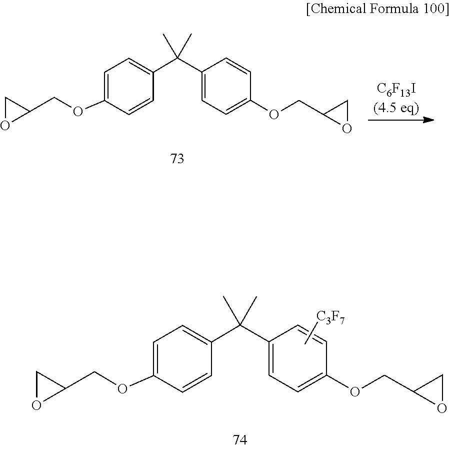

### Spectrum of Compound (74)

¹H NMR (400 MHz, CDCl₃): δ=7.38 (s, 1H), 7.29 (dd, 1H, J=8.47, 2.52), 7.12-7.07 (m, 2H), 6.91 (d, 1H, J=8.70), 6.84-6.81 (m, 2H), 4.20 (tt, 1H), 4.09-4.04 (m, 1H), 3.98-3.93 (m, 2H), 3.36-3.30 (m, 2H), 2.91-2.88 (m, 2H), 2.78-2.74 (m, 2H)

¹⁹F NMR (471 MHz, CDCl₃): δ=δ −81.3 (s, 3F), −108.2 (s, 2F), −121.7 (s, 2F), −122.3 (s, 2F), −123.2 (s, 2F), −126.6 (s, 2F)

### Example 40

In the air, 1 equivalent of perfluoropropyl iodide, 3 equivalents of an aqueous sodium thiosulfate solution (1 mL), and 1.5 equivalents of an aqueous cesium carbonate solution (1 mL) were added to a dichloromethane solution (5 mL) of polyphenylene ether (75) (the total amount of repeating units was 0.5 mmol), and light irradiation was performed with a 365 nm LED at room temperature for 24 hours. The obtained reaction mixture was reprecipitated, filtration was performed to obtain a solid, and the solid was dissolved in a solvent and filtered again. The obtained filtrate was concentrated, and then purified again by reprecipitation. As a result, a C₃F₇ group was introduced into 8 mol % of the whole repeating units, and a desired polymer (76) (Mₙ=2.4×10⁴, M_{w}/Mₙ=2.93) having a fluorine content of 8 wt % was obtained in an isolation yield of 60%. It was confirmed that the raw material polymer (71) was slightly soluble in tetrahydrofuran, but the generated polymer (76) was easily soluble in tetrahydrofuran, and thus the solvent solubility was improved by introduction of a perfluoropropyl group.

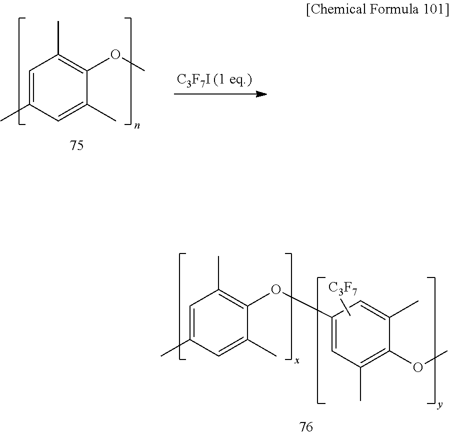

### Spectrum of Compound (76)

¹H NMR (400 MHz, CDCl₃): δ=6.49 (br), 2.13 (br), 0.88-0.79 (br).

¹⁹F NMR (471 MHz, CDCl₃): δ=−80.6-−81.7 (3F, br), −102.2-−102.6 (2F, br), −113.3 (2F, br), −125.0-−125.2 (2F, br), −128.0 (2F, br).

### Example 41

In the air, 1 equivalent of perfluoropropyl iodide, 3 equivalents of an aqueous sodium thiosulfate solution (1 mL), and 1.5 equivalents of an aqueous cesium carbonate solution (1 mL) were added to a dichloromethane solution (5 mL) of a polymer having a phenol skeleton (77) (the total amount of aromatic rings was 0.5 mmol) (Mₙ=1.4×10², Mₙ/Mₙ=37.4), and light irradiation was performed with a 365 nm LED at room temperature for 24 hours. The obtained reaction mixture was reprecipitated, filtration was performed to obtain a solid, and the solid was dissolved in a solvent and filtered again. The obtained filtrate was concentrated, and then purified again by reprecipitation. As a result, a C₃F₇ group was introduced into 26 mol % of the whole repeating units, and a desired polymer (78) (Mₙ=2.4×10², M_{w}/Mₙ=10.9) having a fluorine content of 10 wt % was obtained in an isolation yield of 99%.

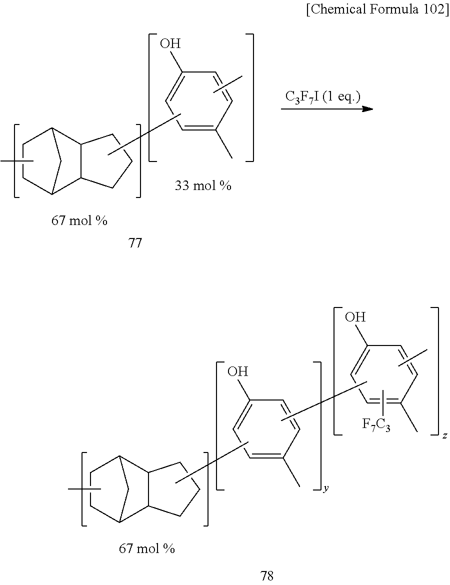

### Spectrum of Compound (78)

¹H NMR (400 MHz, CDCl₃): δ=6.99 (br), 6.92 (br), 6.88 (br), 4.85 (br), 4.69 (br), 3.40 (br), 2.95 (br), 2.90 (br), 2.77 (br), 2.66 (br), 2.31 (br), 2.20 (br), 1.82 (br), 1.79 (br), 1.61 (br), 1.44 (br), 1.28 (br), 0.76 (br).

¹⁹F NMR (471 MHz, CDCl₃): δ=−75.8 (3F, br), −80.9 (3F, br), −107.5 (2F, br), −108.9 (2F, br), −111.0 (2F, br), −115.0 (2F, br), −118.7 (2F, br), −121.2 (2F, br), −124.6 (2F, br), −125.9 (2F, br), −127.7 (2F, br).

### Example 42

In the air, 5 equivalents of perfluoropropyl iodide, 3 equivalents of an aqueous sodium thiosulfate solution (1 mL), and 1.5 equivalents of an aqueous cesium carbonate solution (1 mL) were added to a DMF/dichloromethane/water (3 mL/2 mL/2 mL) mixed solution of a polyamideimide (79) (the total amount of repeating units was 0.2 mmol) (Mₙ=3.6×10⁴, Mₙ/Mₙ=1.46), and light irradiation was performed with a 365 nm LED at room temperature for 72 hours. The obtained reaction mixture was reprecipitated, filtration was performed to obtain a solid, and the solid was filtered again. The obtained filtrate was concentrated, and then purified again by reprecipitation. As a result, a C₃F₇ group was introduced into 13 mol % of the whole repeating units, and a desired polymer (80) (Mₙ=3.1×10⁴, M_{w}/Mₙ=1.59) having a fluorine content of 5 wt % was obtained in an isolation yield of 43%.

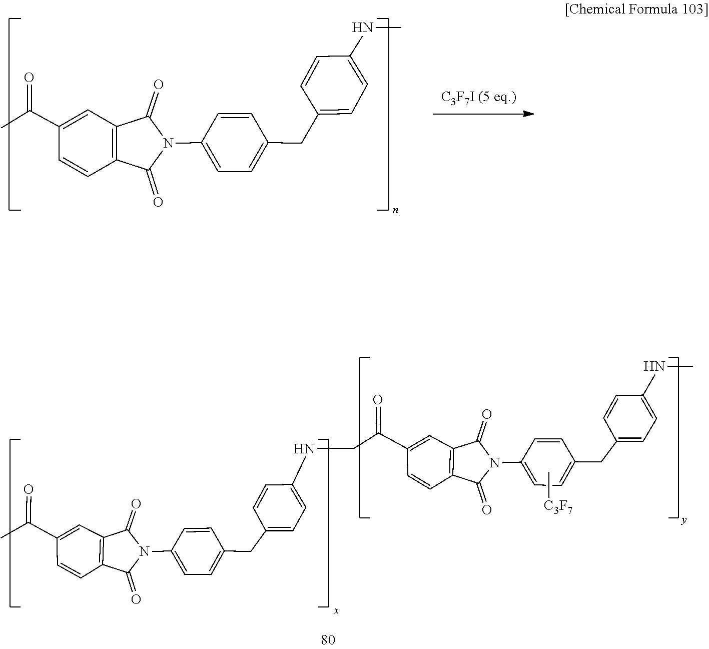

### Spectrum of Compound (80)

¹H NMR (400 MHz, CDCl₃): δ=10.59-10.58 (br), 10.44-10.39 (br), 8.51 (br), 8.44-8.42 (br), 8.10-8.08 (br), 7.77-7.58 (br), 7.45-7.39 (br), 7.30-7.23 (br), 4.09-3.91 (br),

¹⁹F NMR (471 MHz, CDCl₃): δ=−79.1-−81.72 (3F, br), −106.0 (2F, br), −110.9 (2F, br), −123.6-−125.1 (2F, br).

### Example 43

In the air, 1 equivalent of perfluoroisopropyl iodide, 3 equivalents of an aqueous sodium thiosulfate solution (1 mL), and 1.5 equivalents of an aqueous cesium carbonate solution (1 mL) were added to a dichloromethane solution (5 mL) of polyetherimide (24) (the total amount of repeating units was 0.5 mmol) (Mₙ=1.2×10⁴, Mₙ/Mₙ=1.64), and light irradiation with a 365 nm LED and stirring were performed at room temperature for 24 hours. The obtained reaction mixture was reprecipitated, filtration was performed to obtain a solid, and the solid was dissolved in a solvent and filtered again. The obtained filtrate was concentrated, and then purified again by reprecipitation. As a result, an ⁱC₃F₇ group was introduced into 1 mol % of the whole repeating units, and a desired polymer (81) (Mₙ=1.8×10⁴, M_{w}/Mₙ=2.17) having a fluorine content of 0.3 wt % was obtained in an isolation yield of 90%. However, in the following formula, units enclosed in parentheses with X, Y, and z appear in any order. A polymer (82) was easily soluble in tetrahydrofuran and chloroform.

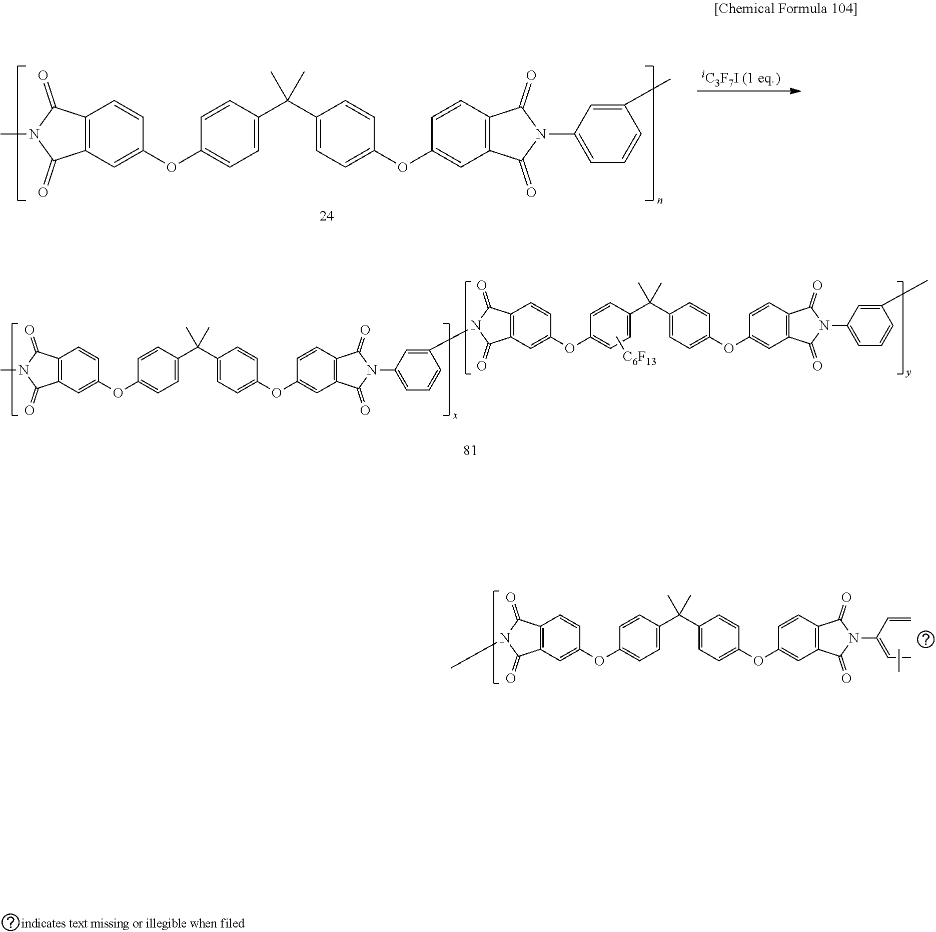

### Spectrum of Compound (81)

¹H NMR (400 MHz, CDCl₃): δ=7.89-7.00 (br), 3.81 (br), 1.90-1.72 (br).

¹⁹F NMR (471 MHz, CDCl₃): δ=−74.1-−74.9 (6F, br).

### Example 44

In the air, 1 equivalent of 1-bromo-2-iodotetrafluoroethane, 3 equivalents of an aqueous sodium thiosulfate solution (1 mL), and 1.5 equivalents of an aqueous cesium carbonate solution (1 mL) were added to a dichloromethane solution (5 mL) of polyetherimide (24) (the total amount of repeating units was 0.5 mmol) (Mₙ=1.2×10⁴, Mₙ/Mₙ=1.64), and light irradiation was performed with a 365 nm LED at room temperature for 24 hours. The obtained reaction mixture was reprecipitated, filtration was performed to obtain a solid, and the solid was dissolved in a solvent and filtered again. The obtained filtrate was concentrated, and then purified again by reprecipitation. As a result, a BrC₂F₄ group was introduced into 3 mol % of the whole repeating units, and a desired polymer (82) (Mₙ=1.9×10⁴, M_{w}/Mₙ=2.11) having a fluorine content of 0.4 wt % was obtained in an isolation yield of 81%. However, in the following formula, units enclosed in parentheses with X, Y, and z appear in any order. The polymer (82) was easily soluble in tetrahydrofuran and chloroform.

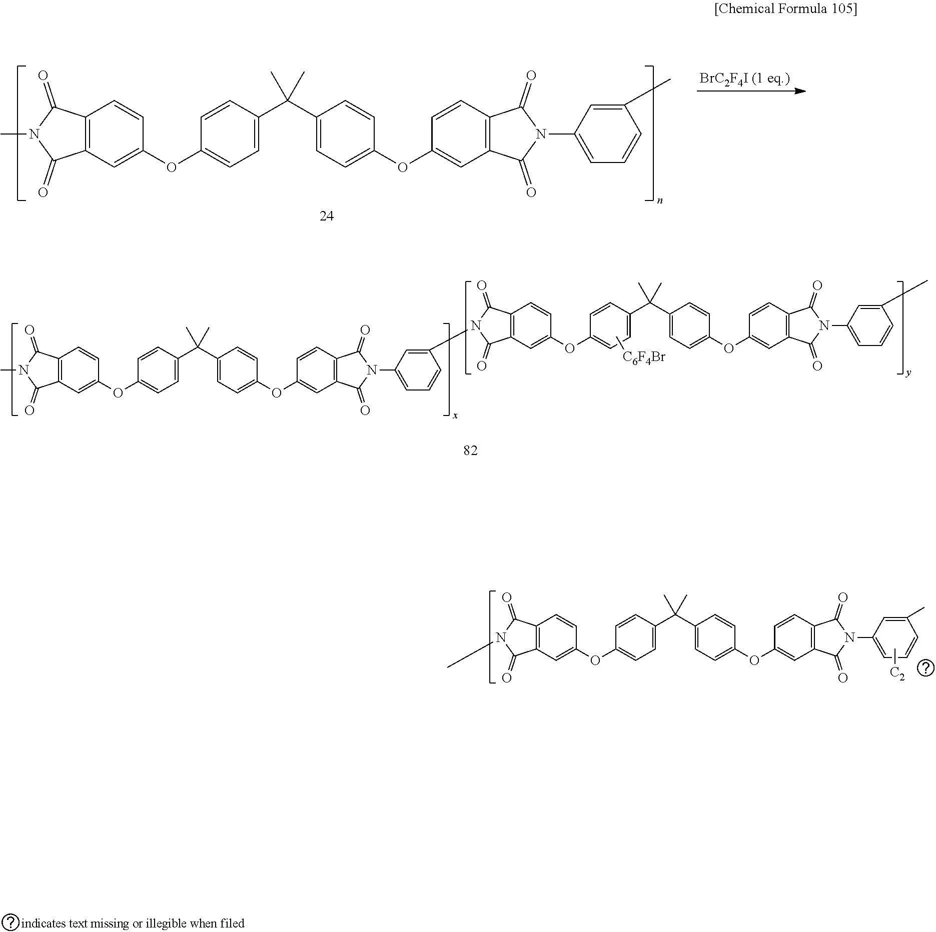

### Spectrum of Compound (82)

¹H NMR (400 MHz, CDCl₃): δ=7.89-7.02 (br), 3.82 (br), 1.75-1.73 (br).

¹⁹F NMR (471 MHz, CDCl₃): δ=−64.3-−64.6 (2F, br), −105.1-−105.6 (2F, br).

### Example 45

In the air, 1 equivalent of ethyl iododifluoroacetate, 3 equivalents of an aqueous sodium thiosulfate solution (1 mL), and 1.5 equivalents of an aqueous cesium carbonate solution (1 mL) were added to a dichloromethane solution (5 mL) of polyetherimide (24) (the total amount of repeating units was 0.5 mmol) (Mₙ=1.2×10⁴, Mₙ/Mₙ=1.64), and light irradiation was performed with a 365 nm LED at room temperature for 24 hours. The obtained reaction mixture was reprecipitated, filtration was performed to obtain a solid, and the solid was dissolved in a solvent and filtered again. The obtained filtrate was concentrated, and then purified again by reprecipitation. As a result, an EtOC(O)CF₂ group was introduced into 3 mol % of the whole repeating units, and a desired polymer (83) (Mₙ=2.0×10⁴, M_{w}/Mₙ=2.10) having a fluorine content of 0.2 wt % was obtained in an isolation yield of 92%. However, in the following formula, units enclosed in parentheses with X, Y, and z appear in any order. The polymer (83) was easily soluble in tetrahydrofuran and chloroform.

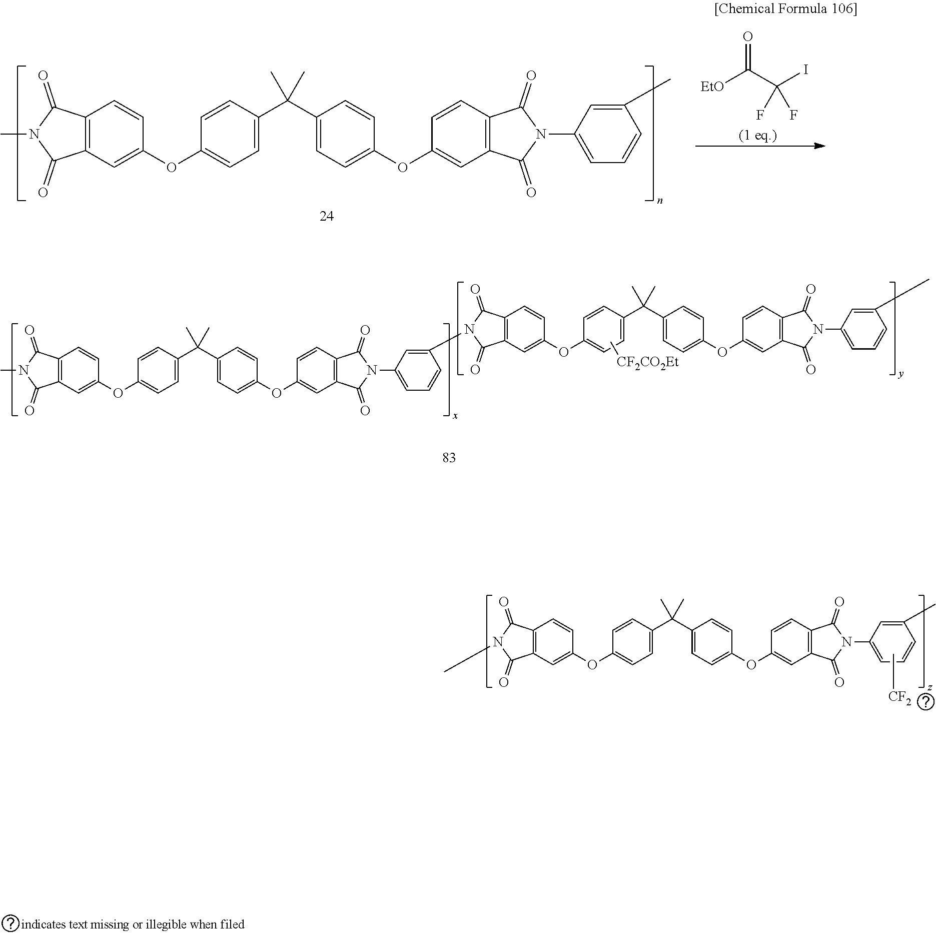

### Spectrum of Compound (83)

¹H NMR (400 MHz, CDCl₃): δ=7.89-7.00 (br), 4.33-4.19 (br), 3.82 (br), 1.75-1.73 (br), 1.28-1.25 (br).

¹⁹F NMR (471 MHz, CDCl₃): δ=−55.9 (2F, br), −96.1 (2F, br), −101.9 (2F, br), −103.4 (2F, br).

### Example 46

In the air, 1 equivalent of an iodine compound, 3 equivalents of an aqueous sodium thiosulfate solution (1 mL), and 1.5 equivalents of an aqueous cesium carbonate solution (1 mL) were added to a dichloromethane solution (5 mL) of polyetherimide (24) (the total amount of repeating units was 0.5 mmol) (Mₙ=1.2×10⁴, Mₙ/Mₙ=1.64), and light irradiation was performed with a 365 nm LED at room temperature for 24 hours. The obtained reaction mixture was reprecipitated, filtration was performed to obtain a solid, and the solid was dissolved in a solvent and filtered again. The obtained filtrate was concentrated, and then purified again by reprecipitation. As a result, a perfluoropolyether skeleton derived from the raw material was introduced into 1 mol % of the whole repeating units, and a desired polymer (84) (Mₙ=1.7×10⁴, M_{w}/Mₙ=2.09) having a fluorine content of 0.5 wt % was obtained in an isolation yield of 88%. However, in the following formula, units enclosed in parentheses with X, Y, and z appear in any order. The polymer (84) was easily soluble in tetrahydrofuran and chloroform.

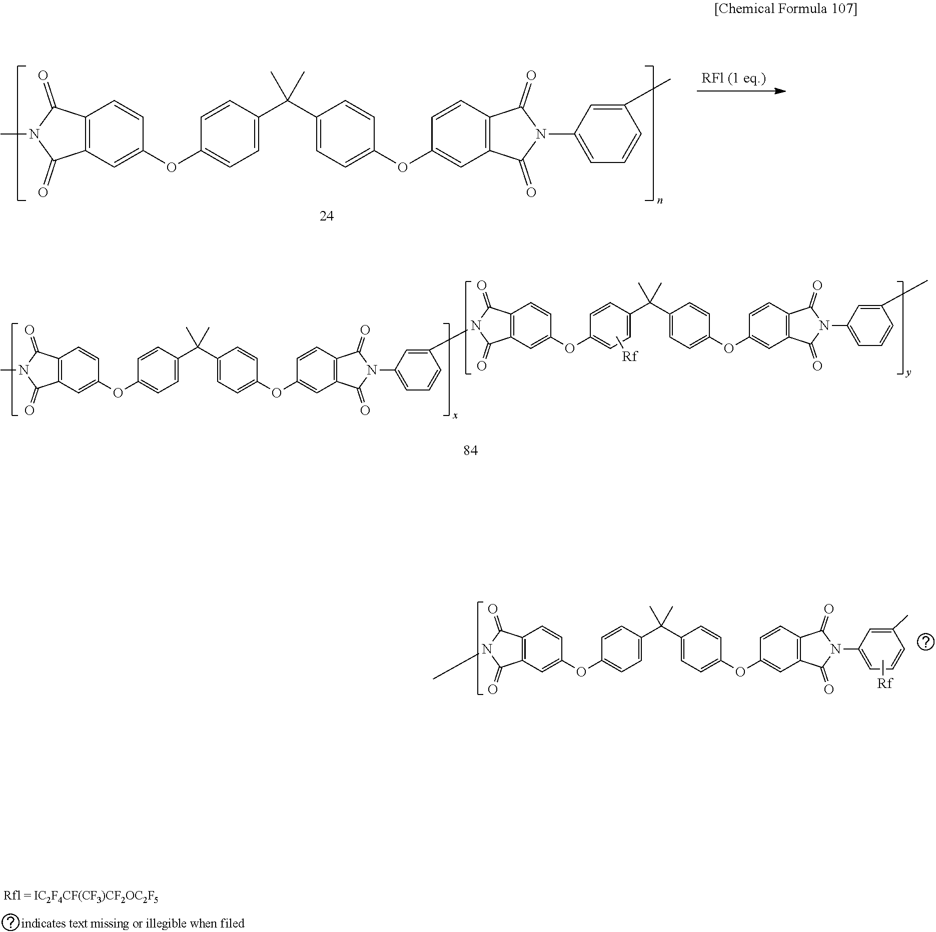

### Spectrum of Compound (84)

¹H NMR (400 MHz, CDCl₃): δ=7.89-7.02 (br), 3.83 (br), 1.75-1.73 (br).

¹⁹F NMR (471 MHz, CDCl₃): δ=−80.4 (3F, br), −83.5 (4F, br), −87.1 (3F, br), −89.0 (2F, br).

### Example 47

In the air, 0.5 equivalents of an iodine compound, 3 equivalents of an aqueous sodium thiosulfate solution (1 mL), and 1.5 equivalents of an aqueous cesium carbonate solution (1 mL) were added to a dichloromethane solution (5 mL) of polyetherimide (24) (the total amount of repeating units was 0.5 mmol) (Mₙ=1.2×¹⁰⁴, Mₙ/Mₙ=1.64), and light irradiation was performed with a 365 nm LED at room temperature for 24 hours. The obtained reaction mixture was reprecipitated, filtration was performed to obtain a solid, and the solid was dissolved in a solvent and filtered again. The obtained filtrate was concentrated, and then purified again by reprecipitation. As a result, a fluorine-containing aniline skeleton derived from the raw material was introduced into 3 mol % of the whole repeating units, and a desired polymer (85) (Mₙ=9.8×10³, M_{w}/Mₙ=3.92) having a fluorine content of 1 wt % was obtained in an isolation yield of 10%. However, in the following formula, units enclosed in parentheses with X, Y, and z appear in any order. The polymer (85) was easily soluble in tetrahydrofuran and chloroform.

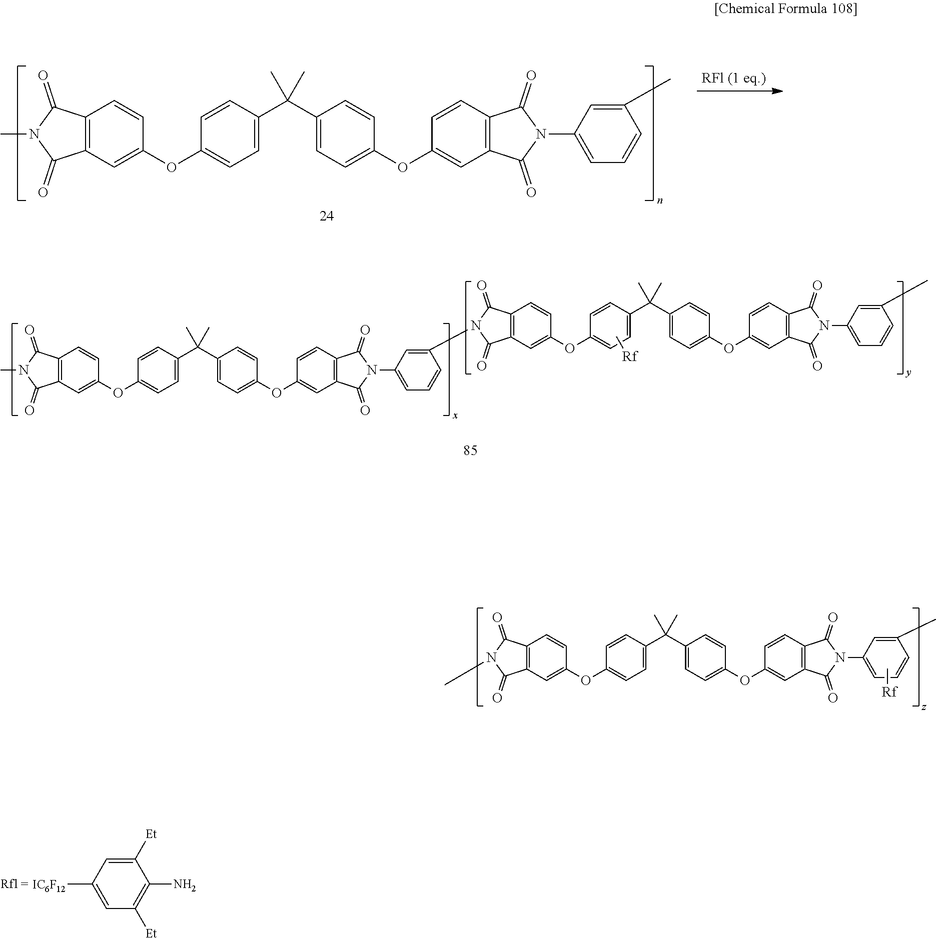

### Spectrum of Compound (85)

¹H NMR (400 MHz, CDCl₃): δ=7.90-7.01 (br), 7.42-7.32 (br), 6.47 (s), 2.09 (s), 1.75 (br), 1.25 (br)

¹⁹F NMR (471 MHz, CDCl₃): δ=−108.5 (2F, br), −111.1 (2F, br), −121.8 (4F, br), −122.2 (4F, br)

### Comparative Example 2

A polyimide was synthesized using 4,4′-oxydianiline 15 having no perfluoroalkyl group on an aromatic ring. Under an argon atmosphere, 1 equivalent of 6FDA was added to a DMF (50 wt %) solution of 4,4′-oxydianiline (15, 0.5 mmol), and the mixture was stirred at 180 °C for 2.5 hours. After completion of the reaction, the resulting polyimide 86 was slightly soluble in DMF and precipitated. The polyimide 86 was also slightly soluble in tetrahydrofuran.

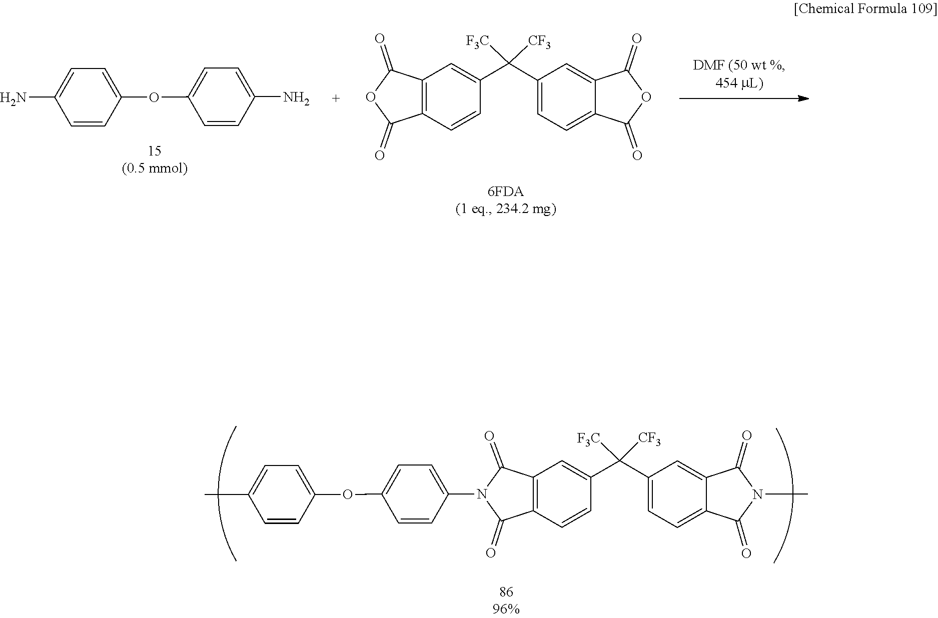

1. A fluorine-containing aromatic polymer represented by Formula (I): 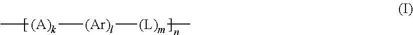
wherein
A each independently represents an aliphatic or aromatic imide-diyl group,
Ar each independently is represented by Formula (Ar1):
*—Ar¹¹—(X¹⁰—Ar¹²)ₙ₁₁—* (Ar1)
wherein
Ar¹¹ represents a divalent C₆₋₁₀ aromatic hydrocarbon group optionally having one or more substituents,
Ar¹² each independently represents a divalent C₆₋₁₀ aromatic hydrocarbon group optionally having one or more substituents,
X¹⁰ represents single bond, —O—, —CO—, —SO₂—, or a branched C₂₋₄ alkylene group,
n11 represents an integer of 0 to 3,
* represents a bond, and
Formula (Ar1) comprises 6 to 20 carbon atoms in total,
L each independently represents one selected from the group consisting of —R¹—, —O—, —S—, —NR²—, —CO—, —CO—O—, —O—CO—, —O—CO—O—, —SO₂—, —NR²—CO—, and CO—NR²—,
R¹ each independently represents one selected from a C₁₋₁₆ alkylene group optionally having one or more substituents; and a divalent group comprising a C₃₋₁₆ alicyclic hydrocarbon moiety optionally having one or more substituents,
R² each independently represents a C₁₋₁₆ alkyl group optionally having one or more substituents; a C₆₋₂₀ aromatic hydrocarbon group optionally having one or more substituents; or a hydrogen atom,
k each independently represents an integer of 0 to 4,
l each independently represents an integer of 1 to 4,
m each independently represents an integer of 0 to 4,
n represents an integer of 1 or more, and
in a unit enclosed in parentheses with n, units enclosed in parentheses with k, l, and m may appear in any order, and
the Formula (I) satisfies (i) or (ii):
(i) k is 0, and Formula (I) comprises one or more C₂₋₂₀ fluorine-containing organic groups, and
(ii) k is 1 to 4, and Formula (I) comprises one or more C₁₋₂₀ fluorine-containing organic groups.

2. The fluorine-containing aromatic polymer according to claim 1, wherein
the C₂₋₂₀ fluorine-containing organic groups are represented by one or more selected from Formula (1A) and Formula (1B):
R³¹—X¹—(R^{F1})ᵣ—CF₂—* (1A)
*—X³—CF₂—* (1B)
wherein
R^{F1} represents —(Rf)ₚ—R^{F}—(O)_{q},
Rf each independently represents a C₁₋₁₆ alkylene group optionally substituted with one or more fluorine atoms,
R^{F} represents a divalent fluoro(poly)ether group,
X¹ represents a C₁₋₁₆ alkylene group optionally substituted with one or more halogen atoms; or single bond,
X³ represents a C₁₋₁₆ alkylene group optionally substituted with one or more halogen atoms,
R³¹ represents a C₁₋₁₆ alkyl group optionally substituted with one or more halogen atoms; a C₆₋₂₀ aromatic hydrocarbon group optionally having one or more substituents; a silsesquioxane residue optionally having one or more substituents; —COOR^{f2}; —OR^{f2}; —SO₂R^{f3}; —CR^{f4}═CR^{f4}₂; a fluorine atom; a bromine atom; or an iodine atom,
R^{f2} each independently represents a C₁₋₁₆ alkyl group optionally substituted with one or more fluorine atoms; or a hydrogen atom,
R^{f3} represents a C₁₋₁₆ alkyl group optionally substituted with one or more halogen atoms; fluorine atom; or hydrogen atom,
R^{f4} each independently represents hydrogen atom or fluorine atom,
p is 0 or 1, q is 0 or 1, r is 0 or 1,
* represents a bond, and
Formula (1A) and Formula (1B) each comprise 2 to 20 20 carbon atoms, and
the C₁₋₂₀ fluorine-containing organic groups are represented by Formula (2A) and Formula (2B):
R³²—X¹—(R^{F1})ᵣ—CF₂—* (2A)
*—X¹—CF₂—* (2B)
wherein
R^{F1} represents (Rf)ₚR^{F}—(O)_{q},
Rf each independently represents a C₁₋₁₆ alkylene group optionally substituted with one or more fluorine atoms,
R^{F} represents a divalent fluoro(poly)ether group,
X¹ represents a C₁₋₁₆ alkylene group optionally substituted with one or more halogen atoms; or single bond,
R³² represents a C₁₋₁₆ alkyl group optionally substituted with one or more halogen atoms; a C₆₋₂₀ aromatic hydrocarbon group optionally having one or more substituents; a silsesquioxane residue optionally having one or more substituents; —COOR^{f2}; —OR^{f2}; —SO₂R^{f3}; —CR^{f4}═CR^{f4}₂; fluorine atom; bromine atom; or iodine atom,
R^{f2} each independently represents a C₁₋₁₆ alkyl group optionally substituted with one or more fluorine atoms or a hydrogen atom,
R^{f3} represents a C₁₋₁₆ alkyl group optionally substituted with one or more halogen atoms; a fluorine atom; or a hydrogen atom,
R^{f4} each independently represents a hydrogen atom or a fluorine atom,
p is 0 or 1, q is 0 or 1, r is 0 or 1,
* represents a bond, and
Formula (2A) and Formula (2B) each comprise 1 to 20 carbon atoms.

3. The fluorine-containing aromatic polymer according to claim 1, wherein
the C₂₋₂₀ fluorine-containing organic groups are selected from Formula (1-a), Formula (1-b), Formula (1-c), and Formula (1B):
F—X³—CF₂—* (1-a)
R³¹—X¹—CF₂—* (1-b)
R³¹—X¹—R^{F1}—CF₂-* (1-c)
*—X³—CF₂—* (1B)
wherein
R^{F1} represents —(Rf)ₚ—R^{F}—(O)_{q},
Rf each independently represents a C₁₋₁₆ alkylene group optionally substituted with one or more fluorine atoms,
R^{F} represents a divalent fluoro(poly)ether group,
X¹ represents a C₁₋₁₆ alkylene group optionally substituted with one or more halogen atoms; or single bond,
X³ represents a C₃₋₁₆ alkylene group optionally substituted with one or more halogen atoms,
R³¹ represents a C₁₋₁₆ alkyl group optionally substituted with one or more halogen atoms; a C₆₋₂₀ aromatic hydrocarbon group optionally having one or more substituents; a silsesquioxane residue optionally having one or more substituents; —COOR^{f2}; —OR^{f2}; —SO₂R^{f3}; —CR^{f4}═CR^{f4}₂; fluorine atom; or bromine atom,
R^{f2} each independently represents a C₁₋₁₆ alkyl group optionally substituted with one or more fluorine atoms; or hydrogen atom,
R^{f3} represents a C₁₋₁₆ alkyl group optionally substituted with one or more halogen atoms; fluorine atom; or hydrogen atom,
R^{f4} each independently represents hydrogen atom or fluorine atom,
p is 0 or 1, q is 0 or 1, r is 0 or 1,
* represents a bond,
Formula (1-a) comprises 2 to 20 carbon atoms,
Formula (1-b) comprises 2 to 20 carbon atoms,
Formula (1-c) comprises 2 to 20 carbon atoms, and
Formula (1B) comprises 2 to 20 carbon atoms, and
the C₁₋₂₀ fluorine-containing organic groups are selected from Formula (2-a), Formula (2-b), Formula (2-c), and Formula (2B):
F—X¹—CF₂—* (2-a)
R³²—X¹—CF₂—* (2-b)
R³²—X¹—R^{F1}—CF₂-* (2-c)
*—X¹—CF₂—* (2B)
wherein
R^{F1} represents (Rf)ₚR^{F}—(O)_{q},
Rf each independently represents a C₁₋₁₆ alkylene group optionally substituted with one or more fluorine atoms,
R^{F} represents a divalent fluoro(poly)ether group,
X¹ represents a C₁₋₁₆ alkylene group optionally substituted with one or more halogen atoms; or single bond,
R³² represents a C₁₋₁₆ alkyl group optionally substituted with one or more halogen atoms; a C₆₋₂₀ aromatic hydrocarbon group optionally having one or more substituents; a silsesquioxane residue optionally having one or more substituents; —COOR^{f2}; —OR^{f2}; —SO₂R^{f3}; —CR^{f4}═CR^{f4}₂; fluorine atom; or bromine atom,
R^{f2} each independently represents a C₁₋₁₆ alkyl group optionally substituted with one or more fluorine atoms; or hydrogen atom,
R^{f3} represents a C₁₋₁₆ alkyl group optionally substituted with one or more halogen atoms; fluorine atom; or hydrogen atom,
R^{f4} each independently represents hydrogen atom or fluorine atom,
p is 0 or 1, q is 0 or 1, r is 0 or 1,
* represents a bond,
Formula (2-a) comprises 1 to 20 carbon atoms,
Formula (2-b) comprises 1 to 20 carbon atoms,
Formula (2-c) comprises 1 to 20 carbon atoms, and
Formula (2B) comprises 1 to 20 carbon atoms.

4. The fluorine-containing aromatic polymer according to claim 1, wherein
Formula (I) is represented by Formula (I-a): 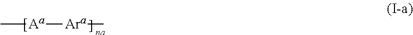
wherein
A^{a} each independently represents an aliphatic or aromatic imide-diyl group,
Ar^{a} each independently is represented by the formula (Ar1),
na represents an integer of 1 or more, and
Formula (I-a) comprises one or more C₁₋₂₀ fluorine-containing organic groups.

5. The fluorine-containing aromatic polymer according to claim 1, wherein
Formula (I) is represented by Formula (I-b): 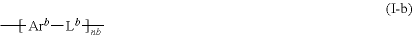
wherein
Ar^{b} each independently is represented by the formula (Ar1),
L^{b} each independently represents one selected from the group consisting of —R¹—, —O—, —S—, —NR²—, —CO—, —CO—O—, —O—CO—, —O—CO—O—, —SO₂—, —NR²—CO—, and CO—NR²—,
R¹ each independently represents one selected from a C₁₋₁₆ alkylene group optionally having a substituent; and a divalent group comprising a C₃₋₁₆ alicyclic hydrocarbon moiety optionally having one or more substituents,
R² each independently represents a C₁₋₁₆ alkyl group optionally having one or more substituents; a C₆₋₂₀ aromatic hydrocarbon group optionally having one or more substituents; or hydrogen atom,
nb represents an integer of 1 or more, and
Formula (I-b) comprises one or more C₂₋₂₀ fluorine-containing organic groups.

6. The fluorine-containing aromatic polymer according to claim 5, wherein
Formula (I-b) is represented by Formula (I-b1), (I-b2), (I-b3), (I-b4), (I-b5), (I-b6), or (I-b7): 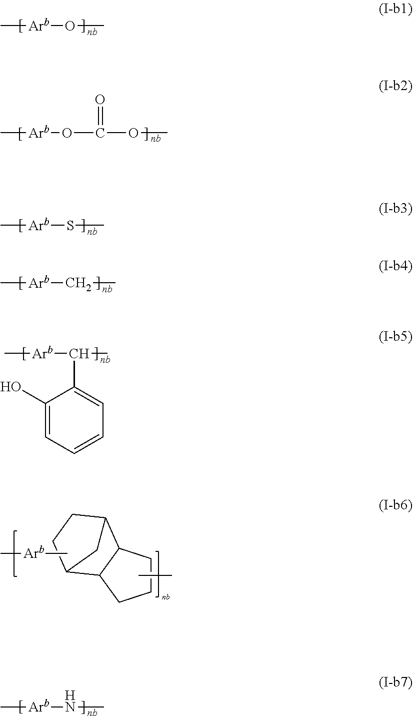
wherein
Ar^{b} each independently is represented by the formula (Ar1),
nb represents an integer of 1 or more, and
Formulas (I-b1), (I-b2), (I-b3), (I-b4), (I-b5), (I-b6), and (I-b7) each comprise one or more C₂₋₂₀ fluorine-containing organic groups.

7. The fluorine-containing aromatic polymer according to claim 1, wherein
Formula (I) is represented by Formula (I-c): 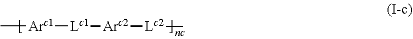
wherein
Ar^{c1} each independently is represented by the formula (Ar1),
Ar^{c2} each independently is represented by the formula (Ar1),
L^{c1} each independently represents one selected from the group consisting of —R¹—, —O—S—, —NR²—, —CO—, —CO—O—, —O—CO—, —O—CO—O—, —SO₂—, —NR²—CO—, and CO—NR²—,
L^{c2} each independently represents one selected from the group consisting of —R¹—, —O—S—, —NR²⁻, —CO—, —CO—O—, —O—CO—, —O—CO—O—, —SO₂—, —NR²—CO—, and CO—NR²—,
in at least one combination of Ar^{c1} and Ar^{c2}; or L^{c1} and L^{c2}, one group is different from the other,
R¹ each independently represents one selected from a C₁₋₁₆ alkylene group optionally having a substituent; and a divalent group comprising a C₃₋₁₆ alicyclic hydrocarbon moiety optionally having one or more substituents,
R² each independently represents a C₁₋₁₆ alkyl group optionally having one or more substituents; a C₆₋₂₀ aromatic hydrocarbon group optionally having one or more substituents; or a hydrogen atom,
nc represents an integer of 1 or more, and
Formula (I-c) comprises one or more C₂₋₂₀ fluorine-containing organic groups.

8. The fluorine-containing aromatic polymer according to claim 7, wherein
Formula (I-c) is represented by Formula (I-c1), (I-c2), or (I-c3): 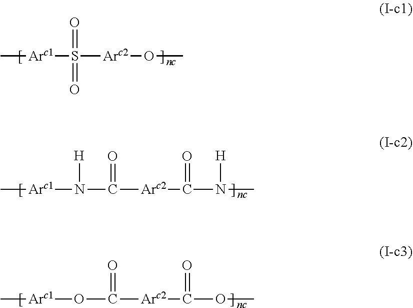
wherein
Ar^{c1} each independently is represented by the formula (Ar1),
Ar^{c2} each independently is represented by the formula (Ar1),
nc each independently represents an integer of 1 or more, and
Formulas (I-c1), (I-c2), and (I-c3) each comprise one or more C₂₋₂₀ fluorine-containing organic groups.

9. The fluorine-containing aromatic polymer according to claim 1, wherein
Formula (I) is represented by Formula (I-d): 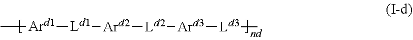
wherein
Ar^{d1} each independently is represented by the formula (Ar1),
Ar^{d2} each independently is represented by the formula (Ar1),
Ar^{d3} each independently is represented by the formula (Ar1),
L^{d1} each independently represents one selected from the group consisting of —R¹—, —O—S—, —NR²—, —CO—, —CO—O—, —O—CO—, —O—CO—O—, —SO₂—, —NR²—CO—, and CO—NR²—,
L^{d2} each independently represents one selected from the group consisting of —R¹—, —O—S—, —NR²⁻, —CO—, —CO—O—, —O—CO—, —O—CO—O—, —SO₂—, —NR²—CO—, and CO—NR²—,
L^{d3} each independently represents one selected from the group consisting of —R¹—, —O—S—, —NR²—, —CO—, —CO—O—, —O—CO—, —O—CO—O—, —SO₂—, —NR²—CO—, and CO—NR²—,
in at least one combination of Ar^{d1}, Ar^{d2}, and Ar^{d3}; or L^{d1}, L^{d2}, and L^{d3}; one group is different from at least one of the other two groups,
R¹ each independently represents one selected from a C₁₋₁₆ alkylene group optionally having one or more substituents; and a divalent group comprising a C₃₋₁₆ alicyclic hydrocarbon moiety optionally having one or more substituents,
R² each independently represents a C₁₋₁₆ alkyl group optionally having one or more substituents; a C₆₋₂₀ aromatic hydrocarbon group optionally having one or more substituents; or a hydrogen atom,
nd represents an integer of 1 or more, and
Formula (I-d) comprises one or more C₂₋₂₀ fluorine-containing organic groups.

10. The fluorine-containing aromatic polymer according to claim 9, wherein 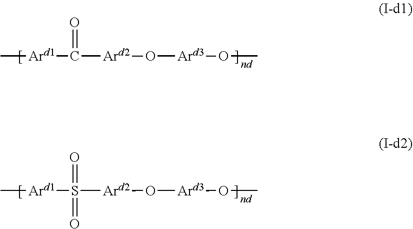
wherein
Ar^{d1} each independently is represented by the formula (Ar1),
Ar^{d2} each independently is represented by the formula (Ar1),
Ar^{d3} each independently is represented by the formula (Ar1),
nd each independently represents an integer of 1 or more, and
Formulas (1-d1) and (1-d2) each comprise one or more C₂₋₂₀ fluorine-containing organic groups.

11. The fluorine-containing aromatic polymer according to claim 1, wherein
Formula (I) is represented by Formula (I-e): 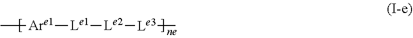
paragraph [ ]
wherein
Ar^{e1} each independently is represented by the formula (Ar1),
L^{e1} each independently represents one selected from the group consisting of —R¹—, —O—, —S—, —NR²—, —CO—, —CO—O—, —O—CO—, —O—CO—O—, —SO₂—, —NR²—CO—, and CO—NR²—,
L^{e2} each independently represents one selected from the group consisting of —R¹—, —O—, —S—, —NR²—, —CO—, —CO—O—, —O—CO—, —O—CO—O—, —SO₂—, —NR²—CO—, and CO—NR²—,
L^{e3} each independently represents one selected from the group consisting of —R¹—, —O—, —S—, —NR²—, —CO—, —CO—O—, —O—CO—, —O—CO—O—, —SO₂—, —NR²—CO—, and CO—NR²—,
R¹ each independently represents one selected from a C₁₋₁₆ alkylene group optionally having one or more substituents; and a divalent group comprising a C₃₋₁₆ alicyclic hydrocarbon moiety optionally having one or more substituents,
R² each independently represents a C₁₋₁₆ alkyl group optionally having one or more substituents; a C₆₋₂₀ aromatic hydrocarbon group optionally having one or more substituents; or a hydrogen atom,
ne represents an integer of 1 or more, and
Formula (I-e) comprises one or more C₂₋₂₀ fluorine-containing organic groups.

12. The fluorine-containing aromatic polymer according to claim 11, wherein
Formula (I-e) is represented by Formula (I-e1), (I-e2), or (I-e3): 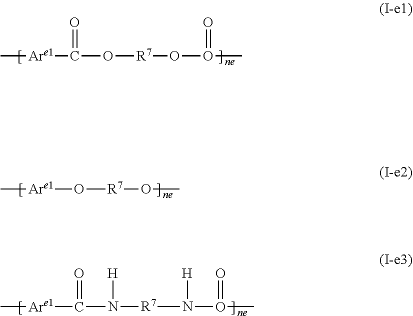
wherein
Ar^{e1} each independently is represented by the formula (Ar1),
R⁷ represents one selected from a C₁₋₁₆ alkylene group optionally having one or more substituents; and a divalent group comprising a C₃₋₁₆ alicyclic hydrocarbon moiety optionally having one or more substituents,
ne each independently represents an integer of 1 or more, and
Formulas (I-e1), (I-e2), and (I-e3) each comprise one or more C₂₋₂₀ fluorine-containing organic groups.

13. The fluorine-containing aromatic polymer according to claim 1, wherein
Formula (I) is represented by Formula (I-g): 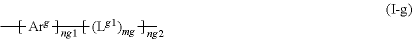
wherein
Ar^{g} each independently is represented by the formula (Ar1),
L^{g1} represents a divalent group comprising a C₃₋₁₆ alicyclic hydrocarbon moiety optionally having one or more substituents,
mg each independently represents an integer of 0 to 4,
ng1 represents an integer of 1 or more,
ng2 represents an integer of 1 or more, and
Formula (I-g) comprises one or more C₂₋₂₀ fluorine-containing organic groups.

14. The fluorine-containing aromatic polymer according to claim 1, wherein
Formula (I) is represented by Formula (I-h): 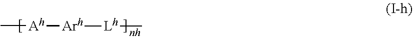
wherein
A^{h} each independently represents an aliphatic or aromatic imide-diyl group,
Ar^{h} each independently is represented by the formula (Ar1),
L^{h} each independently represents one selected from the group consisting of —R¹—, —O—, —S—, —NR²—, —CO—, —CO—O—, —O—CO—, —O—CO—O—, —SO₂—, —NR²—CO—, and CO—NR²—,
R¹ each independently represents one selected from a C₁₋₁₆ alkylene group optionally having a substituent; and a divalent group comprising a C₃₋₁₆ alicyclic hydrocarbon moiety optionally having one or more substituents,
R² each independently represents a C₁₋₁₆ alkyl group optionally having one or more substituents; a C₆₋₂₀ aromatic hydrocarbon group optionally having one or more substituents; or hydrogen atom,
nh represents an integer of 1 or more, and
Formula (1-h) comprises one or more C₁₋₂₀ fluorine-containing organic groups.

15. The fluorine-containing aromatic polymer according to claim 14, wherein
Formula (I-h) is represented by Formula (I-h1): 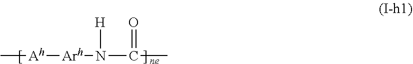
wherein
A^{h} each independently represents an aliphatic or aromatic imide-diyl group,
Ar^{h} each independently is represented by the formula (Ar1),
nh each independently represents an integer of 1 or more, and
Formula (I-h1) comprises one or more C₁₋₂₀ fluorine-containing organic groups.

16. The fluorine-containing aromatic polymer according to claim 1, wherein
A is represented by Formula (A2-I): 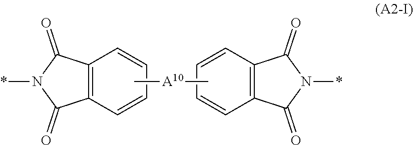
wherein
A¹⁰ represents single bond or a divalent organic group, and
* represents a bond, or
A is represented by Formula (A2-II): 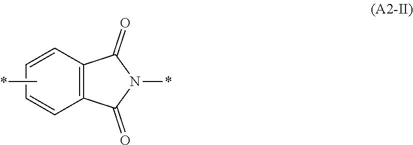
wherein * represents a bond.

17. The fluorine-containing aromatic polymer according to claim 16, wherein
A¹⁰ is one selected from single bond and groups represented by Formulas (a-1) to (a-7): 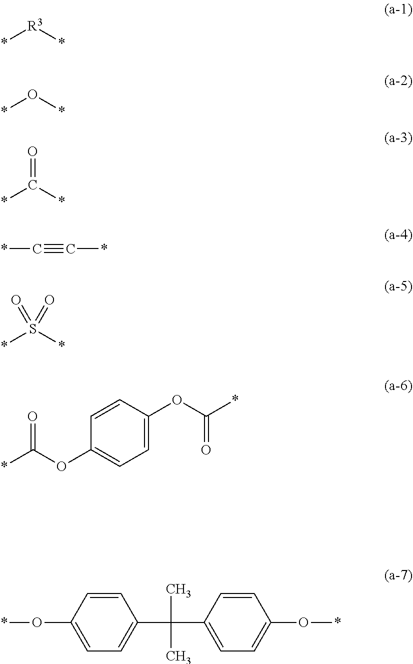
wherein
R³ represents a C₁₋₁₆ alkylene group optionally substituted with a fluorine atom, and
represents a bond.

18. The fluorine-containing aromatic polymer according to claim 14, wherein
A is one selected from groups represented by Formulas (A1-1) to (A1-19): 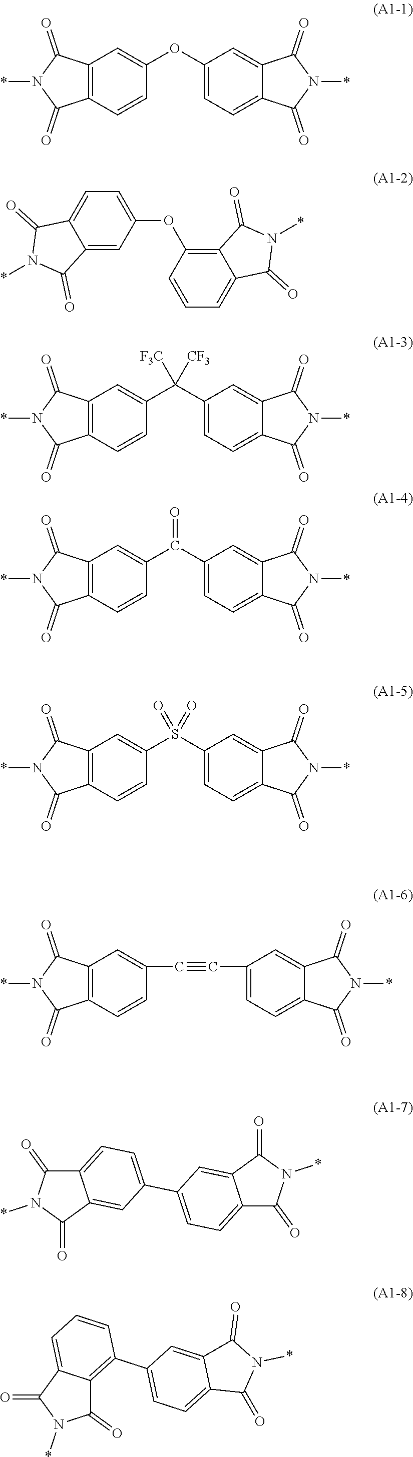 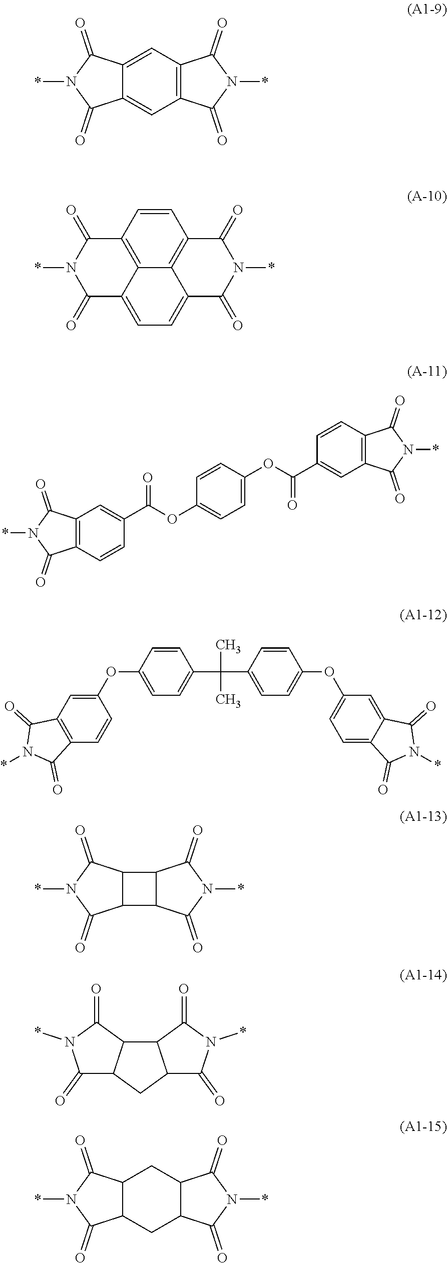 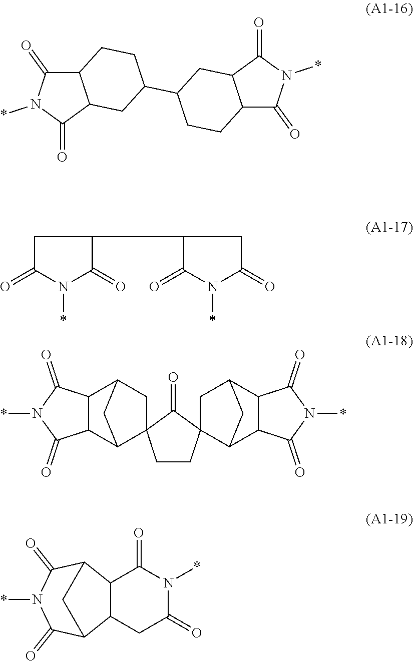
wherein * represents a bond.

19. A method for producing a fluorine-containing aromatic polymer represented by Formula (I-1): 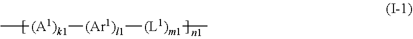
wherein
A¹ each independently represents an aliphatic or aromatic imide-diyl group,
Ar¹ each independently is represented by the formula (Ar1),
L¹ each independently represents one selected from the group consisting of —R¹¹—, —O—, —S—, —NR¹²—, —CO—, —CO—O—, —O—CO—, —O—CO—O—, —SO₂—, —NR¹²—CO—, and CO—NR¹²—,
R¹¹ each independently represents one selected from a C₁₋₁₆ alkylene group optionally having a substituent; and a divalent group comprising a C₃-1₆ alicyclic hydrocarbon moiety optionally having one or more substituents,
R¹² each independently represents a C₁₋₁₆ alkyl group optionally having a substituent; a C₆₋₂₀ aromatic hydrocarbon group optionally having one or more substituents; or hydrogen atom,
k1 each independently represents an integer of 0 to 4,
l1 each independently represents an integer of 1 to 4,
m1 each independently represents an integer of 0 to 4,
n1 represents an integer of 1 or more,
in a unit enclosed in parentheses with n1, units enclosed in parentheses with k1, l1, and m1 appear in any order, and
Formula (1-1) comprises 1 or more C₁₋₂₀ fluorine-containing organic groups,
the method comprising reacting an aromatic polymer represented by Formula (1-2): 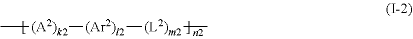
wherein
A² each independently represents an aliphatic or aromatic imide-diyl group,
Ar² each independently is represented by Formula (Ar1):
* —Ar¹¹—(X¹⁰—Ar¹²)ₙ₁₁—* (Ar1)
wherein
Ar¹¹ represents a divalent C₆₋₁₀ aromatic hydrocarbon group optionally having one or more substituents,
Ar¹² each independently represents a divalent C₆₋₁₀ aromatic hydrocarbon group optionally having one or more substituents,
X¹⁰ represents single bond, —O—, —CO—, —SO₂—, or a branched C₂₋₄ alkylene group,
n11 represents an integer of 0 to 3,
* represents a bond, and
Formula (Ar1) comprises 6 to 20 carbon atoms in total,
L each independently represents one selected from the group consisting of —R²¹—, —O—, —S—, —NR²²—, —CO—, —CO—O—, —O—CO—, —O—CO—O—, —SO₂—, —NR²²—CO—, and CO—NR²²—,
R²¹ each independently represents one selected from a C₁₋₁₆ alkylene group optionally having one or more substituents; and a divalent group comprising a C₃₋₁₆ alicyclic hydrocarbon moiety optionally having one or more substituents,
R²² each independently represents a C₁₋₁₆ alkyl group optionally having one or more substituents; a C₆₋₂₀ aromatic hydrocarbon group optionally having one or more substituents; or hydrogen atom,
k2 each independently represents an integer of 0 to 4,
l2 each independently represents an integer of 1 to 4,
m2 each independently represents an integer of 0 to 4,
n2 represents an integer of 1 or more, and
in a unit enclosed in parentheses with n2, units enclosed in parentheses with k2, l2, and m2 appear in any order,
the compound represented by Formula (II):
I—R^{f1} (II)
wherein R^{f1} represents a C₁₋₂₀ fluorine-containing organic group.

20. A method for producing a fluorine-containing aromatic polymer represented by Formula (I-1): 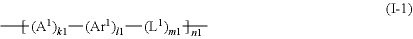
wherein
A¹ each independently represents an aliphatic or aromatic imide-diyl group,
Ar¹ each independently is represented by Formula (Ar1):
* —Ar¹¹—(X¹⁰—Ar¹²)ₙ₁₁—* (Ar1)
wherein
Ar¹¹ represents a divalent C₆₋₁₀ aromatic hydrocarbon group optionally having one or more substituents,
Ar¹² each independently represents a divalent C₆₋₁₀ aromatic hydrocarbon group optionally having one or more substituents,
X¹⁰ represents single bond, —O—, —CO—, —SO₂—, or a branched C₂₋₄ alkylene group,
n11 represents an integer of 0 to 3,
* represents a bond, and
Formula (Ar1) comprises 6 to 20 carbon atoms in total,
L¹ each independently represents one selected from the group consisting of —R¹¹—, —O—, —S—, —NR¹²—, —CO—, —CO—O—, —O—CO—, —O—CO—O—, —SO₂—, —NR¹²—CO—, and CO—NR¹²—,
R¹¹ each independently represents one selected from a C₁₋₁₆ alkylene group optionally having a substituent; and a divalent group comprising a C₃₋₁₆ alicyclic hydrocarbon moiety optionally having one or more substituents,
R¹² each independently represents a C₁₋₁₆ alkyl group optionally having a substituent; a C₆₋₂₀ aromatic hydrocarbon group optionally having one or more substituents; or hydrogen atom,
k1 each independently represents an integer of 0 to 4,
l1 each independently represents an integer of 1 to 4,
m1 each independently represents an integer of 0 to 4,
n1 represents an integer of 1 or more, and
in a unit enclosed in parentheses with n1, units enclosed in parentheses with k1, l1, and m1 appear in any order, and
Formula (1-1) comprises one or more C₁₋₂₀ fluorine-containing organic groups,
the method comprising:
reacting an aromatic monomer with a compound to obtain a fluorine-containing aromatic monomer, the compound represented by Formula (II):
I—R^{f1} (II)
wherein R^{f1} represents a C₁₋₂₀ fluorine-containing organic group; and
using the fluorine-containing aromatic monomer as a monomer to obtain a fluorine-containing aromatic polymer.

21. The method according to claim 20, wherein
the aromatic monomer is represented by Formula (III):
R⁴—Ar³—R⁴ (III)
wherein
Ar³ each independently is represented by the formula (Ar1), and
R⁴ each independently represents —OH, —NH₂, a fluorine atom, or a chlorine atom.

22. The method according to claim 20, comprising reacting the fluorine-containing aromatic monomer with a second monomer to obtain a fluorine-containing aromatic polymer.

23. The method according to claim 22, wherein the second monomer is a monomer having two or more groups capable of reacting with an amino group or a hydroxyl group in one molecule.

24. The method according to claim 22, wherein
the second monomer is a compound represented by Formula (IV):
R⁵-L¹⁰-R⁵ (IV)
wherein
R⁵ each independently represents one selected from Formulas (r-1) to (r-18): 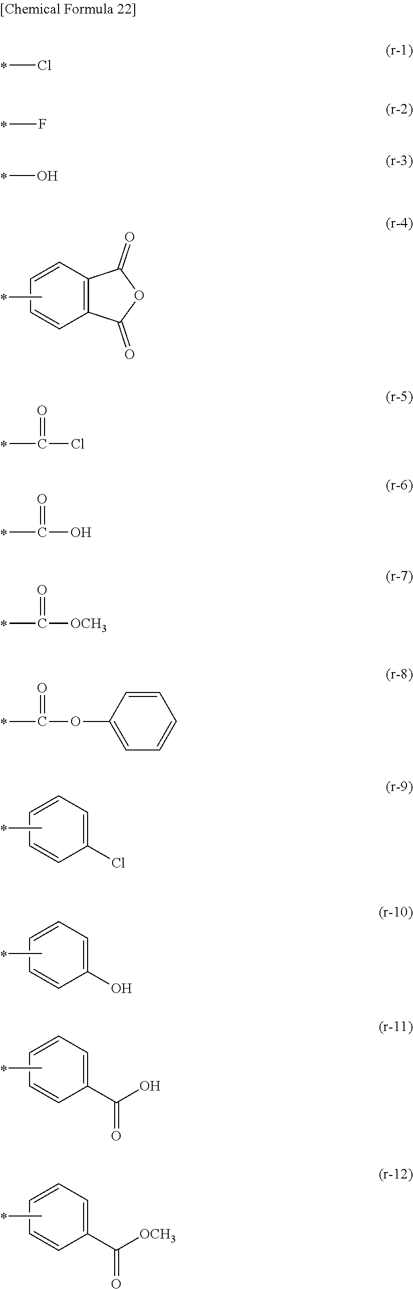 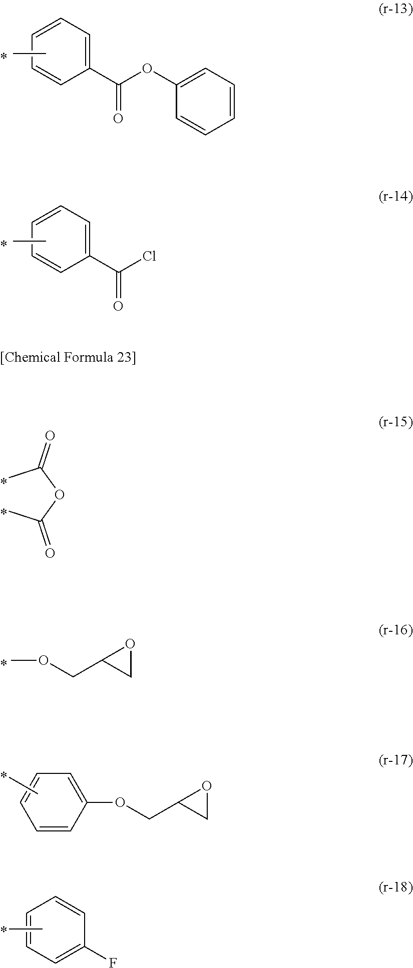
wherein * represents a bond, and
L¹⁰ represents one selected from Formulas (I-1) to (I-11): 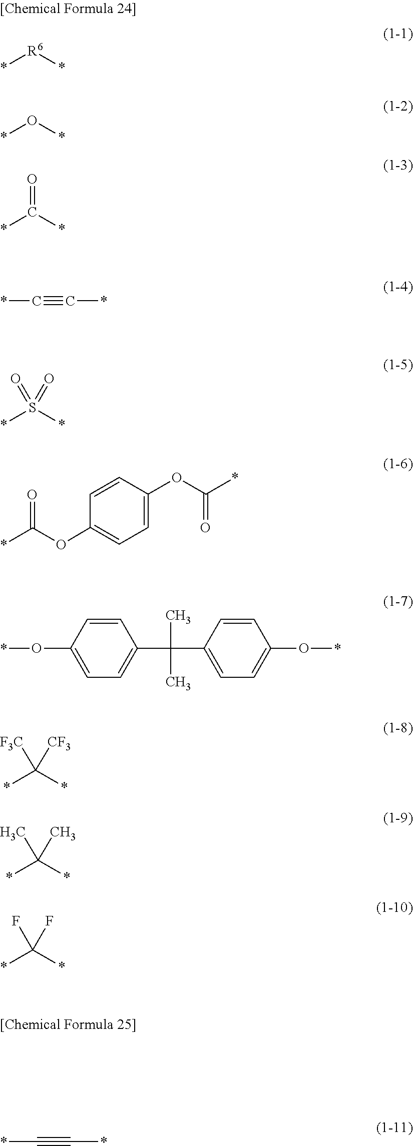
wherein
R⁶ represents single bond; a C₁₋₁₆ alkylene group optionally substituted with one or more fluorine atoms; or a divalent C₆₋₂₀ aromatic hydrocarbon group optionally having one or more substituents, and
* represents a bond.

25. A fluorine-containing aromatic monomer represented by Formula (III-1):
R⁴¹—Ar³¹—R⁴¹ (III-1)
wherein
Ar³¹ each independently is represented by Formula (Ar1):
*—Ar¹¹—(X¹⁰—Ar¹²)ₙ₁₁—* (Ar1)
wherein
Ar¹¹ represents a divalent C₆₋₁₀ aromatic hydrocarbon group optionally having one or more substituents,
Ar¹² each independently represents a divalent C₆₋₁₀ aromatic hydrocarbon group optionally having one or more substituents,
X¹⁰ represents single bond, —O—, —CO—, —SO₂—, or a branched C₂₋₄ alkylene group,
n11 represents an integer of 0 to 3,
* represents a bond, and
Formula (Ar1) comprises 6 to 20 carbon atoms in total,
R⁴¹ each independently represents —OH, —NH₂, glycidyloxy group, fluorine atom, or chlorine atom, and
Formula (III-1) comprises one or more C₁₋₂₀ fluorine-containing organic groups,
the C₁₋₂₀ fluorine-containing organic groups are represented by one or more selected from Formula (2-1A) and Formula (2B):
R³³—X¹—(R^{F1})ᵣ—CF₂—* (2-1A)
*—X¹—CF₂—* (2B)
wherein
R^{F1} represents —(Rf)ₚR^{F}—(O)_{q},
Rf each independently represents a C₁₋₁₆ alkylene group optionally substituted with one or more fluorine atoms,
R^{F} represents a divalent fluoro(poly)ether group,
X¹ represents a C₁₋₁₆ alkylene group optionally substituted with one or more halogen atoms; or single bond,
R³³ represents a C₆₋₂₀ aromatic hydrocarbon group optionally having one or more substituents; a silsesquioxane residue optionally having one or more substituents; —COOR^{f2}; —OR^{f2}; —SO₂R^{f3}; —CR^{f4}═CR^{f52}; fluorine atom; bromine atom; or iodine atom,
R^{f2} each independently represents a C₁₋₁₆ alkyl group optionally substituted with one or more fluorine atoms; or hydrogen atom,
R^{f3} represents a C₁₋₁₆ alkyl group optionally substituted with one or more halogen atoms; fluorine atom; or hydrogen atom,
R^{f4} each independently represents hydrogen atom or fluorine atom,
p is 0 or 1, q is 0 or 1, r is 0 or 1,
* represents a bond,
Formula (2-1A) comprises 1 to 20 carbon atoms, and
Formula (2B) comprises 1 to 20 carbon atoms.

26. A product comprising:
a substrate; and
a layer formed on a surface of the substrate using a surface treatment agent,
wherein the substrate comprising an aromatic polymer,
wherein the surface treatment agent comprising a compound represented by one or more selected from Formula (II-1A) and Formula (II-1B):
R³²—X¹—(R^{F1})ᵣ—CF₂—I (II-1A)
I-X¹—CF₂—I (II-1B)
wherein
R^{F1} represents —(Rf)ₚ—R^{F}—(O)_{q}—,
Rf each independently represents a C₁₋₁₆ alkylene group optionally substituted with one or more fluorine atoms,
R^{F} represents a divalent fluoro(poly)ether group,
X¹ represents a C₁₋₁₆ alkylene group optionally substituted with one or more halogen atoms; or single bond,
R³² represents a C₁₋₁₆ alkyl group optionally substituted with one or more halogen atoms; a C₆₋₂₀ aromatic hydrocarbon group optionally having one or more substituents; a silsesquioxane residue optionally having one or more substituents; —COOR^{f2}; —OR^{f2}; —SO₂R^{f3}; —CR^{f4}═CR^{f4}₂; fluorine atom; bromine atom; or iodine atom,
R^{f2} each independently represents a C₁₋₁₆ alkyl group optionally substituted with one or more fluorine atoms; or hydrogen atom,
R^{f3} represents a C₁₋₁₆ alkyl group optionally substituted with one or more halogen atoms; fluorine atom; or hydrogen atom,
R^{f4} each independently represents hydrogen atom or fluorine atom,
p is 0 or 1, q is 0 or 1, r is 0 or 1,
* represents a bond,
Formula (II-1A) comprises 1 to 20 carbon atoms,
Formula (II-1B) comprises 1 to 20 carbon atoms and
the aromatic polymer represented by the following Formula (I-2): 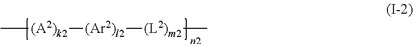
wherein
A² each independently represents an aliphatic or aromatic imide-diyl group,
Ar² each independently is represented by Formula (Ar1):
*—Ar¹¹—(X¹⁰—Ar¹²)ₙ₁₁—* (Ar1)
wherein
Ar¹¹ represents a divalent C₆₋₁₀ aromatic hydrocarbon group optionally having one or more substituents,
Ar¹² each independently represents a divalent C₆₋₁₀ aromatic hydrocarbon group optionally having one or more substituents,
X¹⁰ represents single bond, —O—, —CO—, —SO₂—, or a branched C₂₋₄ alkylene group,
n11 represents an integer of 0 to 3,
* represents a bond, and
Formula (Ar1) comprises 6 to 20 carbon atoms in total,
L each independently represents one selected from the group consisting of —R²¹—, —O—, —S—, —NR²²—, —CO—, —CO—O—, —O—CO—, —O—CO—O—, —SO₂—, —NR²²—CO—, and CO—NR²²—,
R²¹ each independently represents one selected from a C₁₋₁₆ alkylene group optionally having one or more substituents; and a divalent group comprising a C₃₋₁₆ alicyclic hydrocarbon moiety optionally having one or more substituents,
R²² each independently represents a C₁₋₁₆ alkyl group optionally having one or more substituents; a C₆₋₂₀ aromatic hydrocarbon group optionally having one or more substituents; or a hydrogen atom,
k2 each independently represents an integer of 0 to 4,
l2 each independently represents an integer of 1 to 4,
m2 each independently represents an integer of 0 to 4,
n2 represents an integer of 1 or more, and
in a unit enclosed in parentheses with n2, units enclosed in parentheses with k2, l2, and m2 appear in any order,
with a compound represented by the following Formula (II):
I—R^{f1} (II)
wherein R^{f1} represents a C₁₋₂₀ fluorine-containing organic group.

27. A method for producing a product, the method comprising reacting a substrate with a surface treatment agent to form a layer on a surface of the substrate,
the substrate containing an aromatic polymer,
the surface treatment agent containing a compound represented by one or more selected from Formula (II-1A) and Formula (II-1B):
R³²—X¹—(R^{F1})ᵣ—CF₂—I (II-1A)
I-X¹—CF₂—I (II-1B)
wherein
R^{F1} represents (Rf)ₚR^{F}—(O)_{q},
Rf each independently represents a C₁₋₁₆ alkylene group optionally substituted with one or more fluorine atoms,
R^{F} represents a divalent fluoro(poly)ether group,
X¹ represents a C₁₋₁₆ alkylene group optionally substituted with one or more halogen atoms; or single bond,
R³² represents a C₁₋₁₆ alkyl group optionally substituted with one or more halogen atoms; a C₆₋₂₀ aromatic hydrocarbon group optionally having one or more substituents; a silsesquioxane residue optionally having one or more substituents; —COOR^{f2}; —OR^{f2}; —SO₂R^{f3}; —CR^{f4}═CR^{f4}₂; fluorine atom; bromine atom; or iodine atom,
R^{f2} each independently represents a C₁₋₁₆ alkyl group optionally substituted with one or more fluorine atoms; or hydrogen atom,
R^{f3} represents a C₁₋₁₆ alkyl group optionally substituted with one or more halogen atoms; fluorine atom: or hydrogen atom,
R^{f4} each independently represents hydrogen atom or fluorine atom,
p is 0 or 1, q is 0 or 1, r is 0 or 1,
* represents a bond,
Formula (II-1A) comprises 1 to 20 carbon atoms,
Formula (II-1B) comprises 1 to 20 carbon atoms and
the aromatic polymer represented by the following Formula (1-2): 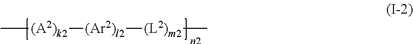
wherein
A² each independently represents an aliphatic or aromatic imide-diyl group,
Ar² each independently is represented by Formula (Ar1):
*—Ar¹¹—(X¹⁰—Ar¹²)ₙ₁₁—* (Ar1)
wherein
Ar¹¹ represents a divalent C₆₋₁₀ aromatic hydrocarbon group optionally having one or more substituents,
Ar¹² each independently represents a divalent C₆₋₁₀ aromatic hydrocarbon group optionally having one or more substituents,
X¹⁰ represents single bond, —O—, —CO—, —SO₂—, or a branched C₂₋₄ alkylene group,
n11 represents an integer of 0 to 3,
* represents a bond, and
Formula (Ar1) comprises 6 to 20 carbon atoms in total,
L each independently represents one selected from the group consisting of —R²¹—, —O—, —S—, —NR²²—, —CO—, —CO—O—, —O—CO—, —O—CO—O—, —SO₂—, —NR²²—CO—, and CO—NR²²—,
R²¹ each independently represents one selected from a C₁₋₁₆ alkylene group optionally having one or more substituents; and a divalent group comprising a C₃₋₁₆ alicyclic hydrocarbon moiety optionally having one or more substituents,
R²² each independently represents a C₁₋₁₆ alkyl group optionally having one or more substituents; a C₆₋₂₀ aromatic hydrocarbon group optionally having one or more substituents; or a hydrogen atom,
k2 each independently represents an integer of 0 to 4,
l2 each independently represents an integer of 1 to 4,
m2 each independently represents an integer of 0 to 4,
n2 represents an integer of 1 or more, and
in a unit enclosed in parentheses with n2, units enclosed in parentheses with k2, l2, and m2 appear in any order,
with a compound represented by the following Formula (II):
I—R^{f1} (II)
wherein R^{f1} represents a C₁₋₂₀ fluorine-containing organic group.
